(19) United States
(12) Patent Application Publication
(10) Pub. No.: US 2026/0073148 A1
(43) Pub. Date: Mar. 12, 2026

(54) Video Compression System with Hierarchical Encoding and Semantic Navigation Through Geometric Manifolds

(71) Applicant: AtomBeam Technologies Inc., Moraga, CA (US)

(72) Inventor: Brian Galvin, Silverdale, WA (US)

(21) Appl. No.: 19/389,387

(22) Filed: Nov. 14, 2025

Related U.S. Application Data
(63) Continuation-in-part of application No. 19/328,103, filed on Sep. 13, 2025.
Application No. 19/328,103 is a continuation-in-part of application No. 19/326,730, filed on Sep. 12, 2025.
Application No. 19/326,730 is a continuation-in-part of application No. 19/321,173, filed on Sep. 6, 2025.
Application No. 19/321,173 is a continuation-in-part of application No. 19/284,115, filed on Jul. 29, 2025.
Application No. 19/284,115 is a continuation of application No. 19/051,193, filed on Feb. 12, 2025, now Pat. No. 12,387,050.
Application No. 19/051,193 is a continuation-in-part of application No. 19/245,366, filed on Jun. 22, 2025, now Pat. No. 12,418,680.
Application No. 19/245,366 is a continuation-in-part of application No. 19/204,525, filed on May 10, 2025.
Application No. 19/204,525 is a continuation-in-part of application No. 19/192,215, filed on Apr. 28, 2025.
Application No. 19/192,215 is a continuation-in-part of application No. 18/972,797, filed on Dec. 6, 2024, now Pat. No. 12,294,392.
Application No. 18/972,797 is a continuation-in-part of application No. 18/648,340, filed on Apr. 27, 2024, now Pat. No. 12,166,507.
Application No. 18/648,340 is a continuation-in-part of application No. 18/427,716, filed on Jan. 30, 2024, now Pat. No. 12,093,972.
Application No. 18/427,716 is a continuation-in-part of application No. 18/410,980, filed on Jan. 11, 2024, now Pat. No. 12,068,761.
Application No. 18/410,980 is a continuation-in-part of application No. 18/537,728, filed on Dec. 12, 2023, now Pat. No. 12,058,333.
(63) Continuation-in-part of application No. 18/737,960, filed on Jun. 8, 2024, now Pat. No. 12,477,117.
Application No. 18/737,960 is a continuation of application No. 18/537,728, filed on Dec. 12, 2023, now Pat. No. 12,058,333.
(60) Provisional application No. 63/847,082, filed on Jul. 19, 2025.
(60) Provisional application No. 63/847,091, filed on Jul. 19, 2025.
(60) Provisional application No. 63/847,096, filed on Jul. 19, 2025.
(60) Provisional application No. 63/847,101, filed on Jul. 19, 2025.
(60) Provisional application No. 63/847,889, filed on Jul. 21, 2025.

(51) Int. Cl. G06F 40/30; G06F 16/332; G06F 16/3329

(52) U.S. Cl. CPC G06F 40/30; G06F 16/3325; G06F 16/3329

(57) ABSTRACT

A video compression system and method integrates geometric compression with cognitive understanding through a persistent cognitive machine interface. The system employs a hierarchical encoder generating multi-scale compressed representations organized within a Lorentzian manifold structure. A geometric processor maintains temporal causality through time-like geodesics and light cone constraints while organizing video content according to semantic relationships. A cognitive interface creates thought bundles as navigable submanifolds, enabling semantic access to compressed content beyond traditional temporal indexing. The system supports real-time processing through progressive refinement, streaming coarse representations immediately while adding detail in parallel. Symbolic anchors mark semantically significant points, enabling concept-based navigation through compressed video. Federated learning capabilities allow distributed systems to share geometric patterns while preserving content privacy. The architecture enables improved compression ratios while maintaining both temporal causality and semantic navigability, transforming video from sequential media into an intelligently accessible information space.

### CROSS-REFERENCE TO RELATED APPLICATIONS

Priority is claimed in the application data sheet to the following patents or patent applications, each of which is expressly incorporated herein by reference in its entirety:
Ser. No. 18/737,960
Ser. No. 19/328,103
Ser. No. 19/326,730
Ser. No. 19/321,173
Ser. No. 19/284,115
Ser. No. 19/051,193
63/847,082
63/847,091
63/847,096
63/847,101
63/847,889
Ser. No. 19/245,366
Ser. No. 19/204,525
Ser. No. 19/192,215
Ser. No. 18/972,797
Ser. No. 18/648,340
Ser. No. 18/427,716
Ser. No. 18/410,980
Ser. No. 18/537,728

### BACKGROUND OF THE INVENTION

### Field of the Art

The present invention is in the field of data compression, and more particularly is directed to the problem of recovering data lost from lossy compression and decompression.

### Discussion of the State of the Art

Traditional video compression methods including H.264, H.265, and AV1 operate primarily in the pixel domain, treating video as sequences of 2D images with limited temporal modeling. These codecs rely on block-based motion compensation that processes video in small spatial regions, failing to capture rich semantic and geometric relationships inherent in video data. While achieving reasonable compression ratios, they provide no mechanism for semantic navigation or content understanding.

Recent neural video compression approaches learn end-to-end mappings without explicit modeling of spatiotemporal structure. These black-box methods lack interpretability and cannot adapt dynamically to varying bandwidth or computational constraints. Emerging volumetric representations like neural radiance fields show promise but are computationally intensive and not designed for efficient compression or streaming applications.

Spatiotemporal tensors naturally represent video as 4D data, but existing tensor decomposition methods focus purely on numerical approximation without considering temporal causality or semantic relationships. These approaches treat spatial and temporal dimensions symmetrically, ignoring that time flows unidirectionally. Current manifold learning approaches for video use Euclidean or Riemannian geometry that cannot properly represent causal structure or enforce temporal constraints.

Existing video understanding systems operate on already-compressed video rather than integrating cognitive processing into compression itself. This separation leads to suboptimal results where perceptually important information may be discarded. Current real-time systems must choose between low latency and high quality, lacking true progressive refinement. Most fundamentally, video remains accessible only through temporal indices rather than semantic queries, limiting efficient content discovery in growing video collections.

What is needed is a video compression system that integrates geometric compression with cognitive understanding, organizing video content within mathematically rigorous manifold structures that preserve temporal causality while enabling semantic navigation. Such a system should support progressive refinement for real-time applications, incorporate learning mechanisms that preserve privacy, and transform video from a purely sequential medium into an intelligently accessible information space that can be navigated based on meaning rather than just time.

### SUMMARY OF THE INVENTION

Accordingly, the inventor has conceived and reduced to practice, a video compression system and method integrates geometric compression with cognitive understanding through a persistent cognitive machine interface. The system employs a hierarchical encoder generating multi-scale compressed representations organized within a Lorentzian manifold structure. A geometric processor maintains temporal causality through time-like geodesics and light cone constraints while organizing video content according to semantic relationships. A cognitive interface creates thought bundles as navigable submanifolds, enabling semantic access to compressed content beyond traditional temporal indexing. The system supports real-time processing through progressive refinement, streaming coarse representations immediately while adding detail in parallel. Symbolic anchors mark semantically significant points, enabling concept-based navigation through compressed video. Federated learning capabilities allow distributed systems to share geometric patterns while preserving content privacy. The architecture enables improved compression ratios while maintaining both temporal causality and semantic navigability, transforming video from sequential media into an intelligently accessible information space.

According to a preferred embodiment, a computing system for video compression is disclosed, comprising: a processor; and a memory storing instructions that, when executed by the processor, cause the computing system to implement: a hierarchical encoder configured to receive video data and generate compressed representations at a plurality of hierarchical scales; a geometric processor configured to organize the compressed representations within a manifold structure having geometric properties that encode relationships between video elements, the geometric processor configured to: compute paths through the manifold that represent evolution of video content over time; determine geometric characteristics based on content properties; and enforce constraints maintaining temporal relationships during compression; a cognitive interface configured to provide semantic understanding of video content, the cognitive interface configured to: organize related concepts into navigable structures within the manifold; enable traversal of the manifold based on semantic relationships; and adapt the manifold structure based on learned patterns; a decoder configured to reconstruct video from the compressed representations using information from both the geometric processor and the cognitive interface; and a navigation system configured to enable access to compressed video content based on semantic queries.

According to another preferred embodiment, a computer-implemented method for video compression is disclosed, comprising the steps of: receiving video data and generating compressed representations at a plurality of hierarchical scales; organizing the compressed representations within a manifold structure having geometric properties that encode relationships between video elements, the organizing comprising: computing paths through the manifold that represent evolution of video content over time; determining geometric characteristics based on content properties; and enforcing constraints maintaining temporal relationships during compression; providing semantic understanding of video content through a cognitive interface, the providing comprising: organizing related concepts into navigable structures within the manifold; enabling traversal of the manifold based on semantic relationships; and adapting the manifold structure based on learned patterns; reconstructing video from the compressed representations using information from both the geometric organizing and the semantic understanding; and enabling access to compressed video content based on semantic queries.

According to a further aspect, the method includes organizing the compressed representations by organizing within a Lorentzian manifold having a metric tensor with negative temporal signature to distinguish time dimensions from spatial dimensions, and computing time-like geodesics through the Lorentzian manifold with light cone constraints that prevent acausal information flow.

According to a further aspect, the method includes providing semantic understanding by: creating submanifolds containing semantically related video elements as thought bundles, each submanifold having local geometric properties reflecting semantic density; and modifying curvature of the manifold based on usage patterns and creating new connections between thought bundles based on discovered relationships.

According to a further aspect, the method includes reconstructing video by: identifying spatiotemporal relationships between compressed elements through a correlation network; progressively combining representations from different hierarchical scales; and applying refinements guided by the semantic understanding.

According to a further aspect, the method includes enabling access by identifying semantically significant points within the video as anchors and assigning them positions within the manifold, the anchors being categorized as at least one of: decision points for narrative branches, semantic boundaries for concept transitions, navigation waypoints for reference locations, and temporal markers for time-based events.

According to a further aspect, the method includes extracting geometric patterns from the manifold structure; applying privacy-preserving transformations that remove content-specific information while maintaining geometric and topological properties; and sharing abstracted patterns with other video compression systems to enable collective learning without content disclosure.

According to a further aspect, the method includes generating initial coarse compressed representations with minimal latency; progressively refining the representations by adding hierarchical detail; and streaming video content while refinement continues in parallel, including terminating refinement when quality targets are achieved.

According to a further aspect, the method includes providing semantic understanding by implementing a persistent cognitive machine having sensory encoding corresponding to the generating compressed representations, cognitive processing implementing the manifold operations, and motor decoding corresponding to the reconstructing, and wherein the method further comprises evolving the manifold structure through dreaming operations comprising perturbation, recombination, and pruning of structures.

According to a further aspect, the method includes generating compressed representations by generating at least macro-scale, meso-scale, and micro-scale representations capturing progressively finer details.

According to a further aspect, the method includes generating compressed representations performed on edge devices; the organizing within a manifold structure and providing semantic understanding are performed on cloud resources; and the reconstructing is performed on client devices, wherein the method processes multiple video types including standard video, volumetric video, and holographic video.

### BRIEF DESCRIPTION OF THE DRAWING FIGURES

FIG. 1 is a block diagram illustrating an exemplary system architecture for complex-valued SAR image compression with predictive recovery, according to an embodiment.

FIGS. 2A and 2B illustrate an exemplary architecture for an AI deblocking network configured to provide deblocking on dual-channel data stream comprising SAR I/Q data, according to an embodiment.

FIG. 3 is a block diagram illustrating an exemplary architecture for a component of the system for SAR image compression, the channel-wise transformer.

FIG. 4 is a block diagram illustrating an exemplary system architecture for providing lossless data compaction, according to an embodiment.

FIG. 5 is a diagram showing an embodiment of one aspect of the lossless data compaction system, specifically data deconstruction engine.

FIG. 6 is a diagram showing an embodiment of another aspect of lossless data compaction system 600, specifically data reconstruction engine.

FIG. 7 is a flow diagram showing an embodiment of another aspect of lossless data compaction the system 700, specifically library manager.

FIG. 8 is a flow diagram illustrating an exemplary method for complex-valued SAR image compression, according to an embodiment.

FIG. 9 is a flow diagram illustrating and exemplary method for decompression of a complex-valued SAR image, according to an embodiment.

FIG. 10 is a flow diagram illustrating an exemplary method for deblocking using a trained deep learning algorithm, according to an embodiment.

FIGS. 11A and 11B illustrate an exemplary architecture for an AI deblocking network configured to provide deblocking for a general N-channel data stream, according to an embodiment.

FIG. 12 is a block diagram illustrating an exemplary system architecture for N-channel data compression with predictive recovery, according to an embodiment.

FIG. 13 is a flow diagram illustrating an exemplary method for processing a compressed n-channel bit stream using an AI deblocking network, according to an embodiment.

FIG. 14 is a block diagram illustrating an exemplary system architecture for a neural compaction system with Lorentzian autoencoder and persistent cognitive machine (PCM) interface, according to an embodiment.

FIG. 15 is a flow diagram illustrating an exemplary method for spatiotemporal video compression using a Lorentzian autoencoder system, according to an embodiment.

FIG. 16 is a flow diagram illustrating an exemplary method for PCM-guided cognitive navigation in compressed video, according to an embodiment.

FIG. 17 is a flow diagram illustrating an exemplary method for multi-scale zoom with synthetic detail generation in compressed video, according to an embodiment.

FIG. 18 is a flow diagram illustrating an exemplary method for manifold evolution through cognitive operations, according to an embodiment.

FIG. 19 is a flow diagram illustrating an exemplary method for temporal causality preservation during video compression, according to an embodiment.

FIG. 20 is a flow diagram illustrating an exemplary method for correlation network enhancement with persistent cognitive machine PCM guidance, according to an embodiment.

FIG. 21 is a flow diagram illustrating an exemplary method for symbolic anchor management and semantic navigation in compressed video.

FIG. 22 is a flow diagram illustrating an exemplary method for federated learning across persistent cognitive machine instances, according to an embodiment.

FIG. 23 is a flow diagram illustrating an exemplary method for real-time video processing with progressive refinement, according to an embodiment.

FIG. 24 illustrates an exemplary computing environment on which an embodiment described herein may be implemented, in full or in part.

### DETAILED DESCRIPTION OF THE INVENTION

The inventor has conceived, and reduced to practice, a video compression system and method integrates geometric compression with cognitive understanding through a persistent cognitive machine interface. The system employs a hierarchical encoder generating multi-scale compressed representations organized within a Lorentzian manifold structure. A geometric processor maintains temporal causality through time-like geodesics and light cone constraints while organizing video content according to semantic relationships. A cognitive interface creates thought bundles as navigable submanifolds, enabling semantic access to compressed content beyond traditional temporal indexing. The system supports real-time processing through progressive refinement, streaming coarse representations immediately while adding detail in parallel. Symbolic anchors mark semantically significant points, enabling concept-based navigation through compressed video. Federated learning capabilities allow distributed systems to share geometric patterns while preserving content privacy. The architecture enables improved compression ratios while maintaining both temporal causality and semantic navigability, transforming video from sequential media into an intelligently accessible information space.

The Lorentzian Autoencoder for Video implements a neural architecture that embeds video data into a Lorentzian manifold, fundamentally differing from traditional autoencoders by incorporating the causal structure of time through geometric constraints. The autoencoder employs a metric tensor g_{μν}=diag(−c², 1, 1, . . . , 1) where the negative signature in the temporal dimension enforces the distinction between time and space, and c represents a scaling factor analogous to the speed of light that determines the maximum rate of information propagation through the video. This metric structure ensures that the encoded representations respect causality, preventing future frames from influencing past reconstructions. The encoder learns to map video tensors onto geodesics in this Lorentzian space, where the geodesic equation d²x^{μ}/dτ²+Γ^{μ}_{νρ}(dx^{ν}/dτ)(dx^{ρ}/dτ)=0 governs the evolution of encoded video content along time-like paths. The Christoffel symbols Γ^{μ}_{νρ}=½g\hat{ }μσ(∂_ν g_{σρ}+∂_{ρ}g_{σν}−∂_{σ}g_{νρ}) are computed from the learned metric, creating a self-consistent geometric structure that adapts to video content. The training employs a composite loss function Lₜₒₜₐₗ=λᵣL_{reconstruction}+λ_{g}L_{geodesic}+λ_{c}L_{causality}+λₛL_{sparsity}, where L_{reconstruction} measures fidelity to input video, L_{geodesic}=∫|d²x^{μ}/dτ²+Γ^{μ}_{νρ}(dx^{ν}/dτ)(dx^{ρ}/dτ)|²dτ penalizes deviation from geodesic paths, L_{causality} enforces light cone constraints preventing acausal connections, and L_{sparsity} promotes efficient representations. This architecture enables the autoencoder to learn compressed representations that naturally follow the physical evolution of video content while maintaining mathematical rigor in preserving temporal relationships.

The Hierarchical Latent and Zoom Controller orchestrates navigation through the multi-scale compressed representations by managing transitions between the macro (H_{macro}), meso (Hₘₑₛₒ), and micro (H_{micro}) hierarchical levels. The controller employs a policy function π(sₜ, hₜ)→aₜ that maps the current state sₜ and hierarchical level hi to an action at determining zoom operations, where actions include zooming in to finer scales, zooming out to coarser scales, or lateral navigation within the current scale. The zoom decisions are governed by a detail threshold function δ(r, h) that evaluates whether region r at hierarchy h contains sufficient semantic importance to warrant higher resolution exploration, computed as δ(r, h)=σ(W_{δ}·[f_{semantic}(r), fₘₒₜᵢₒₙ(r), fᵤₛₑᵣ(r)]) where f_{semantic} captures semantic density from the PCM interface, fₘₒₜᵢₒₙ measures temporal activity, and fᵤₛₑᵣ incorporates user attention patterns. The controller dynamics follow the state evolution equation s_{{t+1}}=T(sₜ, aₜ) where the transition function T implements smooth interpolation between hierarchical levels according to x_{{t+1}}=(1−αₜ)xₜ^{h}ₜ+αₜxₜ^{h}ₜ₊₁, with αₜ∈[0,1] controlling the blend between adjacent hierarchy levels during transitions. The hierarchical navigation is constrained by the consistency equation C(H_{macro}, Hₘₑₛₒ, H_{micro})=∥P_{↓}(H_{fine})−H_{coarse}∥²<ε, where P_{↓} represents the downsampling projection operator, ensuring that finer scales remain consistent with coarser representations. This controller enables efficient exploration of the compressed video space by dynamically adjusting the level of detail based on content importance and navigation context, allocating computational resources optimally while maintaining smooth user experience through the mathematical framework that governs hierarchical transitions.

A reversible replay mechanism enables bidirectional navigation through compressed video while maintaining an immutable audit trail for federated playback scenarios across multiple PCM instances. In some embodiments, the system implements a cryptographic audit mechanism using exponential and logarithmic mappings that create verifiable playback histories without revealing specific content. For each navigation action aᵢ at time tᵢ, the system computes an audit token τᵢ=exp(H(sᵢ∥aᵢ∥tᵢ)) where H is a cryptographic hash function, sᵢ represents the manifold state, and the exponential mapping ensures forward secrecy. The accumulated audit trail Aₙ=Πᵢ₌₁ⁿτᵢ forms a multiplicative group structure that enables efficient verification of playback sequences through the property that log(Aₙ)=Σ{i=1}ⁿ log(τᵢ)=Σᵢ₌₁ⁿH(sᵢ∥aᵢ∥tᵢ). This logarithmic verification allows federated systems to confirm navigation patterns without accessing individual states. The reversible navigation employs a bijective transformation R: M×A→M where M represents the manifold space and A the action space, ensuring that for any forward navigation sequence {a₁, a₂, . . . , aₙ}, there exists a unique reverse sequence {aₙ⁻¹, . . . , a₂⁻¹, a₁⁻¹ computed through R⁻¹. The system maintains causal consistency during reverse playback by preserving light cone constraints in the Lorentzian manifold, where reverse navigation follows time-reversed geodesics satisfying d²x^{μ}/d(−τ)²+Γ^{μ}_{νρ}(dx^{ρ}/d(−τ))(dx^{ρ}/d(−τ))=0. The federated audit mechanism enables privacy-preserving analytics across distributed PCM instances by sharing only the aggregate audit tokens exp(ΣⱼHⱼ) without revealing individual viewing patterns, while the homomorphic property of the exponential mapping allows computation of collective statistics through token multiplication. This architecture supports applications requiring verifiable playback history such as educational systems confirming content consumption, surveillance systems maintaining chain of custody, and distributed content delivery networks optimizing caching based on verified navigation patterns.

A channel-wise transformer with attention is a neural network architecture that combines elements of both the transformer architecture and channel-wise attention mechanisms. It's designed to process multi-channel data, such as complex-valued radar image images, where each channel corresponds to a specific feature map or modality. The transformer architecture is a powerful neural network architecture initially designed for natural language processing (NLP) tasks. It consists of self-attention mechanisms that allow each element in a sequence to capture relationships with other elements, regardless of their position. The transformer has two main components: the self-attention mechanism (multi-head self-attention) and feedforward neural networks (position-wise feedforward layers). Channel-wise attention, also known as “Squeeze-and-Excitation” (SE) attention, is a mechanism commonly used in convolutional neural networks (CNNs) to model the interdependencies between channels (feature maps) within a single layer. It assigns different weights to different channels to emphasize important channels and suppress less informative ones. At each layer of the network, a channel-wise attention mechanism is applied to the input data. This mechanism captures the relationships between different channels within the same layer and assigns importance scores to each channel based on its contribution to the overall representation. After the channel-wise attention, a transformer-style self-attention mechanism is applied to the output of the channel-wise attention. This allows each channel to capture dependencies with other channels in a more global context, similar to how the transformer captures relationships between elements in a sequence. Following the transformer self-attention, feedforward neural network layers (position-wise feedforward layers) can be applied to further process the transformed data.

One or more different aspects may be described in the present application. Further, for one or more of the aspects described herein, numerous alternative arrangements may be described; it should be appreciated that these are presented for illustrative purposes only and are not limiting of the aspects contained herein or the claims presented herein in any way. One or more of the arrangements may be widely applicable to numerous aspects, as may be readily apparent from the disclosure. In general, arrangements are described in sufficient detail to enable those skilled in the art to practice one or more of the aspects, and it should be appreciated that other arrangements may be utilized and that structural, logical, software, electrical and other changes may be made without departing from the scope of the particular aspects. Particular features of one or more of the aspects described herein may be described with reference to one or more particular aspects or figures that form a part of the present disclosure, and in which are shown, by way of illustration, specific arrangements of one or more of the aspects. It should be appreciated, however, that such features are not limited to usage in the one or more particular aspects or figures with reference to which they are described. The present disclosure is neither a literal description of all arrangements of one or more of the aspects nor a listing of features of one or more of the aspects that must be present in all arrangements.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects and in order to more fully illustrate one or more aspects. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method, or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

### Definitions

The term “bit” refers to the smallest unit of information that can be stored or transmitted. It is in the form of a binary digit (either 0 or 1). In terms of hardware, the bit is represented as an electrical signal that is either off (representing 0) or on (representing 1).

The term “codebook” refers to a database containing sourceblocks each with a pattern of bits and reference code unique within that library. The terms “library” and “encoding/decoding library” are synonymous with the term codebook.

The terms “compression” and “deflation” as used herein mean the representation of data in a more compact form than the original dataset. Compression and/or deflation may be either “lossless”, in which the data can be reconstructed in its original form without any loss of the original data, or “lossy” in which the data can be reconstructed in its original form, but with some loss of the original data.

The terms “compression factor” and “deflation factor” as used herein mean the net reduction in size of the compressed data relative to the original data (e.g., if the new data is 70% of the size of the original, then the deflation/compression factor is 30% or 0.3.)

The terms “compression ratio” and “deflation ratio”, and as used herein all mean the size of the original data relative to the size of the compressed data (e.g., if the new data is 70% of the size of the original, then the deflation/compression ratio is 70% or 0.7.)

The term “data set” refers to a grouping of data for a particular purpose. One example of a data set might be a word processing file containing text and formatting information. Another example of a data set might comprise data gathered/generated as the result of one or more radars in operation.

The term “sourcepacket” as used herein means a packet of data received for encoding or decoding. A sourcepacket may be a portion of a data set.

The term “sourceblock” as used herein means a defined number of bits or bytes used as the block size for encoding or decoding. A sourcepacket may be divisible into a number of sourceblocks. As one non-limiting example, a 1 megabyte sourcepacket of data may be encoded using 512 byte sourceblocks. The number of bits in a sourceblock may be dynamically optimized by the system during operation. In one aspect, a sourceblock may be of the same length as the block size used by a particular file system, typically 512 bytes or 4,096 bytes.

The term “codeword” refers to the reference code form in which data is stored or transmitted in an aspect of the system. A codeword consists of a reference code to a sourceblock in the library plus an indication of that sourceblock's location in a particular data set.

The term “deblocking” as used herein refers to a technique used to reduce or eliminate blocky artifacts that can occur in compressed images or videos. These artifacts are a result of lossy compression algorithms, such as JPEG for images or various video codecs like H.264, H.265 (HEVC), and others, which divide the image or video into blocks and encode them with varying levels of quality. Blocky artifacts, also known as “blocking artifacts,” become visible when the compression ratio is high, or the bitrate is low. These artifacts manifest as noticeable edges or discontinuities between adjacent blocks in the image or video. The result is a visual degradation characterized by visible square or rectangular regions, which can significantly reduce the overall quality and aesthetics of the content. Deblocking techniques are applied during the decoding process to mitigate or remove these artifacts. These techniques typically involve post-processing steps that smooth out the transitions between adjacent blocks, thus improving the overall visual appearance of the image or video. Deblocking filters are commonly used in video codecs to reduce the impact of blocking artifacts on the decoded video frames. A primary goal of deblocking is to enhance the perceptual quality of the compressed content, making it more visually appealing to viewers. It's important to note that deblocking is just one of many post-processing steps applied during the decoding and playback of compressed images and videos to improve their quality.

### Conceptual Architecture

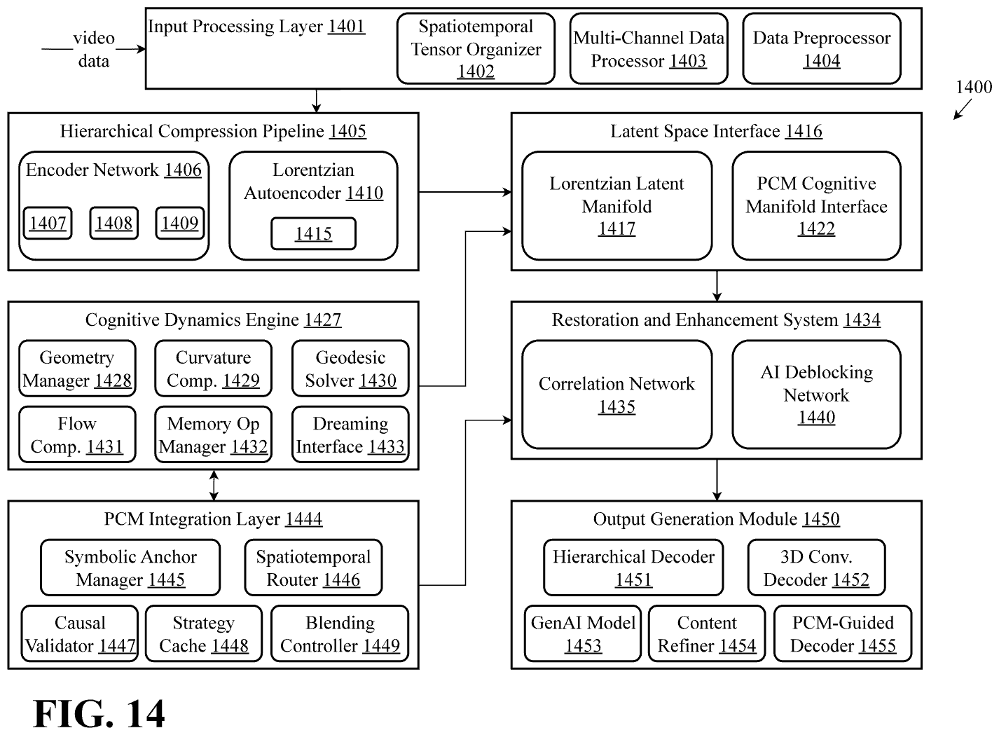

FIG. 14 is a block diagram illustrating an exemplary system architecture for a neural compaction system with Lorentzian autoencoder and persistent cognitive machine (PCM) interface 1400, according to an embodiment. System 1400 can be configured as a comprehensive data compression and cognitive reasoning framework that integrates hierarchical neural compression techniques with spatiotemporal video processing capabilities and geometric manifold-based cognitive operations. The system architecture extends traditional compression methodologies by incorporating Lorentzian geometric principles for video data representation and persistent cognitive structures for intelligent interaction with compressed content. The system 1400 is designed to process video input data organized as spatiotemporal tensors while maintaining causal relationships, enabling continuous multi-scale exploration, and providing cognitive reasoning capabilities through geometric manifold operations.

An input processing layer 1401 serves as the initial stage of system 1400, receiving and preparing video data for subsequent compression and cognitive processing. Within the input processing layer 1401, a spatiotemporal tensor organizer 1402 receives video input V∈R^{T×H×W×C}, where T represents the temporal dimension, H and W represent spatial height and width dimensions, and C represents the number of channels. In some implementations, video input may comprise more or fewer dimensions than those described herein. The spatiotemporal tensor organizer 1402 structures the incoming video stream into n-dimensional (e.g., three-dimensional) tensors that preserve both spatial and temporal relationships throughout the processing pipeline. This organization supports maintaining temporal causality and enabling coherent navigation through compressed video representations. The tensor organization may involve segmentation based on scene changes, fixed temporal windows, or adaptive partitioning strategies that respond to content characteristics.

A multi-channel data processor 1403 within input processing layer 1401 extends the system's capabilities beyond traditional single or dual-channel inputs to handle N-channel data streams. This component generalizes the compression framework to accommodate diverse data types including but not limited to RGB video channels, hyperspectral imagery, multi-sensor fusion data, or any correlated multi-channel inputs. The multi-channel data processor 1403 analyzes inter-channel correlations and dependencies, enabling more efficient compression by exploiting redundancies across channels. A data preprocessor 1404 performs necessary transformations on the input data, including clipping operations to manage dynamic range, normalization to ensure consistent scaling across channels, and format conversion to prepare data for the hierarchical compression pipeline. In some aspects, preprocessor 1404 may implement adaptive preprocessing strategies based on content characteristics and downstream processing requirements.

A hierarchical compression pipeline 1405 implements multi-scale compression through parallel processing paths optimized for different types of features and temporal dynamics. Within this pipeline, a hierarchical encoder network 1406 comprises multiple encoding levels that progressively compress input data while preserving essential features at different scales. According to an embodiment, Level 1 encoder (H_{macro}) 1407 captures global scene structure and coarse-scale features, operating on downsampled representations to identify overarching patterns and scene composition. This macro-level encoding establishes the foundational structure upon which finer details are layered. Level 2 encoder (Hₘₑₛₒ) 1408 focuses on intermediate features including textures, edges, and motion boundaries, capturing the mid-scale patterns that define object boundaries and surface characteristics. Level 3 encoder (H_{micro}) 1409 preserves fine-grained pixel-level details and subtle variations, maintaining the high-frequency information necessary for detailed reconstruction.

A Lorentzian autoencoder (LAE) 1410 operates in parallel with the hierarchical encoder network 1406, implementing specialized compression for spatiotemporal video data through geometric principles. The LAE 1410 embeds video sequences as time-like geodesic trajectories in a Lorentzian latent space, where the metric structure naturally encodes causal relationships and temporal evolution. A 3D convolutional encoder within the LAE 1410 applies three-dimensional convolutional operations that simultaneously process spatial and temporal dimensions, preserving spatiotemporal correlations that would be lost in frame-by-frame processing approaches. The 3D convolutional operations employ kernels that extend across time, enabling the encoder to capture motion patterns, temporal textures, and dynamic scene elements.

A Lorentzian metric embedding component of LAE 1410 transforms the encoded representations into a geometric space governed by Lorentzian metric g_{μν}=diag(−1, 1, 1, . . . , 1), where the negative signature in the temporal dimension enforces causal structure. This embedding ensures that the compressed representations respect temporal ordering and maintain physically meaningful relationships between past and future frames. Mini-Lorentzian representations may be implemented to serve as the compressed tensor structures output by the LAE, maintaining the n-dimensional organization while enabling significant dimensionality reduction. These representations preserve local geometric properties that enable subsequent reconstruction and navigation operations.

A latent diffusor models the temporal dynamics within the compressed space, learning the patterns of change and evolution in video sequences. The latent diffusor may implement recurrent architectures, attention mechanisms, or specialized temporal modeling components that capture how compressed representations evolve over time. This temporal modeling enables predictive capabilities and supports temporal interpolation during reconstruction. A zoom controller 1415 manages multi-scale exploration capabilities, coordinating between different levels of the hierarchical representations to enable seamless zooming operations. The zoom controller implements control functions π: (z, σ)→α that map latent positions z and scale parameters σ to blending coefficients α, enabling smooth transitions between scales.

A latent space architecture interface 1416 provides the geometric substrate for both compression and cognitive operations. Within this architecture, a Lorentzian latent manifold 1417 serves as the primary geometric space where compressed video representations exist as navigable structures. The manifold exhibits variable curvature regions that reflect the semantic density and complexity of different areas within the compressed space. Regions of high curvature correspond to semantically rich areas requiring careful navigation, while flatter regions represent more uniform or predictable content. Geodesic trajectories within the manifold represent the natural evolution of video content over time, with the Lorentzian metric ensuring these trajectories respect causal constraints.

Compression pressure fields encode the local compression difficulty across the manifold, creating a scalar field that influences navigation and reconstruction strategies. Areas of high compression pressure indicate complex or information-dense content requiring more careful handling during decompression and navigation. Symbolic anchor positions mark semantically significant locations within the manifold, serving as navigation waypoints and semantic reference points. These anchors may correspond to scene changes, important objects, or other meaningful events within the video sequence.

A PCM cognitive manifold interface 1422 extends the latent space with cognitive structures that enable reasoning and intelligent interaction with compressed content. Thought bundles exist as submanifolds within the larger latent space, representing coherent conceptual structures related to the video content. Each thought bundle maintains its own internal geometry and can evolve through cognitive operations. Goal potential fields create attractive forces within the manifold that guide cognitive attention toward relevant regions based on user queries or system objectives. These fields shape the energy landscape of the manifold, making certain navigation paths more favorable than others.

Attention vector fields define the flow of cognitive focus across the manifold, creating streamlines that guide reasoning processes through relevant conceptual territories. The vector fields adapt based on context and goals, creating dynamic navigation patterns that evolve with use. Memory operation structures enable the persistence and evolution of cognitive patterns, storing successful navigation strategies, learned associations, and refined conceptual relationships. These structures support both short-term working memory operations and long-term knowledge consolidation.

A cognitive dynamics engine (CDE) 1427 manages the geometric operations that enable cognitive reasoning within the compressed representation space. A geometry manager 1428 maintains the manifold's metric tensor and topological structure, ensuring geometric consistency as the space evolves through use. Geometry manager 1428 handles coordinate transformations, metric updates, and structural modifications while preserving essential geometric properties. A curvature computer 1429 calculates local curvature tensors and derived geometric quantities that inform navigation and reasoning strategies. The computed curvature information can be used to determine compression pressure, influence geodesic paths, and guide the formation of cognitive structures.

A geodesic solver 1430 computes optimal paths through the manifold by solving the geodesic equation d²x^{μ}/dτ²+Γ^{μ}_{νρ}(dx^{ν}/dτ)(dx^{ρ}/dτ)=0, where Γ^{μ}_{νρ} are the Christoffel symbols derived from the manifold's metric. These geodesic paths represent both efficient navigation routes and natural reasoning trajectories that respect the manifold's geometric structure. A flow computer 1431 manages the dynamics of attention and cognitive resources across the manifold, implementing flow equations that govern how cognitive focus moves through the space. The flow computation considers both the underlying geometry and active goal potentials to create purposeful navigation patterns.

A memory operation manager 1432 coordinates the various memory operations that modify the manifold's structure based on experience. These operations may comprise fanning-in processes that strengthen frequently used pathways, fanning-out operations that explore new conceptual territories, and rebinding procedures that create new associations between previously disparate concepts. A dreaming interface 1433 enables autonomous manifold reorganization during inactive periods, implementing consolidation processes that optimize the geometric structure for improved efficiency and coherence. The dreaming operations may include smoothing of unnecessary complexity, discovery of latent patterns, and strengthening of important conceptual bridges.

A restoration and enhancement system 1434 processes the compressed representations to reconstruct high-quality output while leveraging both learned correlations and cognitive guidance. A correlation network 1435 implements neural upsampling techniques specifically adapted for spatiotemporal data, exploiting correlations across spatial, temporal, and channel dimensions. In some embodiments, correlation network 1435 incorporates temporal correlation mechanisms that identify and leverage patterns across time, enabling the recovery of information lost during compression by exploiting temporal redundancy and predictability.

A channel-wise transformer within the correlation network 1435 processes multi-channel data using attention mechanisms that capture inter-channel dependencies. The transformer architecture enables the network to dynamically weight the importance of different channels based on context, improving restoration quality for multi-channel inputs. Spatiotemporal attention mechanisms enable the correlation network to focus on relevant regions across both space and time when performing restoration, adapting its processing based on local content characteristics. Multi-scale restoration capabilities allow the correlation network to operate at different resolution levels, matching the hierarchical nature of the compression pipeline and enabling progressive reconstruction.

An AI deblocking network 1440 specifically addresses compression artifacts in video data through learned restoration techniques. Video artifact removal components identify and eliminate blocking artifacts, ringing effects, and other compression-induced distortions while preserving legitimate image features. Temporal consistency mechanisms ensure that artifact removal maintains coherence across frames, preventing flickering or sudden changes that would disrupt viewing experience. PCM-guided enhancement leverages cognitive understanding from the PCM interface to inform restoration decisions, using semantic knowledge to guide artifact removal and detail enhancement.

A PCM integration layer 1444 provides the interface between the core compression system and the cognitive reasoning capabilities. A symbolic anchor manager 1445 maintains the relationships between symbolic concepts and their geometric positions within the manifold, enabling semantic navigation and conceptual reasoning about compressed content. The anchor manager handles the creation, modification, and deletion of symbolic anchors as the system learns and evolves. A spatiotemporal router 1446 implements intelligent navigation strategies that consider both spatial and temporal aspects of the compressed content, planning efficient paths through the n-dimensional representation space.

A causal validator 1447 ensures that all navigation and manipulation operations respect temporal causality constraints imposed by the Lorentzian metric. This component prevents paradoxical operations such as information flow from future to past, maintaining physical consistency in temporal navigation. A strategy cache 1448 stores successful navigation patterns and reasoning strategies for reuse, implementing a form of procedural memory that improves system efficiency over time. The cached strategies are indexed by context and goals, enabling rapid retrieval of relevant navigation patterns. A blending controller 1449 manages the integration of generated content with original compressed data, ensuring seamless transitions between recorded and synthesized information during exploration and reconstruction.

An output generation module 1450 produces the final reconstructed video output by combining information from multiple processing pathways. A hierarchical decoder 1451 reverses the multi-scale encoding process, progressively reconstructing features from coarse to fine scales while maintaining consistency across levels. The hierarchical decoding process leverages skip connections and residual pathways to preserve detail information throughout reconstruction. A 3D convolutional decoder 1452 specifically handles the tensor-structured outputs from the Lorentzian autoencoder, applying three-dimensional transposed convolutions that simultaneously reconstruct spatial and temporal dimensions while maintaining their relationships.

A generative AI model 1453 synthesizes additional detail when users explore beyond the original resolution or temporal boundaries of the input video. The generative model is conditioned on the manifold geometry and surrounding context, ensuring that synthesized content maintains consistency with the original material. A content refiner 1454 performs final quality enhancement on the reconstructed output, ensuring coherence, removing residual artifacts, and optimizing perceptual quality. The refinement process considers both local detail and global consistency to produce visually pleasing results. A PCM-guided decoder 1455 leverages cognitive understanding from the PCM interface to inform reconstruction decisions, using semantic knowledge to resolve ambiguities and enhance relevant details based on user focus and system goals.

According to some embodiments, optional components provide additional capabilities that may be included based on specific implementation requirements. A reversible mode logger implements audit trail functionality using exponential and logarithmic maps on the latent manifold, enabling round-trip verification and debugging of compression operations. The logger records the sequence of geometric transformations applied during compression and navigation, supporting system validation and federated replay scenarios. A federated learning interface enables knowledge sharing and collaborative learning across multiple system instances while maintaining privacy through geometric abstraction. The interface allows systems to share learned manifold structures and navigation strategies without exposing raw data. A lossless compactor provides an additional compression stage that applies entropy coding techniques to the already-compressed representations, achieving further size reduction for storage or transmission scenarios where bandwidth is critical.

The integrated operation of system 1400 enables advanced capabilities beyond traditional compression systems. Video data flows through the input processing layer 1401 where it is organized into spatiotemporal tensors and preprocessed for compression. The hierarchical compression pipeline 1405 and Lorentzian autoencoder 1410 operate in parallel to create multi-scale compressed representations that preserve different aspects of the input. These representations are embedded within the latent space 1416, where they exist as navigable geometric structures influenced by both compression efficiency and cognitive organization. The cognitive dynamics engine 1427 continuously shapes and optimizes this geometric space based on usage patterns and learning. During reconstruction, the restoration and enhancement pipeline 1434 leverages learned correlations and cognitive guidance to produce high-quality output. The PCM integration layer 1444 enables intelligent interaction with the compressed content, supporting semantic queries and guided exploration. Finally, the output generation module 1450 combines information from all processing streams to produce the reconstructed video output, potentially enhanced with generated details for multi-scale exploration.

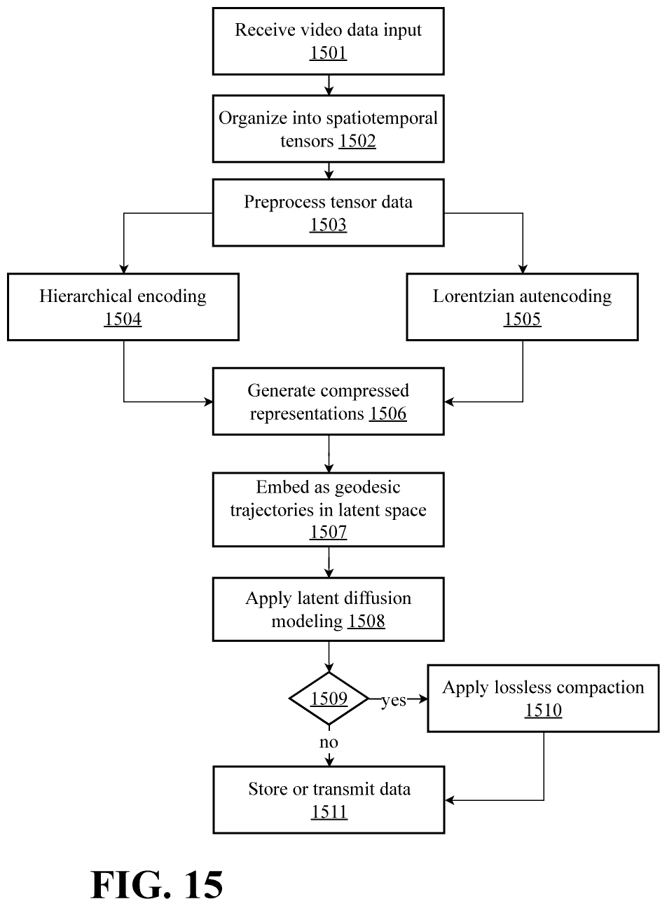

FIG. 15 is a flow diagram illustrating an exemplary method for spatiotemporal video compression using a Lorentzian autoencoder system, according to an embodiment. The method begins at step when system 1400 initiates the compression process for video data that will be processed as spatiotemporal tensors while preserving causal relationships and enabling multi-scale representation. This compression method represents a significant departure from traditional frame-by-frame video compression techniques by treating video as a unified four-dimensional structure where spatial and temporal dimensions are processed simultaneously through geometric principles.

According to the embodiment, the process begins at step 1501, the system receives video input V. The video input is received in a format that maintains the inherent relationships between spatial and temporal dimensions, enabling the subsequent processing steps to exploit these relationships for more efficient compression. The system may receive video from various sources including but not limited to live camera feeds, stored video files, streaming services, or other multimedia applications requiring efficient compression while maintaining the ability for intelligent interaction with the compressed content.

In step 1502, the system organizes the received video input into spatiotemporal tensors that preserve the three-dimensional structure of the video data. This organization process involves segmenting the continuous video stream into manageable tensor blocks that can be processed efficiently while maintaining temporal continuity. The segmentation may be performed based on various criteria including scene change detection, where natural boundaries in the video content guide the tensor organization; fixed temporal windows, where consistent time intervals define tensor boundaries; or adaptive partitioning that responds to content complexity and motion characteristics. During this organization step, the system ensures that the spatial dimensions (H×W) remain coupled with the temporal dimension (T), creating true three-dimensional data structures rather than treating frames as independent two-dimensional images. This preservation of spatiotemporal structure is important for enabling the Lorentzian geometric processing in subsequent steps and for maintaining causal relationships throughout the compression pipeline.

Step 1503 involves preprocessing the organized tensor data to prepare it for the dual-path compression pipeline. The preprocessing operations include normalization of channel values to ensure consistent scaling across different input sources and channel types. This normalization may involve computing channel-wise statistics such as mean and standard deviation, then applying standardization transforms that center and scale the data appropriately. Additionally, the preprocessing step applies clipping operations to manage the dynamic range of the input data, preventing extreme values from dominating the compression process while preserving the essential information content. The clipping thresholds may be determined adaptively based on the statistical properties of the input data, ensuring that only a small percentage of outlier values are affected while the majority of the meaningful signal is preserved. The preprocessing step may also include other transformations such as color space conversion, noise reduction, or format alignment to optimize the data for subsequent encoding operations.

Following preprocessing, the method enters a parallel processing phase where the video tensors are simultaneously processed through two or more complementary encoding pathways. This parallel architecture, indicated by the branching at step 1503, enables the system to capture different aspects of the video content through specialized processing streams that are later combined to create a comprehensive compressed representation. The parallel processing approach ensures that both fine-grained spatial details and broad temporal patterns are preserved in the compressed output.

In the left branch of the parallel processing, step 1504 performs hierarchical encoding through multiple levels of spatial feature extraction. The hierarchical encoder operates at various distinct scales to capture different aspects of the video content. At the H_{macro} level, the encoder captures global scene structure, identifying large-scale patterns such as scene composition, dominant objects, and overall motion trends. This macro-level encoding operates on significantly downsampled representations of the input tensors, enabling efficient capture of coarse-scale features while dramatically reducing data dimensionality. The Hₘₑₛₒ level focuses on intermediate features including textures, edges, and local motion patterns that define object boundaries and surface characteristics. This level bridges the gap between global structure and fine details, preserving the mid-frequency information that is crucial for visual quality. The H_{micro} level preserves fine-grained pixel-level details and subtle variations that contribute to the perceived sharpness and clarity of the video. Each hierarchical level may employ different architectural elements such as varying kernel sizes, pooling strategies, and feature dimensions optimized for capturing information at the respective scale.

Simultaneously in the right branch, step 1505 performs Lorentzian autoencoding specifically designed for spatiotemporal data. This process begins with three-dimensional convolutional encoding that processes the video tensors using kernels that extend across both spatial and temporal dimensions. Unlike traditional two-dimensional convolutions that process individual frames, the 3D convolutional operations capture spatiotemporal patterns such as motion, temporal textures, and dynamic scene elements. The key distinguishing feature of this step is the application of the Lorentzian metric g_{μν}=diag(−1, 1, 1, . . . , 1), which imposes a geometric structure on the latent space that naturally encodes causal relationships. The negative signature in the temporal dimension ensures that the compression respects the arrow of time, preventing information from future frames from influencing the encoding of past frames. This causal structure preservation is essential for maintaining physical consistency in the compressed representation and enables meaningful navigation through the compressed video along time-like paths.

Step 1506 involves generating compressed representations by combining the outputs from both parallel encoding paths. The hierarchical encoding path produces multi-scale mini-representations that capture spatial features at different resolutions, while the Lorentzian encoding path generates mini-Lorentzian tensors that preserve the three-dimensional structure of the video data. These compressed representations maintain sufficient information to enable high-quality reconstruction while achieving significant dimensionality reduction. The mini-Lorentzian tensors specifically retain the geometric properties necessary for subsequent navigation and exploration operations, including the metric structure that defines distances and angles within the compressed space. The combination of hierarchical and Lorentzian representations provides a rich, multi-faceted compression that captures both the spatial detail hierarchy and the temporal evolution patterns of the video content.

In step 1507, the system embeds the compressed representations as geodesic trajectories within the latent space. This embedding process transforms the discrete sequence of compressed tensors into continuous curves within the Lorentzian manifold, where each curve represents the temporal evolution of the video content. The geodesic trajectories are computed as the shortest paths with respect to the Lorentzian metric, ensuring that the embedded representation follows physically meaningful paths through the latent space. During this embedding process, the system also positions symbolic anchors at semantically significant points along the trajectories. These anchors may correspond to scene changes, key frames, detected objects, or other meaningful events that serve as navigation waypoints. The symbolic anchors are linked to semantic metadata that enables intelligent querying and navigation of the compressed content. The geodesic embedding creates a navigable structure where movement along the trajectories corresponds to temporal progression through the video, while movement perpendicular to the trajectories explores spatial or semantic variations.

Step 1508 applies latent diffusion modeling to capture and encode the temporal dynamics within the compressed space. The latent diffusion process models how the compressed representations evolve over time, learning the patterns of change that characterize the video content. This modeling may employ various architectural approaches including recurrent neural networks that maintain temporal state, attention mechanisms that capture long-range temporal dependencies, or specialized temporal convolution operations. The learned diffusion model enables several important capabilities: prediction of future frames based on past compressed representations, interpolation between frames for smooth playback at variable frame rates, and identification of anomalous temporal patterns that may indicate scene changes or important events. The diffusion modeling operates entirely within the compressed latent space, making it computationally efficient while preserving the essential temporal characteristics of the video.

At decision step 1509, the system determines whether additional lossless compaction should be applied to the compressed representations. This decision may be based on various factors including target bitrate requirements, available storage or bandwidth constraints, and the specific application requirements. If additional compaction is needed, the flow proceeds to step 1510 where lossless compaction techniques are applied to further reduce the size of the compressed data without any additional loss of information. The lossless compaction may employ entropy coding methods such as arithmetic coding or asymmetric numeral systems, dictionary-based compression for recurring patterns, or other reversible compression techniques that exploit remaining redundancies in the compressed representation. If additional compaction is not required, the flow proceeds directly to the storage/transmission step.

In step 1511, the system stores or transmits the compressed data, which now consists of multiple components that together enable full reconstruction and intelligent interaction with the video content. The stored data includes the hierarchical representations at multiple scales (H_{macro}, Hₘₑₛₒ, H_{micro}), the mini-Lorentzian tensors that preserve spatiotemporal structure, the geodesic trajectory metadata that enables navigation, and the symbolic anchor information for semantic access. This multi-component representation may be packaged into a unified container format that maintains the relationships between components while enabling selective access based on application needs. For example, a streaming application may initially transmit only the H_{macro} representations for rapid preview, followed by progressive transmission of finer scales as bandwidth permits. The storage format preserves all geometric and semantic metadata necessary for advanced operations such as multi-scale zoom, temporal navigation, and cognitive reasoning about the compressed content.

The method concludes having successfully compressed the input video into a compact yet information-rich representation that goes beyond traditional compression to enable new modes of interaction and understanding. This compression method enables high compression ratios while maintaining the ability to reconstruct high-quality video and supporting advanced features such as continuous zoom, temporal exploration, and integration with cognitive reasoning systems. The method is particularly well-suited for applications requiring not just efficient storage and transmission but also intelligent interaction with video content, such as video analytics, content-based retrieval, and immersive media experiences.

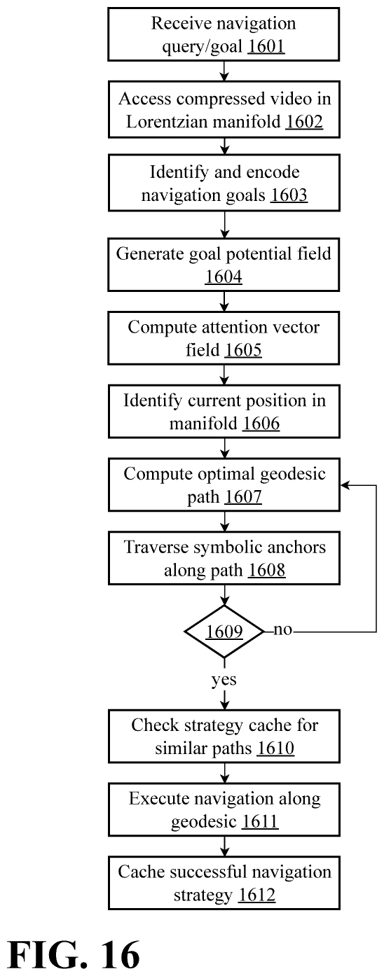

FIG. 16 is a flow diagram illustrating an exemplary method for PCM-guided cognitive navigation in compressed video, according to an embodiment. The method is prepared to start when the system initiates a cognitive navigation process that enables intelligent, goal-directed exploration of compressed video content through geometric reasoning within a Lorentzian manifold. This method leverages the PCM interface to enable semantic navigation, multi-scale exploration, and intelligent path planning through compressed video representations based on user goals and system understanding.

According to the embodiment, the process begins at step 1601 when the system receives a navigation query or goal that specifies the desired exploration objective within the compressed video content. This query may take various forms including natural language questions such as “show me when the main character enters the building,” semantic search requests like “find all scenes with red vehicles,” temporal navigation commands such as “explore what happens after the explosion,” or abstract exploration goals like “trace the emotional arc of this scene.” The system processes these diverse input types to extract the underlying navigation intent, identifying both explicit targets and implicit exploration patterns. The query processing leverages natural language understanding capabilities to parse semantic intent, temporal references, spatial specifications, and conceptual relationships that will guide the subsequent navigation process.

In step 1602, the system accesses the compressed video representation within the Lorentzian manifold, loading the necessary data structures to enable geometric navigation. This involves retrieving the mini-Lorentzian representations that encode the video content as compressed tensors preserving spatiotemporal structure, initializing the manifold's metric tensor guy that defines the geometric properties of the latent space, loading symbolic anchor positions that mark semantically significant locations, and establishing connections to the hierarchical representations at multiple scales. The system prepares the manifold for navigation by ensuring all geometric structures are properly initialized and accessible for the path planning computations that follow.

Step 1603 involves identifying and encoding the navigation goals extracted from the user query into geometric representations within the manifold. The goal identification process parses the semantic intent to determine what the user is seeking, whether it's specific objects, events, patterns, or abstract concepts. The system then maps these semantic goals to coordinates within the manifold by identifying regions where relevant content is likely to be encoded based on the manifold's learned structure. This mapping process considers the semantic organization of the latent space, where similar content clusters in nearby regions, and the temporal organization, where video evolution follows geodesic trajectories. Multiple goals may be identified from a single query, requiring the system to balance competing objectives during navigation.

In step 1604, the system generates a goal potential field Φ(x) that creates an attractive force toward the identified goal regions within the manifold. This scalar field is defined over the entire manifold space and encodes the desirability of each location based on its relevance to the navigation goals. The potential field is computed by assigning low potential values to goal regions, creating “valleys” that attract navigation paths, weighting contributions from multiple goals based on their relative importance, incorporating semantic similarity measures that create smooth gradients toward relevant content, and considering the accessibility of different regions based on the manifold's compression pressure. The resulting potential field shapes the energy landscape of the manifold, guiding subsequent navigation decisions.

Step 1605 computes an attention vector field V(x) that determines the flow of cognitive focus across the manifold during navigation. The vector field is derived from the goal potential field using the relation V(x)=−∇Φ(x)+drift terms, where the negative gradient creates flow toward low-potential regions. Additional drift terms incorporate factors such as compression pressure gradients that bias navigation toward efficiently encoded regions, learned navigation preferences from previous user interactions, temporal coherence constraints that favor smooth progression through time, and exploration bonuses that encourage discovery of novel content. The attention vector field creates streamlines through the manifold that represent natural paths of cognitive focus, adapted to both the goals and the structure of the compressed content.

In step 1606, the system identifies the current position within the manifold from which navigation will begin. This position may be determined by the user's current viewing location in the video, a previously bookmarked position, the result of a prior navigation operation, or a default starting point such as the beginning of a scene. The system also checks for nearby symbolic anchors that provide semantic context about the current location and potential navigation options. These anchors serve as landmarks within the manifold, offering both navigational reference points and semantic metadata about the surrounding content.

Step 1607 involves computing the optimal geodesic path from the current position to the goal regions by solving the modified geodesic equation set equal to the external forces from the goal potential and attention fields. This equation extends the standard geodesic equation by incorporating cognitive forces that guide the path toward semantically relevant regions while respecting the manifold's geometric constraints. The solution process must ensure that paths respect the Lorentzian causality constraints, preventing navigation that would violate temporal ordering. The computed geodesic represents the optimal navigation trajectory that balances efficiency, semantic relevance, and geometric naturalness.

In step 1608, the system traverses symbolic anchors encountered along the computed geodesic path, using these semantic waypoints to gather context and refine navigation. As the path passes near symbolic anchors, the system collects associated metadata including semantic labels, temporal markers, and cross-references to related content. This information enriches the navigation experience by providing interpretive context, enabling dynamic path adjustments based on discovered information, and creating opportunities for branching explorations. The symbolic anchor traversal transforms the geometric path into a semantically meaningful journey through the video content.

At decision step 1609, the system performs causal validation to ensure the computed navigation path respects temporal consistency constraints imposed by the Lorentzian metric. The validation checks whether the path maintains proper time-like or null separation between events, ensures information does not flow backward in time, and verifies that cause-and-effect relationships are preserved. If the path violates causality constraints, the system follows the feedback loop to step 1607 to recompute a valid path with additional constraints. This validation step is crucial for maintaining physical consistency in video navigation, preventing paradoxical operations such as seeing effects before their causes.

In step 1610, the system checks the strategy cache for previously successful navigation patterns similar to the current path. The cache stores navigation strategies indexed by goal types, starting and ending regions, path characteristics, and performance metrics. If similar strategies are found, the system can adapt them to the current context, potentially avoiding expensive recomputation while leveraging learned navigation patterns. The strategy cache implements a form of procedural memory that improves navigation efficiency over time as the system learns common patterns and successful approaches.

Step 1611 executes the navigation along the computed geodesic path through the manifold. During execution, the system follows the path by updating the current position according to the geodesic trajectory, reconstructing video content at positions along the path using the decoder networks, managing the level of detail based on navigation speed and user attention, and providing smooth transitions between different regions of the manifold. The navigation execution may involve progressive refinement, where coarse representations are displayed immediately while finer details are loaded asynchronously, enabling responsive interaction even with complex navigation operations.

In step 1612, the system caches the successful navigation strategy for future reuse, storing comprehensive information about the navigation operation including the computed path and its geometric properties, the goal configuration and resulting potential fields, performance metrics such as path length and computation time, and user feedback or interaction patterns. Additionally, the system updates the manifold's curvature based on the navigation usage, implementing a form of path reinforcement where frequently traversed routes become easier to navigate over time. This adaptive mechanism allows the manifold to evolve based on actual usage patterns, creating a personalized navigation space.

The method concludes having successfully completed a cognitively guided navigation through the compressed video content. This navigation method transforms compressed video from a static representation into an explorable space where movement is guided by both geometric efficiency and semantic relevance, enabling new forms of intelligent interaction with video content that go beyond traditional playback paradigms.

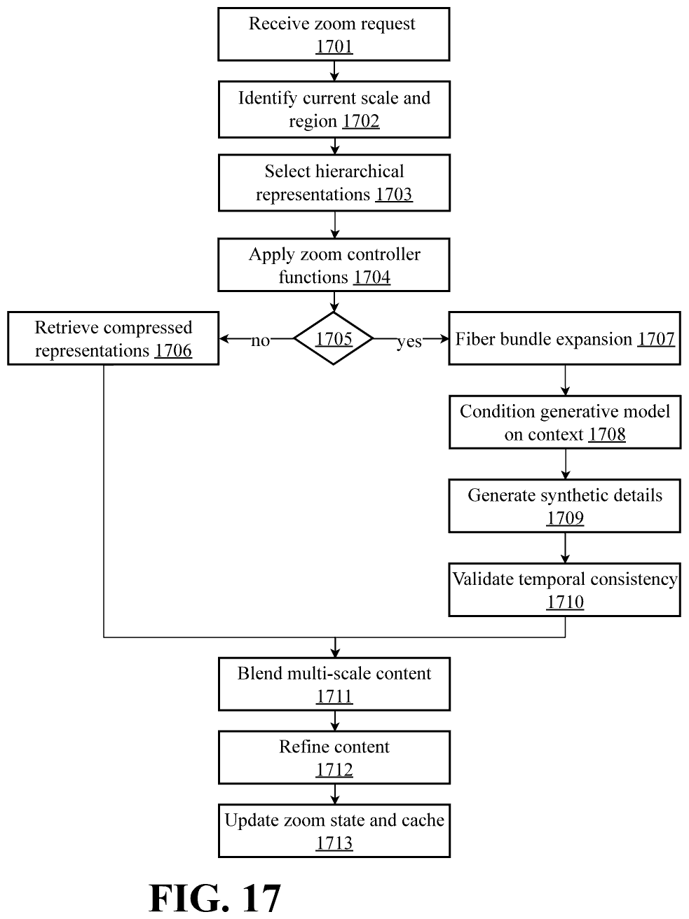

FIG. 17 is a flow diagram illustrating an exemplary method for multi-scale zoom with synthetic detail generation in compressed video, according to an embodiment. The method begins at step when the system initiates an advanced zoom operation that enables continuous exploration of video content across multiple scales, including the capability to generate plausible visual details beyond the original capture resolution. This method represents a significant advancement over traditional digital zoom techniques, which merely interpolate existing pixels, by leveraging hierarchical representations, geometric manifold structures, and generative models to synthesize coherent details that maintain semantic and temporal consistency.

According to the embodiment, the process begins at step 1701 when the system receives, retrieves, or otherwise obtains a zoom request specifying the desired exploration parameters. The zoom request may comprise target region coordinates (x, y, t, etc.) that identify the spatial location and temporal position within the video where zoom is desired, along with a scale factor σ that indicates the desired zoom level. The scale factor σ can be configured to range from 0 to 1, although other ranges or scales may be implemented, where values approaching 0 represent extreme close-up views requiring fine detail, and values approaching 1 represent wide-angle views showing global structure. The system may receive zoom requests through various interfaces including direct user interaction with gesture controls or mouse input, programmatic API calls for automated exploration, or as part of a larger navigation sequence guided by the PCM interface. The zoom request may also include additional parameters such as zoom speed for animated transitions or quality preferences that balance detail generation against computational requirements.

In step 1702, the system identifies the current scale and region from which the zoom operation will proceed. This involves determining the current viewing scale σ_{current} to establish the starting point for the zoom transition and mapping the target region coordinates to the corresponding location within the Lorentzian manifold. The mapping process considers both the spatial coordinates within the video frame and the temporal position along the geodesic trajectory representing the video's evolution. The system also identifies which hierarchical representations are currently active and what cached content may be available from previous zoom operations in nearby regions. This contextual information enables smooth transitions and efficient reuse of previously generated content.

Step 1703 involves selecting the appropriate hierarchical representations based on the target scale factor. The selection follows a scale-dependent strategy where different levels of the hierarchical compression are activated based on the zoom requirements. For example, for fine-scale zoom where σ<0.33, the system primarily uses H_{micro} representations that preserve pixel-level details and high-frequency information. For medium-scale zoom where 0.33≤σ<0.67, Hₘₑₛₒ representations containing texture and edge information become dominant. For coarse-scale zoom where σ≥0.67, H_{macro} representations capturing global scene structure are utilized. The boundaries between these ranges are not rigid but rather involve smooth transitions with overlapping contributions from multiple levels to ensure continuity during zoom operations. These boundary values are merely exemplary and do not limit the possible boundary values to those described herein.

In step 1704, the system applies zoom controller functions that manage the complex process of scale-based content selection and blending. The projection function π: (z, σ)→hierarchical level maps from the current position z in the latent space and scale factor σ to determine which hierarchical level should be active. The detail control function δ: (h, σ)→detail amount regulates how much detail from each hierarchical level h should be included based on the scale σ. These functions work together to compute blending coefficients α that determine how different scales are combined, ensuring smooth transitions between levels without visible boundaries or artifacts. The zoom controller also considers the local manifold geometry to adapt the blending strategy based on content complexity and compression characteristics.

At decision step 1705, the system determines whether the requested zoom level extends beyond the original capture resolution of the video. This critical decision point separates standard zoom operations that can be satisfied using existing compressed data from advanced zoom operations that require synthetic detail generation. The determination is made by comparing the effective resolution at the target scale with the maximum resolution preserved in the compressed representations. If the zoom remains within the original resolution bounds, the method proceeds along the left branch to retrieve existing compressed data. If the zoom extends beyond original resolution, requiring details that were not present in the source video, the method follows the right branch to engage synthetic generation capabilities.

Following the left branch when zoom is within original resolution, step 1706 retrieves the relevant compressed representations from the hierarchical storage. This involves accessing the mini-Lorentzian tensors at the appropriate scale levels and loading any cached intermediate representations from previous operations. The retrieval process is optimized to load only the necessary data for the target region, minimizing memory usage and computational overhead. The retrieved representations maintain their geometric structure and temporal relationships, enabling coherent reconstruction through the standard decoding pipeline.

Following the right branch when zoom exceeds original resolution, step 1707 performs fiber bundle expansion to extend the manifold locally in the region where new details must be generated. This geometric operation creates a detailed subspace attached to the base manifold, analogous to how mathematical fiber bundles attach additional structure to each point of a base space. The expansion maintains continuity with the surrounding manifold structure while providing the additional degrees of freedom needed to represent synthesized fine details. The fiber bundle structure ensures that generated details remain geometrically consistent with the larger-scale content and preserve the manifold's topological properties.

In step 1708, the system conditions the generative model using the rich context available from the manifold structure and surrounding content. The conditioning process incorporates multiple sources of information including, but not limited to, the local manifold geometry that indicates content characteristics and compression patterns, neighboring visual content that provides style and semantic context, nearby symbolic anchors that offer semantic guidance about what types of details are appropriate, and temporal context from adjacent frames that ensures consistency across time. This comprehensive conditioning enables the generative model to produce details that are not merely plausible in isolation but coherent within the specific context of the video.

Step 1709 involves the actual generation of synthetic details using the conditioned generative model. The generation process is guided by the PCM interface, which provides semantic understanding to ensure generated details are meaningful and appropriate. A generative model may employ various architectures such as diffusion models that progressively refine details from noise, generative adversarial networks that learn to produce realistic details through adversarial training, or transformer-based models that leverage attention mechanisms for context-aware generation. The generation process operates in the latent space, producing compressed representations of the synthetic details that integrate naturally with the existing hierarchical structure.

In step 1710, the system validates the temporal consistency of any generated synthetic details to ensure they maintain coherence across frames. This validation checks that generated details in the current frame align properly with corresponding regions in adjacent frames, motion patterns are preserved and extended naturally into the synthesized regions, and no flickering or sudden changes occur that would break the illusion of continuous detail. If temporal inconsistencies are detected, the system may apply temporal smoothing operations or regenerate details with stronger temporal conditioning to achieve acceptable consistency.

Step 1711 performs the critical operation of blending multi-scale content from various sources into a unified output. The blending process applies the previously computed coefficients α to combine contributions from different hierarchical levels, seamlessly integrate any synthetically generated details with original compressed content, and ensure smooth transitions across scale boundaries without visible artifacts. The blending operation works in the compressed domain where possible, leveraging the geometric structure of the latent space to achieve natural combinations that would be difficult to accomplish in pixel space.

In step 1712, the system applies content refinement to ensure visual coherence in the final output. This refinement process addresses potential artifacts at the boundaries between different scale regions or between original and synthetic content. The refinement may involve edge smoothing to eliminate visible seams, color harmonization to ensure consistent appearance across regions, and detail enhancement to sharpen features that may have been softened during blending. The content refiner operates with awareness of both the local image properties and the global video context to maintain overall coherence.

Step 1713 updates the zoom state and caches relevant information for future operations. The system stores the current scale and position parameters to enable smooth continuation of zoom operations, caches any generated synthetic details for reuse if the same region is visited again, and updates the manifold structure to reflect the paths taken during zoom navigation. This caching strategy significantly improves performance for interactive zoom operations where users may repeatedly explore the same regions or zoom in and out dynamically. The cache management considers available memory and uses importance metrics based on recency and frequency of access to determine what content to retain.

In step 1714, the system outputs the zoomed video frame or sequence resulting from the multi-scale blending and generation process. The output delivers content that seamlessly combines multiple scales of detail, integrates any synthetic enhancements naturally with original content, and supports continuous exploration without resolution barriers. The output format may be optimized for the specific display context, with appropriate tone mapping, color space conversion, or additional post-processing to ensure optimal visual quality on the target display device.

The method concludes at step 1715, having successfully completed a multi-scale zoom operation that potentially extends beyond the original video resolution. The key innovations of this method include the hierarchical representation selection that adapts to zoom scale, the fiber bundle expansion that enables geometric extension of the manifold for detail generation, the use of comprehensive contextual conditioning for synthetic detail generation, the sophisticated blending operations that seamlessly integrate content across scales, and the temporal validation that ensures consistency in video applications. This method transforms zoom from a simple magnification operation into an intelligent exploration capability that can reveal details that enhance understanding while maintaining visual and semantic coherence, enabling new applications in video analysis, surveillance, scientific imaging, and immersive media experiences.

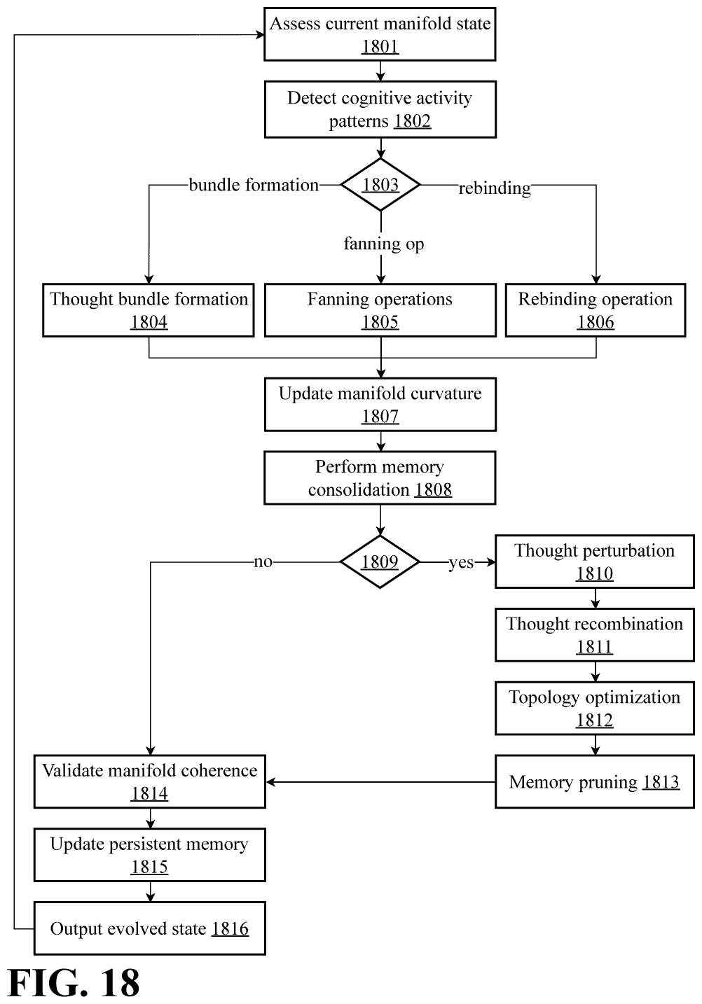

FIG. 18 is a flow diagram illustrating an exemplary method for manifold evolution through cognitive operations, according to an embodiment. The method starts when the system (e.g., system 1400) initiates a process of adaptive geometric evolution that allows the cognitive manifold to develop and optimize its structure based on usage patterns, learned associations, and autonomous reorganization. This evolutionary capability transforms the manifold from a static geometric space into a living cognitive substrate that improves its representational efficiency and navigational properties through experience, fundamentally distinguishing it from traditional static embedding spaces or fixed neural network architectures.

According to the embodiment, the process begins at step 1801 when the system assesses the current state of the manifold by measuring its geometric and topological properties. This assessment involves computing the distribution of curvature across different regions using the Ricci tensor and scalar curvature measures, identifying the current configuration of thought bundles including their positions, sizes, and internal structure, mapping the connectivity patterns between different manifold regions, and evaluating the overall health metrics such as navigability, compression efficiency, and semantic coherence. The manifold state assessment provides a comprehensive baseline from which evolution decisions can be made, ensuring that modifications improve rather than degrade the cognitive capabilities of the system.

In step 1802, the system detects cognitive activity patterns that may trigger evolutionary changes in the manifold structure. The detection process monitors various indicators of cognitive usage including navigation paths taken during recent reasoning operations, regions of high attention focus where cognitive resources concentrate, frequency patterns showing which thought bundles are accessed repeatedly, and exploration behaviors indicating attempts to connect previously unrelated concepts. These activity patterns are analyzed to identify areas where the manifold structure could be optimized to better support the observed cognitive operations. The system maintains activity heat maps and trajectory statistics that reveal both immediate usage patterns and longer-term trends in cognitive behavior.

At decision step 1803, the system determines whether any evolution triggers have been detected that warrant modification of the manifold structure. Evolution triggers fall into several categories; each associated with specific types of structural modifications. The system evaluates whether sufficient evidence exists for thought bundle formation when related concepts cluster together repeatedly, fanning operations when existing pathways need strengthening or new territories require exploration, rebinding operations when separate bundles show sufficient overlap to warrant merging, or general reorganization when the overall manifold structure becomes inefficient. If no significant triggers are detected, the system may proceed directly to validation steps, maintaining the current structure while continuing to monitor for future evolution opportunities.

Following the left branch when bundle formation is triggered, step 1804 executes thought bundle formation operations that create new submanifolds to encapsulate related concepts. The formation process involves identifying conceptual clusters through analysis of navigation patterns and semantic relationships, defining bundle boundaries that encompass the related concepts while maintaining clear interfaces with surrounding regions, establishing internal geometry for the bundle including local metric structure and curvature properties, and creating connection pathways that link the new bundle to relevant existing structures. The newly formed thought bundle becomes a coherent unit within the manifold that can be navigated as a whole while maintaining its internal structure for detailed exploration when needed.

Following the middle branch for fanning operations, step 1805 performs either fanning-in or fanning-out operations based on the detected usage patterns. Fanning-in operations strengthen frequently used pathways by decreasing the metric distance along well-traveled routes, increasing the curvature to create attractive basins around important concepts, and reinforcing connections between related thought bundles. This process makes future navigation along these paths more efficient, implementing a form of cognitive habituation. Fanning-out operations explore new conceptual territories by creating tentative connections to unexplored manifold regions, reducing local curvature to encourage exploration, and establishing provisional pathways that may be reinforced or pruned based on subsequent usage. The balance between fanning-in and fanning-out maintains the manifold's ability to both efficiently navigate known territory and discover new conceptual relationships.

Following the right branch for rebinding needs, step 1806 executes rebinding operations that restructure existing thought bundles to create higher-order organizations. The rebinding process identifies bundles with significant conceptual overlap through semantic analysis and shared navigation patterns, computes optimal merge strategies that preserve essential structure while eliminating redundancy, creates meta-bundles that abstract common patterns across the merged components, and updates the hierarchical organization to reflect the new conceptual relationships. Rebinding operations enable the manifold to develop increasingly sophisticated representational structures that capture abstract patterns and relationships discovered through use.

In step 1807, the system updates the manifold curvature to reflect the structural changes from the preceding operations. The curvature update involves computing the new Ricci tensor R_{μν} based on the modified metric structure, adjusting the metric tensor g_{μν} to incorporate usage-based adaptations, smoothing local discontinuities that may have arisen from structural modifications, and ensuring that the updated curvature maintains appropriate causal structure in regions representing temporal sequences. The curvature updates create a landscape that naturally guides future cognitive operations toward efficient paths while maintaining the flexibility to explore new directions when needed.

Step 1808 performs memory consolidation operations that strengthen important structures while allowing unused elements to decay. The consolidation process applies reinforcement to frequently accessed thought bundles and pathways, increasing their stability and resistance to future modifications. Simultaneously, it implements a thermodynamic decay mechanism where unused structures gradually lose activation energy according to Eᵢ(t+Δt)=Eᵢ(t)×exp(−λAᵢ(t)Δt), where λ is the decay constant and Aᵢ represents the inactivity measure. This dual process ensures that the manifold maintains relevant structures while preventing unlimited growth that would degrade performance. The consolidation also performs defragmentation operations that reorganize sparse regions and tighten the overall manifold structure.

At decision step 1809, the system determines whether to enter a dream state for autonomous manifold reorganization. The decision considers factors such as the availability of idle processing time when active cognitive operations are minimal, the accumulation of structural inefficiencies that could benefit from global optimization, the need for exploratory recombination to discover new conceptual relationships, and the presence of unresolved tensions or inconsistencies in the current structure. The dream state provides an opportunity for more radical reorganization operations that would be disruptive during active use but can significantly improve long-term performance.

If the dream state is entered, step 1810 performs thought perturbation operations that introduce controlled randomness into the manifold structure. These perturbations involve applying small random displacements to thought bundle positions, introducing noise into connection strengths to test stability, and exploring alternative geometric configurations through Monte Carlo sampling. The perturbations help identify stable attractors in the cognitive landscape while potentially discovering new organizational patterns that improve efficiency or capability.

Step 1811 in the dream sequence executes thought recombination operations that explore novel connections between existing structures. The recombination process selects pairs or groups of thought bundles based on structural similarity or complementary properties, generates tentative bridge structures that connect previously unrelated concepts, evaluates the semantic coherence and geometric feasibility of new combinations, and retains promising recombinations while discarding those that violate consistency constraints. This exploratory process can discover surprising conceptual relationships that enhance the manifold's representational power.

Step 1812 performs topology optimization within the dream state, making more fundamental changes to the manifold's connective structure. This optimization may involve rewiring connections to reduce average path lengths between related concepts, eliminating redundant pathways that no longer serve useful purposes, introducing new topological features such as handles or bridges that enable more efficient navigation, and rebalancing the hierarchical organization to better reflect discovered conceptual relationships. The topology optimization operates under relaxed constraints compared to wake-state modifications, allowing for more creative restructuring.

Step 1813 completes the dream sequence with memory pruning operations that remove obsolete or redundant structures. The pruning process identifies candidates for removal based on prolonged inactivity, functional redundancy with other structures, or inconsistency with the evolved manifold organization. Pruning is performed carefully to avoid losing potentially valuable but currently dormant knowledge, with structures marked for gradual decay rather than immediate deletion. This process prevents the manifold from accumulating excessive complexity that would impair navigation and reasoning efficiency.

In step 1814, whether coming from dream operations or direct evolution, the system validates the coherence of the evolved manifold structure. The validation checks geometric consistency by ensuring the metric tensor remains positive definite and the curvature bounds stay within acceptable ranges, navigational integrity by verifying that important paths remain accessible and causal constraints are preserved, semantic coherence by confirming that conceptual relationships remain meaningful, and performance metrics by measuring improvements in compression efficiency and navigation speed. Any detected inconsistencies trigger local repair operations to restore coherence without reverting the beneficial evolutionary changes.

Step 1815 updates the persistent memory manager with the evolved manifold structures, ensuring that improvements are preserved for future use. The update process stores the modified geometric structures including updated metric tensors and curvature information, records the evolution history including what changes were made and why, caches successful navigation strategies that work well with the new structure, and indexes the changes to enable efficient rollback if problems emerge. The persistent storage ensures that evolutionary improvements accumulate over time rather than being lost between sessions.

In step 1816, the system outputs the evolved manifold state, making the improved cognitive substrate available for future operations. The output includes the updated geometric structures with enhanced navigation properties, strengthened cognitive pathways that reflect learned patterns, new conceptual bridges discovered through recombination, and optimized topology that supports more efficient reasoning. A continuous evolution feedback loop connects the output back to the initial assessment step, enabling ongoing adaptation as new usage patterns emerge and additional learning occurs.

The method concludes at step 1817, having successfully evolved the manifold structure to better support cognitive operations. The key innovations of this evolutionary method include the usage-based adaptation that shapes geometry through experience, the multiple evolution mechanisms that address different types of structural improvements, the dream-state reorganization that enables exploratory optimization, the thermodynamic memory consolidation that balances retention with efficiency, and the continuous feedback loop that enables lifelong learning. This evolutionary approach transforms the cognitive manifold from a static repository into a dynamic, self-improving substrate for intelligence, enabling systems that become more capable through use rather than degrading over time.

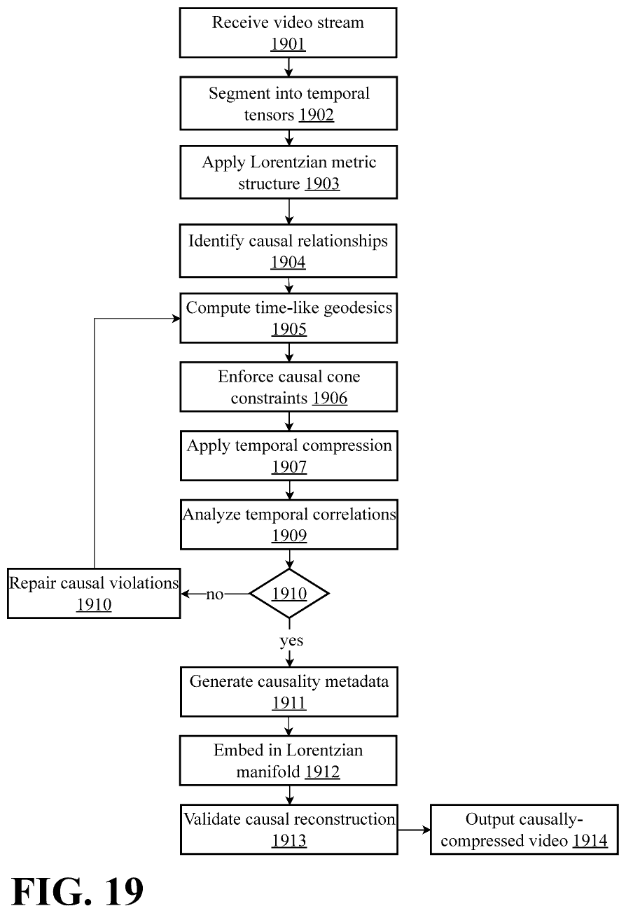

FIG. 19 is a flow diagram illustrating an exemplary method for temporal causality preservation during video compression, according to an embodiment. The method begins when the system (e.g., system 1400) initiates a compression process specifically designed to maintain the causal relationships inherent in video data, ensuring that temporal dependencies are preserved throughout the compression and subsequent decompression operations. This method addresses a fundamental limitation of traditional video compression techniques that treat frames independently or with limited temporal context, potentially introducing artifacts where effects appear before their causes or where temporal coherence is disrupted.

According to the embodiment, the process begins at step 1901 when the system receives, retrieves, or otherwise obtains a video stream consisting of a temporal sequence of frames that must be processed while maintaining strict temporal ordering. The video stream arrives as a continuous or discrete sequence where each frame has a definite position in time, and the relationships between frames encode important information about motion, scene evolution, and causal dependencies. The system maintains careful bookkeeping of frame timestamps and ordering to ensure that no temporal information is lost during initial processing. The reception process may involve buffering to accumulate sufficient temporal context for subsequent operations while maintaining real-time processing capabilities for streaming applications.

In step 1902, the system segments the video stream into temporal tensors that serve as the fundamental units for causality-preserving compression. Each temporal tensor is structured as a three-dimensional array with dimensions H×W×T, where H and W represent the spatial height and width dimensions, and T represents the temporal extent. The segmentation process carefully preserves temporal continuity at segment boundaries by implementing overlapping windows or by encoding boundary conditions that maintain causal connections across segments. The temporal extent T is chosen to balance computational efficiency with the need to capture sufficient temporal context for meaningful causal relationships. The segmentation strategy may adapt based on content characteristics, using shorter segments for rapidly changing scenes and longer segments for stable content.

Step 1903 applies a Lorentzian metric structure to the temporal tensors, fundamentally distinguishing this compression method from traditional approaches. The Lorentzian metric g_{μν} introduces an asymmetry between time and space dimensions, with the negative signature in the temporal dimension encoding the directional nature of time. This metric structure defines light cones at each point in the video tensor, establishing which regions can causally influence each other. The light cone structure creates a natural partition of the tensor space into causally connected regions and causally disconnected regions, providing a principled framework for compression that respects temporal dependencies. The implementation of the Lorentzian metric involves modifying distance calculations, gradient computations, and optimization procedures to account for the hyperbolic geometry induced by the metric.

In step 1904, the system identifies causal relationships within the video content by analyzing motion patterns, scene changes, and object interactions. This analysis detects motion vectors that indicate how objects move through the scene over time, identifying source and destination regions that must maintain causal connections. Scene changes are analyzed to distinguish between cuts that break causal chains and continuous transitions that preserve them. The system maps cause-effect dependencies such as objects casting shadows, collisions triggering responses, or actions leading to reactions. These causal relationships form a directed graph structure overlaid on the temporal tensor, with edges representing causal influences that must be preserved during compression.

Step 1905 computes time-like geodesics through the tensor space that represent the natural evolution paths of video content. The constraint ds²<0 ensures that only time-like paths are considered, corresponding to physically realizable evolution trajectories that respect causality. These geodesics map how different regions of the video evolve over time, creating natural compression pathways that follow the flow of visual information. The geodesic structure provides a coordinate-independent representation of temporal evolution that remains valid even under various transformations applied during compression.

In step 1906, the system enforces causal cone constraints that prevent the creation or preservation of acausal connections during compression. Each point in the temporal tensor has an associated future light cone containing all points that it can causally influence and a past light cone containing all points that can influence it. The compression algorithm is constrained to only create dependencies within these light cones, preventing information from flowing backward in time or between causally disconnected regions. This enforcement involves modifying convolution kernels to respect light cone boundaries, constraining optimization procedures to maintain causal structure, and designing pooling operations that preserve temporal ordering. The strict enforcement of causal cones ensures that the compressed representation cannot encode physically impossible temporal relationships.

Step 1907 applies temporal compression operations that respect the established causal structure. The compression employs three-dimensional convolution operations designed to operate within light cone constraints, ensuring that each compressed value only depends on causally connected input values. The encoding follows geodesic trajectories identified earlier, naturally capturing the flow of information through time while achieving efficient compression. The compression parameters adapt based on local causal density, allocating more resources to regions with complex causal relationships while efficiently encoding causally sparse areas. This causality-aware compression achieves better perceptual quality than traditional methods by preserving the temporal relationships that are most important for understanding video content.

In step 1908, the system analyzes temporal correlations within the constraints imposed by the causal structure. Forward prediction operates within future light cones, using information from the present to predict future frames only where causal connections exist. Backward dependencies are traced through past light cones, identifying which historical information must be preserved to reconstruct current frames. This bidirectional analysis operates entirely within the causal constraints, never creating correlations between causally disconnected regions. The correlation analysis informs adaptive compression strategies that allocate bits based on causal importance rather than just statistical frequency.

At decision step 1909, the system performs a comprehensive validation to verify that all causal constraints have been satisfied throughout the compression process. This validation checks that no information pathways exist outside light cones, all temporal dependencies follow proper time ordering, geodesic structures remain time-like, and no compression artifacts introduce acausal effects. The validation employs both local checks at individual tensor points and global verification of the entire causal graph structure. If any violations are detected, the method branches to a repair process.

When causal violations are detected, step 1910 implements repair operations to restore proper causal structure. The repair process identifies the specific constraints that were violated and traces their origin in the compression pipeline. Corrective measures may include adjusting convolution weights to eliminate acausal dependencies, modifying compressed values to restore proper temporal ordering, or restructuring geodesic paths to maintain time-like properties. The repair operations are designed to minimally impact compression efficiency while fully restoring causal consistency. After repair, the method returns to the geodesic computation step to reverify the causal structure.

Following successful validation, step 1911 generates comprehensive causality metadata that accompanies the compressed representation. This metadata includes the causal graph structure showing dependencies between different regions, markers for important causal events such as collisions or state changes, temporal dependency maps indicating the strength and direction of causal influences, and light cone boundary definitions for efficient decompression. The metadata is structured to enable efficient navigation and reconstruction while maintaining a compact representation. This causal information proves invaluable during decompression and for applications requiring temporal reasoning about the video content.

In step 1912, the system embeds the compressed representation within a Lorentzian manifold that provides the geometric framework for storage and subsequent processing. The embedding positions compressed tensors along time-like geodesics, maintaining their causal relationships within the manifold structure. The manifold organization enables efficient access patterns that follow causal flow, natural interpolation along time-like paths for frame rate conversion, and coherent navigation that respects temporal structure. The embedding process ensures that the geometric properties of the Lorentzian metric are preserved, enabling causality-aware operations on the compressed data.

Step 1913 validates that causal structure will be preserved during reconstruction by testing the decompression process. This validation verifies that the decoder respects light cone constraints when reconstructing frames, temporal ordering is maintained throughout decompression, causal dependencies are correctly resolved, and no artifacts introduce acausal effects. The validation may involve test decompressions of representative segments to ensure end-to-end causality preservation. Any issues identified during reconstruction validation trigger adjustments to the compression parameters or metadata to ensure proper decompression.

In step 1914, the system outputs the causally-compressed video consisting of the compressed representations that encode video content efficiently while maintaining causal structure, comprehensive causal metadata that enables intelligent decompression and navigation, and guarantees of temporal consistency throughout the compression-decompression pipeline. The output format is designed to support both traditional playback applications and advanced systems that can leverage the causal structure for enhanced functionality such as temporal reasoning, physics-aware editing, or causal inference from video content.

The method concludes upon having successfully compressed video data while preserving the fundamental causal relationships that give meaning to temporal sequences. This causality-preserving compression method enables new applications in physics simulation, temporal analysis, and any domain where the causal structure of video data carries essential information that must not be lost during compression.

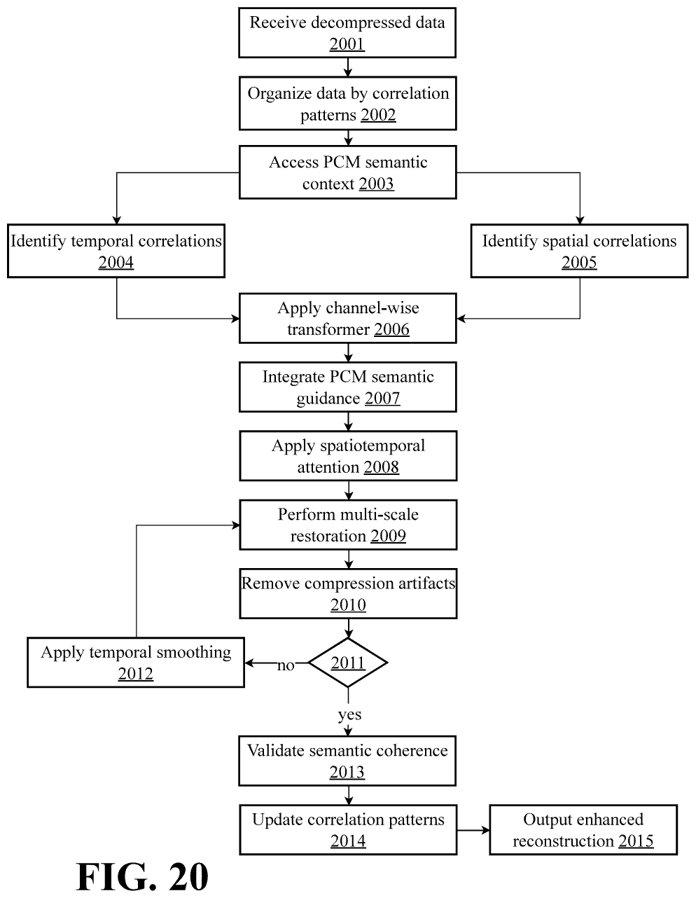

FIG. 20 is a flow diagram illustrating an exemplary method for correlation network enhancement with persistent cognitive machine PCM guidance, according to an embodiment. The method begins when the system (e.g., system 1400) initiates an enhanced restoration process that leverages both statistical correlations in the compressed data and semantic understanding from the PCM interface to achieve superior reconstruction quality. This method represents a significant advancement over traditional correlation-based restoration techniques by incorporating cognitive guidance that ensures recovered details are not only statistically plausible but also semantically appropriate within the context of the video content.

According to the embodiment, the process begins at step 2001 when the system receives, retrieves, or otherwise obtains decompressed data consisting of multi-channel outputs from the initial decompression stage of the compression pipeline. These decompressed outputs represent the preliminary reconstruction from the compressed representations, which may contain artifacts, missing details, or degraded quality due to the lossy compression process. The multi-channel nature of the data may include different color channels for video, multiple sensor modalities for specialized imaging, or hierarchical representations at different scales from the compression system. The received data maintains its tensor structure, preserving spatial and temporal relationships that will be exploited by the correlation network to enhance reconstruction quality.

In step 2002, the system organizes the decompressed data by identifying and grouping correlation patterns among different data elements. This organization process analyzes statistical dependencies between different channels, spatial regions, and temporal segments to identify which data elements exhibit strong correlations that can be exploited for mutual enhancement. The system constructs a correlation matrix that quantifies the strength of relationships between different data components, enabling efficient processing of related elements together. The grouping strategy may employ clustering algorithms that identify natural groupings in the data, similarity metrics that measure correlation strength, or domain-specific knowledge about expected relationships in the data type being processed. This organization primes the correlation network to process related data elements together, maximizing the potential for recovering missing information through correlation analysis.

Step 2003 accesses the PCM semantic context to obtain high-level understanding about the content being restored. The system queries relevant thought bundles within the PCM's cognitive manifold to identify conceptual structures related to the video content, retrieving semantic anchors that provide meaningful labels and relationships for different regions or objects in the video. This semantic context includes information about expected object appearances, typical motion patterns, contextual relationships between different elements, and domain-specific knowledge relevant to the video content. The PCM interface provides a bridge between low-level pixel correlations and high-level semantic understanding, enabling restoration decisions that respect both statistical patterns and meaningful content structure.

Following step 2003, the method enters a parallel processing phase where temporal and spatial correlations are analyzed simultaneously to capture different aspects of the data relationships. This parallel architecture ensures that both dimensions of correlation are fully exploited without biasing the analysis toward either temporal or spatial patterns.

In the left branch, step 2004 identifies temporal correlations by analyzing dependencies across time in the video sequence. The temporal correlation analysis detects frame-to-frame dependencies that indicate how pixels or regions evolve over time, identifies motion patterns that reveal object trajectories and scene dynamics, and tracks object persistence to understand which elements remain stable versus those that change. The analysis employs techniques such as optical flow estimation to track pixel movements, temporal filtering to identify stable versus dynamic regions, and motion compensation to align temporal sequences for correlation analysis. These temporal correlations provide crucial information for recovering details that may be degraded in individual frames but can be inferred from temporal context.

In the right branch, step 2005 identifies spatial correlations by analyzing relationships within individual frames or spatial regions. The spatial correlation analysis detects regional patterns such as textures, edges, and structural regularities that can inform restoration, analyzes texture coherence to identify areas that should exhibit similar characteristics, and finds structural similarities that indicate repeated patterns or symmetric relationships. The spatial analysis may employ techniques including spatial frequency analysis to identify texture characteristics, edge detection and linking to find structural boundaries, and pattern matching to identify repeated elements. These spatial correlations enable the recovery of fine details by exploiting redundancy and regularity within the spatial domain.

The parallel branches converge at step 2006, where the system applies a channel-wise transformer to process the multi-channel data with attention mechanisms that adaptively weight different channels based on their relevance and correlation strength. The transformer implements multi-head attention that allows different attention heads to focus on different types of correlations, enabling the model to simultaneously capture various relationship patterns. The attention mechanism weights channels based on their correlation strength, giving more importance to channels that provide reliable information for restoration while downweighting noisy or less informative channels. The transformer preserves important dependencies identified in the correlation analysis, ensuring that restoration leverages the most relevant relationships in the data. This adaptive processing allows the correlation network to dynamically adjust its restoration strategy based on the specific correlation patterns present in each data instance.

In step 2007, the system integrates PCM semantic guidance into the restoration process, using high-level understanding to inform low-level reconstruction decisions. The integration applies semantic constraints from thought bundles that encode knowledge about plausible object appearances and behaviors, prioritizes semantically relevant correlations over statistically weak but semantically important relationships, and adjusts restoration parameters based on contextual understanding of what is being reconstructed. For example, when restoring a partially occluded face, the PCM guidance ensures that facial features are reconstructed according to anatomical constraints rather than just statistical averaging. This semantic integration bridges the gap between pure statistical restoration and intelligent reconstruction that respects meaningful content structure.

Step 2008 applies spatiotemporal attention mechanisms that focus restoration efforts on critical regions in both space and time. The attention mechanism generates PCM-weighted attention maps that highlight regions of semantic importance, concentrates computational resources on areas where restoration will have the most impact, and coordinates spatial and temporal attention to ensure coherent restoration across dimensions. The spatiotemporal attention may be guided by factors including semantic importance from PCM annotations, motion saliency indicating dynamic regions requiring careful restoration, and perceptual importance based on human visual system characteristics. This focused attention ensures efficient and effective restoration by prioritizing the most important aspects of the data.

In step 2009, the system performs multi-scale restoration that leverages the hierarchical nature of the compressed representations. The restoration proceeds progressively through the hierarchical scales, beginning with coarse-scale restoration at the H_{macro} level to establish global structure, proceeding through Hₘₑₛₒ restoration to recover textures and intermediate features, and concluding with H_{micro} restoration for fine details. Each scale's restoration is guided by correlations identified at that scale while also leveraging cross-scale dependencies where coarse scales inform fine-scale restoration. The multi-scale approach ensures that restoration maintains consistency across scales while maximizing detail recovery at each level. The progressive refinement allows early stages to establish a coherent foundation upon which later stages add increasing detail.

Step 2010 removes compression artifacts using PCM-aware smoothing techniques that distinguish between legitimate details and compression-induced distortions. The artifact removal process identifies specific types of artifacts including blocking artifacts at compression boundaries, ringing artifacts around edges, and color banding in smooth gradients. The system applies smoothing operations that are modulated by PCM understanding, aggressively smoothing regions identified as uniform surfaces while preserving details in semantically important areas. The PCM awareness prevents over-smoothing of important features while effectively removing visually disturbing artifacts, resulting in perceptually superior restoration compared to blind deblocking approaches.

At decision step 2011, the system validates temporal consistency to ensure that the restored video maintains coherent motion and appearance across frames. The validation checks for temporal flickering that would indicate frame-to-frame inconsistencies, verifies that motion patterns remain smooth and physically plausible, and ensures that object appearances remain stable except for legitimate changes. If temporal inconsistencies are detected, the method branches to step 2012 where temporal smoothing is applied to restore coherence. The temporal smoothing uses motion-compensated filtering to align and blend information across frames while respecting the correlation patterns and PCM guidance to maintain semantic validity. After smoothing, the process returns to the multi-scale restoration step for refinement.

Following successful temporal validation, step 2013 performs semantic coherence validation by checking the restored content against PCM knowledge structures. This validation ensures that restored details are contextually appropriate for the identified content type, that relationships between different elements remain semantically valid, and that no impossible or highly improbable features have been introduced during restoration. The semantic validation leverages the PCM's understanding of object categories, typical appearances, and contextual constraints to identify restorations that may be statistically valid but semantically incorrect. Any semantic inconsistencies trigger targeted adjustments to align the restoration with expected content characteristics.

In step 2014, the system updates correlation patterns based on the successful restoration, implementing a learning mechanism that improves future restoration performance. The update process analyzes which correlations proved most useful for restoration in the current instance, adjusts correlation weights to emphasize effective patterns, and stores successful restoration strategies for similar content types. This learning mechanism allows the correlation network to adapt to specific content domains and improve over time as it processes more examples. The updated patterns are integrated back into the correlation analysis components, creating a feedback loop that continuously enhances restoration capabilities.

Step 2015 outputs the enhanced reconstruction that combines the benefits of correlation-based restoration with PCM semantic guidance. The output consists of restored data with significantly improved quality compared to the initial decompression, recovered details that are both statistically justified and semantically appropriate, and maintained structural and temporal coherence throughout the sequence. The enhancement preserves the original content's essential characteristics while recovering information lost during compression, achieving a balance between fidelity to the original and perceptual quality improvement.

The method concludes upon having successfully enhanced the decompressed data through intelligent correlation analysis guided by semantic understanding. This enhanced correlation network demonstrates how cognitive understanding can guide and improve traditional signal processing techniques, resulting in restoration quality that surpasses what either approach could achieve independently.

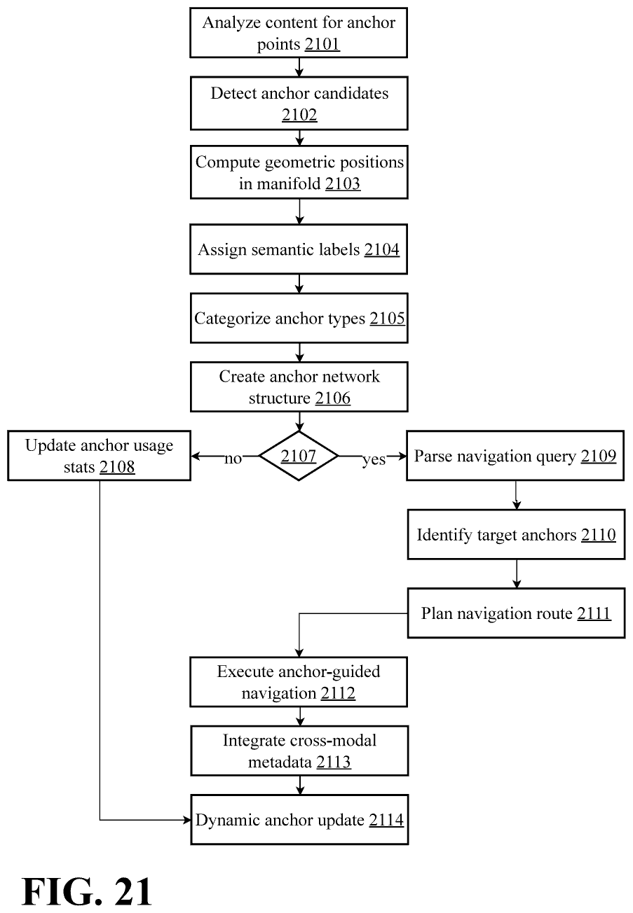

FIG. 21 is a flow diagram illustrating an exemplary method for symbolic anchor management and semantic navigation in compressed video, according to an embodiment. The method begins when the system (e.g., system 1400) initiates a process for creating, managing, and utilizing symbolic anchors that serve as semantic waypoints within the compressed video representation. These symbolic anchors transform video navigation from a purely temporal operation into a semantically meaningful exploration where users can navigate based on concepts, events, and relationships rather than just time indices. This method enables intelligent video access patterns that align with human cognitive models of how video content is understood and remembered.

According to the embodiment, the process begins at step 2101 when the system analyzes the compressed video content to identify potential anchor points that represent semantically significant locations within the video. This analysis operates on the compressed representations within the Lorentzian manifold, scanning for patterns that indicate meaningful content boundaries, events, or transitions. The system examines both the geometric structure of the compressed data, looking for regions of high curvature or compression pressure that often correspond to significant content, and the temporal evolution patterns that reveal important moments in the video narrative. The analysis leverages the hierarchical representations to identify significance at multiple scales, from scene-level transitions to fine-grained object appearances. This comprehensive scan ensures that no semantically important moments are overlooked when establishing the anchor framework.

In step 2102, the system detects specific anchor candidates based on multiple criteria that indicate semantic significance. The detection process identifies scene transitions where the visual content undergoes substantial change, marking boundaries between different narrative segments or locations. Key frames that represent visually distinctive or narratively important moments are selected as anchor candidates, such as frames showing establishing shots, climactic moments, or significant reveals. The system detects object appearances and disappearances, marking when important entities enter or leave the scene, which often corresponds to meaningful narrative developments. Significant motion events such as collisions, sudden movements, or choreographed actions are identified as potential anchors due to their typical importance in video content. The detection employs both low-level visual analysis and higher-level pattern recognition to ensure comprehensive identification of anchor-worthy moments.

Step 2103 computes the geometric positions of the identified anchor candidates within the Lorentzian manifold. Each anchor must be mapped to specific coordinates in the compressed representation space, establishing its location along the geodesic trajectories that represent the video's temporal evolution. The positioning process calculates geodesic distances between anchors to ensure proper spacing that reflects their semantic relationships, with closely related content having anchors positioned near each other in the manifold. The system ensures that anchor positions respect the causal structure of the manifold, maintaining proper temporal ordering and preventing paradoxical arrangements. The geometric positioning also considers the local manifold curvature, placing anchors in regions that are easily accessible through navigation while avoiding areas of extreme compression that might make access difficult. This careful positioning creates a navigable network of semantic waypoints throughout the compressed video space.

In step 2104, the system assigns semantic labels to each anchor through a comprehensive analysis of the associated content. Object recognition algorithms identify and classify entities present at each anchor location, providing labels such as “person entering room,” “vehicle,” or “explosion.” Action and event identification analyzes the dynamic content to label anchors with descriptions of what is occurring, such as “conversation begins,” “chase sequence,” or “reveal moment.” The system maps contextual relationships between different elements in the scene, understanding not just what is present but how different entities relate to each other and to the broader narrative context. These semantic labels may be hierarchical, with broad categories refined into specific subcategories, enabling navigation at different levels of semantic granularity. The labeling process may also incorporate metadata from the video source, such as script annotations or production notes, when available.

Step 2105 categorizes each anchor into one of four primary types that support different navigation strategies. Decision points mark locations where the narrative branches or where user choices might affect the viewing experience, such as the beginning of alternative storylines or moments where different perspectives are available. Semantic boundaries indicate transitions between different conceptual segments, such as shifts from action to dialogue, changes in emotional tone, or movements between thematic sections. Navigation waypoints serve as general-purpose markers for exploration, identifying visually or narratively distinctive moments that users might want to revisit or use as reference points. Temporal references mark specific time-related events such as flashbacks, flash-forwards, or explicitly mentioned temporal markers within the content. This categorization enables the navigation system to apply appropriate strategies based on the anchor type and user intent.

In step 2106, the system creates a network structure that connects related anchors and establishes hierarchical relationships among them. The network construction links anchors that share semantic relationships, such as those involving the same characters, locations, or themes, creating pathways for conceptually guided navigation. Hierarchical relationships are established where broad conceptual anchors contain more specific sub-anchors, enabling multi-level navigation from general concepts to specific moments. The network structure may include both strong connections representing direct semantic relationships and weak connections indicating potential but less certain associations. This interconnected structure transforms the set of individual anchors into a navigable semantic graph that overlays the geometric structure of the compressed video manifold.

At decision step 2107, the system determines whether a navigation request has been received that requires use of the anchor system. If no navigation request is active, the method proceeds to step 2108 where anchor usage statistics are updated based on any passive interactions or system maintenance operations. These statistics track which anchors are frequently accessed, how they are used in navigation paths, and their effectiveness in supporting user goals. This information feeds back into the anchor management system for continuous improvement. If a navigation request is received, the method proceeds to the navigation planning sequence.

When navigation is requested, step 2109 parses the navigation query to extract semantic intent and identify what the user is seeking within the video content. The parsing process employs natural language understanding to interpret queries that may range from specific requests like “show me the car chase” to more abstract desires like “find emotionally intense moments.” The system extracts key concepts, relationships, and constraints from the query, mapping them to the semantic vocabulary used in the anchor labels. The parsing also identifies any temporal constraints, spatial specifications, or other modifiers that should influence the navigation strategy.

Step 2110 identifies target anchors that best match the parsed navigation query by comparing the extracted semantic intent with the labels and categories of available anchors. The matching process may employ various similarity metrics including direct label matching for explicit queries, semantic similarity measures for conceptually related content, and contextual matching that considers the relationships between anchors. Multiple anchors may be identified as potential targets, especially for broad or ambiguous queries, requiring the system to rank them based on relevance and confidence. The identification process also considers the anchor types, preferring certain categories based on the nature of the query.

In step 2111, the system plans an optimal navigation route through the anchor network from the current position to the identified target anchors. The route planning considers multiple factors including the semantic distance between anchors, preferring paths that maintain conceptual coherence, the geometric distance in the manifold, balancing semantic relevance with navigation efficiency, and any constraints specified in the query such as temporal ordering or content preferences. The planned route may include intermediate anchors that serve as stepping-stones, providing context or narrative continuity along the navigation path. For queries with multiple target anchors, the system plans an efficient tour that visits all relevant anchors while minimizing redundant traversal.

Step 2112 executes the planned anchor-guided navigation by traversing the computed route through the manifold. The execution involves moving along geodesic paths between anchor positions while progressively loading and reconstructing the associated video content. The navigation may proceed at different speeds based on user preference, with options for rapid jumps between distant anchors or smooth transitions that maintain visual continuity. As each anchor is reached, its associated content is highlighted and any relevant metadata is presented to provide context. The system may also prefetch content for upcoming anchors along the planned route, ensuring smooth playback despite the non-linear navigation pattern.

In step 2113, the system integrates cross-modal metadata associated with the anchors being visited during navigation. This integration links audio annotations such as dialogue transcripts or sound effect descriptions with the visual anchors, providing a richer understanding of the content. Text annotations from subtitles, closed captions, or production notes are synchronized with the anchor positions, offering additional context. The system may also connect anchors to external knowledge bases, retrieving relevant information about identified entities, locations, or events to enhance the viewing experience. This multi-modal integration transforms simple video navigation into a rich, information-enhanced exploration experience.

Step 2114 performs dynamic anchor updates based on accumulated usage patterns and navigation experiences. Anchor positions may be adjusted to better reflect their actual semantic importance as revealed through usage, with frequently accessed anchors potentially moved to more prominent positions in the network. Semantic associations are refined based on observed navigation patterns, strengthening connections between anchors that users frequently traverse together and weakening rarely used links. New anchors may be created in regions that users frequently seek but where no anchors currently exist, while rarely used anchors may be demoted or removed. This dynamic updating ensures that the anchor system evolves to better serve actual usage patterns rather than remaining static based on initial analysis.

The method concludes upon having successfully managed symbolic anchors and enabled semantic navigation through the compressed video content. This symbolic anchor system transforms compressed video from a linear medium into a semantically navigable information space, enabling new forms of video interaction that align with how humans naturally think about and remember video content.

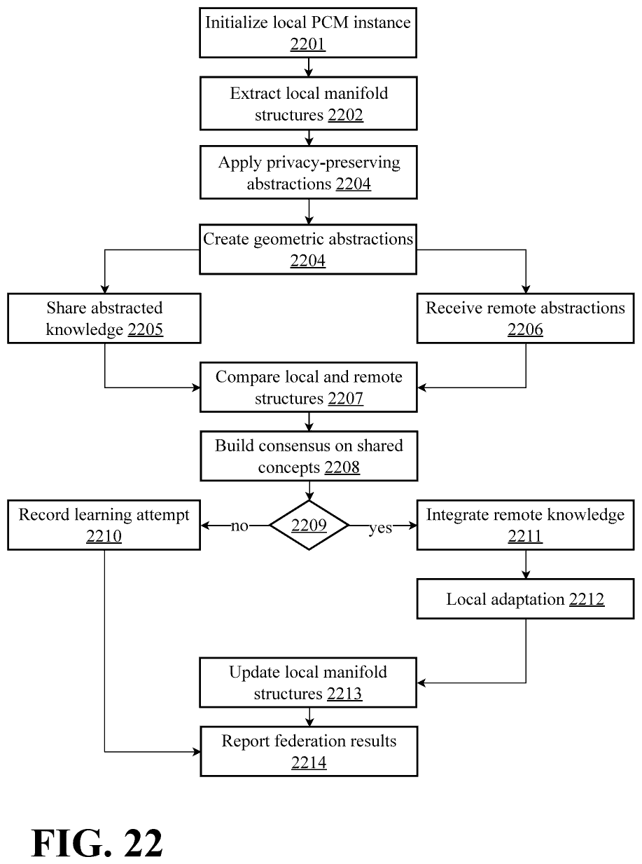

FIG. 22 is a flow diagram illustrating an exemplary method for federated learning across persistent cognitive machine instances, according to an embodiment. The method starts when the system initiates a federated learning process that enables multiple distributed PCM instances to share knowledge and improve their cognitive capabilities without exchanging raw data or compromising privacy.

According to the embodiment, the process begins at step 2201 when the system initializes the local PCM instance and prepares it for federated communication with peer instances. This initialization involves identifying the current state of local manifold structures including thought bundles, curvature patterns, and established navigation strategies that represent the accumulated knowledge of the local system. The preparation process establishes secure communication channels with other PCM instances, sets up protocols for knowledge exchange, and configures privacy parameters that will govern what information can be shared. The system also performs a self-assessment to determine which aspects of its local knowledge might be valuable to other instances and which areas could benefit from external knowledge. This preparation ensures that the local instance can participate effectively in the federated learning process while maintaining its operational integrity.

In step 2202, the system extracts local manifold structures that represent the knowledge and capabilities developed through the instance's unique experiences. The extraction focuses on three primary categories of information: thought bundle configurations that represent how concepts are organized and related within the local cognitive space, curvature patterns that indicate areas of semantic density and the geometric landscape shaped by usage, and successful navigation strategies that have proven effective for reasoning tasks within the local domain. These structures are extracted in their geometric form, preserving the relationships and patterns that make them valuable while preparing them for abstraction. The extraction process carefully selects structures that are well-established and validated through use, avoiding tentative or experimental configurations that might not generalize well to other instances.

Step 2203 applies privacy-preserving abstraction to the extracted structures, transforming specific local knowledge into generalizable patterns that can be safely shared. This critical step removes any identifying content that could reveal sensitive information about the data processed by the local instance, such as specific names, locations, or proprietary information. The abstraction process generalizes specific patterns into broader categories, converting detailed thought bundles about particular entities into abstract templates about entity types and relationships. Despite these transformations, the system maintains the essential geometric properties that make the knowledge valuable, preserving curvature characteristics, topological relationships, and structural patterns. The privacy-preserving abstraction ensures that shared knowledge cannot be reverse-engineered to recover original content while retaining its utility for improving cognitive capabilities.

In step 2204, the system creates geometric abstractions that encode the essential characteristics of local knowledge in a shareable format. These abstractions include topology descriptors that capture the connectivity patterns and structural relationships within thought bundles without revealing their specific content, curvature statistics that summarize the geometric properties of different manifold regions using aggregate measures rather than detailed maps, and bundle relationship graphs that show how different concepts connect and interact while using abstract labels rather than actual semantic content. The geometric abstractions serve as a compact, privacy-safe representation of local knowledge that can be transmitted to other instances and compared with their structures. This abstraction process is carefully designed to preserve the mathematical properties that enable knowledge transfer while eliminating any information that could compromise privacy or security.

Following step 2204, the method enters a parallel federated knowledge exchange phase where the local instance simultaneously shares its abstractions and receives abstractions from other PCM instances. This bidirectional exchange ensures efficient knowledge transfer while maintaining synchronization across the federated network.

In the left branch, step 2205 involves sharing the abstracted knowledge with peer PCM instances across the federated network. The sharing process broadcasts geometric descriptors that summarize the structural characteristics of local manifold regions, enabling other instances to identify potentially useful patterns. Pattern signatures are exchanged that represent successful cognitive strategies in abstract form, allowing peers to recognize similar challenges they may face. The sharing protocol ensures that all participating instances receive the abstractions while maintaining version control and preventing duplicate transmissions. The broadcast may use various network topologies including peer-to-peer connections, hierarchical distribution trees, or cloud-mediated exchanges, depending on the federation architecture.

In the right branch, step 2206 involves receiving remote abstractions from other PCM instances participating in the federated learning network. The system collects geometric patterns and structural descriptions from peer instances, each representing knowledge gained in different domains or applications. The reception process validates the geometric consistency of received abstractions, ensuring they represent valid manifold structures and haven't been corrupted during transmission. The system may receive abstractions from multiple sources simultaneously, requiring careful organization and queuing to process each contribution effectively. The validation includes checking that topology descriptors form valid structures, curvature statistics fall within reasonable bounds, and relationship graphs maintain logical consistency.

The parallel branches converge at step 2207, where the system compares local and remote structures to identify opportunities for knowledge transfer. This comparison involves sophisticated pattern matching that operates on abstract geometric representations rather than semantic content. The system identifies common patterns that appear in both local and remote structures, suggesting universal principles or widely applicable strategies. Novel configurations unique to remote instances are detected as potential sources of new knowledge that could enhance local capabilities. The comparison process uses various similarity metrics adapted for geometric structures, including topological equivalence measures, curvature distribution comparisons, and graph isomorphism detection. This analysis provides the foundation for determining which remote knowledge should be integrated into the local system.

Step 2208 involves building consensus on shared concepts when multiple remote instances provide related but not identical knowledge structures. The consensus building process aligns similar thought bundles from different sources, identifying core commonalities while respecting variations that may reflect different contexts or applications. When conflicting structures arise, such as different organizational patterns for similar concepts, the system implements resolution strategies that may involve voting mechanisms where the most common pattern is adopted, weighted averaging that considers the confidence or success metrics associated with each pattern, or hybrid approaches that preserve multiple valid alternatives. The consensus building ensures that integrated knowledge represents the collective wisdom of the federation rather than being biased by individual instances.

At decision step 2209, the system evaluates whether valuable knowledge has been discovered through the federated exchange that warrants integration into the local manifold. This evaluation considers factors such as the novelty of received patterns compared to existing local knowledge, the potential utility based on similarity to local challenges or gaps in current capabilities, the consensus strength indicating how widely validated the knowledge is across the federation, and the integration cost in terms of computational resources and potential disruption to existing structures. If no valuable knowledge is identified, the method proceeds to step 2210 where the learning attempt is recorded for future reference, maintaining statistics about federation participation that can inform future exchange decisions.

When valuable knowledge is identified, step 2211 integrates the remote knowledge into the local manifold through a careful mapping process. The integration involves translating abstract geometric patterns into concrete structures within the local manifold space, creating new thought bundles or modifying existing ones based on received patterns. The mapping process respects the local manifold's existing organization, finding appropriate regions for new knowledge that maintain coherence with established structures. The system may create provisional structures that are marked for evaluation, allowing the integrated knowledge to prove its utility before becoming permanently established. This integration preserves the privacy boundary by instantiating abstract patterns with local semantics rather than copying specific content from remote instances.

Step 2212 performs local adaptation of the integrated knowledge to ensure it aligns with the specific context and requirements of the local PCM instance. The adaptation process adjusts imported structures to match local conventions and patterns, ensuring smooth integration with existing knowledge. Local optimizations are applied that may reshape the integrated structures to better fit the local manifold's geometry while preserving their essential characteristics. The system maintains markers indicating the federated origin of adapted knowledge, enabling tracking of which improvements came from collective learning. This adaptation ensures that federated knowledge enhances rather than disrupts local cognitive capabilities.

In step 2213, the system updates local manifold structures to incorporate the validated and adapted knowledge from the federation. This update involves modifying the metric tensor in regions where new structures have been integrated, adjusting curvature to reflect the enhanced semantic density, and establishing connections between new and existing thought bundles. The system maintains a federation history that tracks which knowledge came from federated learning, when it was integrated, and how it has been used, enabling long-term analysis of the federation's impact. The update process is designed to be reversible, allowing problematic integrations to be rolled back if they prove detrimental to system performance.

Step 2214 reports federation results to provide visibility into the federated learning process and its outcomes. The report includes knowledge gained statistics showing how many new patterns were integrated and their characteristics, performance improvements measured through enhanced navigation efficiency or reasoning capabilities, and participation metrics that track the local instance's contributions to the collective learning process. These reports serve multiple purposes including system monitoring, federation optimization, and demonstrating the value of participation to stakeholders. The reporting may trigger additional federation rounds if significant knowledge gaps remain or particularly valuable patterns are identified.

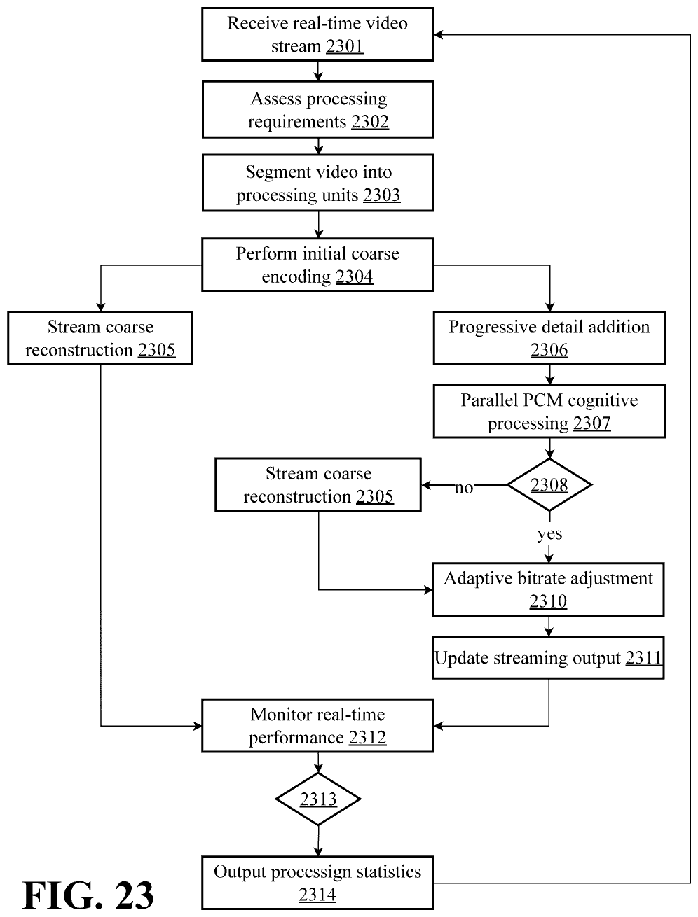

FIG. 23 is a flow diagram illustrating an exemplary method for real-time video processing with progressive refinement, according to an embodiment. The method begins when the system initiates a streaming video processing pipeline designed to deliver immediate low-latency output while progressively enhancing quality as computational resources become available. This approach addresses the fundamental tension between real-time constraints and compression quality by decoupling initial delivery from final quality, enabling systems to provide usable video output within milliseconds while continuing to improve that output in the background. The method transforms traditional batch-oriented video compression into a streaming-compatible progressive system that adapts dynamically to available resources and network conditions.

According to the embodiment, the process begins at step 2301, the system receives a real-time video stream that may originate from a live camera feed, streaming service, or other continuous video source. The reception process implements buffer management to maintain stream continuity despite variations in input rate and processing speed. The buffering strategy must balance several competing requirements: maintaining low latency for real-time responsiveness, accumulating sufficient data for effective compression, and preventing buffer overflow or underflow conditions. The system monitors input characteristics including frame rate, resolution, and data rate to inform subsequent processing decisions. This initial reception establishes the foundation for all downstream processing while maintaining the real-time nature of the video stream.

In step 2302, the system assesses processing requirements by evaluating both the available computational resources and the specific latency constraints of the application. The assessment examines CPU and GPU availability, memory bandwidth limitations, and current system load to determine how much processing power can be allocated to the video stream. Latency constraints are evaluated based on the application requirements, which may range from ultra-low latency for interactive applications to more relaxed constraints for broadcast scenarios. The system also considers quality targets, network conditions, and power consumption limits in mobile or embedded deployments. This comprehensive assessment enables the system to make intelligent decisions about how to balance quality and latency throughout the processing pipeline.

Step 2303 segments the incoming video stream into processing units that can be compressed independently while maintaining temporal coherence. The segmentation creates overlapping temporal windows that ensure smooth transitions between segments and prevent boundary artifacts. Each processing unit contains sufficient temporal context to enable effective compression while being small enough to process within latency constraints. The segmentation strategy maintains causal continuity by ensuring that each unit can be decoded using only information from current and previous units, never requiring future data. The overlap between segments is carefully designed to enable seamless stitching during reconstruction while minimizing redundant processing. This segmentation transforms the continuous stream into manageable units that can flow through the progressive refinement pipeline.

In step 2304, the system performs initial coarse encoding using only the H_{macro} level of the hierarchical compression framework. This encoding applies fast 3D convolutions that capture the essential spatiotemporal structure of the video while requiring minimal computational resources. The coarse encoding prioritizes speed over quality, using simplified neural architectures and reduced precision computations to achieve sub-millisecond processing times. The encoding captures major motion patterns, scene structure, and key visual elements while omitting fine details that would require more extensive processing. This initial encoding provides sufficient information for viewers to understand the video content, making it suitable for immediate streaming while refinements continue in parallel.

Following step 2304, the method splits into parallel processing paths that enable simultaneous streaming and progressive refinement. This parallel architecture is key to achieving both low latency and high quality without compromise.

In the left branch, step 2305 immediately streams the coarse reconstruction to provide low-latency preview quality output. The streaming process outputs the decoded coarse representation with minimal additional processing, ensuring that viewers receive video content with latency measured in milliseconds rather than seconds. The coarse stream maintains temporal consistency and provides sufficient quality for many applications, particularly those prioritizing responsiveness over visual fidelity. The streaming infrastructure supports standard protocols while adding metadata that indicates the progressive nature of the stream and enables clients to receive quality updates. This immediate output satisfies real-time requirements while the system continues to enhance quality in parallel.

In the right branch, step 2306 begins progressive detail addition by computing Hₘₑₛₒ representations that add medium-scale features to the coarse encoding. This processing occurs in the background without affecting the already-streaming coarse output, using available computational resources that weren't needed for real-time processing. The Hₘₑₛₒ encoding captures textures, local motion refinements, and structural details that significantly improve perceived quality. The computation is designed to be interruptible and resumable, allowing the system to dynamically allocate resources based on current load. The progressive nature means that partial Hₘₑₛₒ computations can still provide quality improvements, enabling flexible resource utilization.

Step 2307 performs parallel PCM cognitive processing that analyzes the coarse features to guide intelligent enhancement. The PCM system performs semantic analysis on the coarse representation, identifying objects, understanding scene context, and detecting important regions that should receive priority during refinement. This cognitive processing generates predictive enhancement guidance that helps the progressive refinement focus on perceptually important areas first. The PCM may identify faces that need detail preservation, text that requires sharpness, or motion patterns that benefit from temporal refinement. This cognitive guidance ensures that progressive refinement improves the aspects of video quality that matter most to human viewers.

At decision step 2308, the system assesses whether the current quality level meets the target requirements for the application and network conditions. This assessment considers both objective metrics such as PSNR or SSIM and perceptual quality measures guided by PCM analysis. The quality target may be static based on application requirements or dynamic based on network bandwidth and client capabilities. The assessment also considers the diminishing returns of further refinement, evaluating whether additional processing would provide meaningful quality improvements. This decision point enables early termination of refinement when quality targets are met, freeing resources for processing new segments.

If quality targets are not met, step 2309 adds H_{micro} details to capture fine-scale features and textures. The H_{micro} processing focuses on areas identified by PCM analysis as perceptually important, efficiently allocating computational resources where they provide the most benefit. This finest level of detail includes sharp edges, fine textures, and subtle motion that contribute to professional-quality output. The H_{micro} computation may be partially completed based on available resources, with the system intelligently choosing which regions receive full detail enhancement. After H_{micro} processing, the method returns to quality assessment to determine if further refinement is needed.

When quality targets are met or maximum refinement is achieved, step 2310 performs adaptive bitrate adjustment based on current network conditions and client capabilities. The system monitors network bandwidth, packet loss, and latency to dynamically adjust the quality level transmitted to each client. This adaptation may involve selecting which refinement levels to transmit, adjusting quantization parameters, or modifying temporal resolution. The bitrate adjustment operates independently for different clients, enabling the same source to serve viewers with varying network capabilities. This adaptive approach ensures smooth playback while maximizing quality within available bandwidth constraints.

Step 2311 updates the streaming output by seamlessly replacing coarse reconstructions with refined versions as they become available. The update process carefully synchronizes the replacement to avoid visual discontinuities, using overlapping segments to blend transitions. Clients receive update notifications that allow them to integrate refinements without interrupting playback, creating a viewing experience where quality improves naturally over time. The system maintains version tracking to ensure clients receive consistent updates and can handle out-of-order delivery if network conditions require. This seamless upgrade mechanism is transparent to viewers, who simply observe improving quality without playback interruption.

In step 2312, the system continuously monitors real-time performance metrics to ensure the pipeline maintains its latency and quality objectives. Performance monitoring tracks encoding latency for each hierarchical level, streaming delay from capture to display, quality metrics achieved at each refinement stage, and resource utilization across the pipeline. These metrics feed back into the assessment and decision-making components, enabling dynamic adjustment of processing strategies. The monitoring system can detect when the pipeline is falling behind real-time constraints and trigger load shedding or quality reduction to maintain synchronization. This continuous monitoring ensures reliable real-time operation even under varying conditions.

At decision step 2313, the system determines whether to continue processing the stream or terminate based on stream status and application requirements. If the stream continues, the method loops back to receive new video segments, maintaining the progressive refinement pipeline for the duration of the broadcast or capture session. The continuous loop enables indefinite streaming while adapting to changing conditions throughout the session. State is maintained across iterations to ensure temporal consistency and enable learning from previous segments.

When streaming completes, step 2314 outputs comprehensive processing statistics that characterize the session's performance. These statistics include average latency from capture to initial display, quality levels achieved across different segments, refinement completion rates showing how often full quality was reached, resource utilization patterns throughout the session, and network adaptation events and their impact. These statistics provide valuable feedback for system optimization and demonstrate the effectiveness of progressive refinement in meeting real-time constraints while maximizing quality.

The method concludes upon having successfully processed a real-time video stream with progressive quality refinement. This progressive refinement approach enables a new class of video applications that combine the immediacy of real-time streaming with the quality of sophisticated compression algorithms, adapting dynamically to deliver the best possible experience within available constraints.

The cognitive video compression system described herein is particularly well-suited for distributed implementation across edge devices, cloud resources, and client devices, leveraging the natural partitioning of the system components to optimize performance, reduce latency, and minimize bandwidth usage. In exemplary embodiments, the hierarchical encoder (H_{macro}, Hₘₑₛₒ, H_{micro}) is implemented on edge devices such as cameras, mobile devices, or local processing units near the video source. This edge placement provides several benefits including reduced bandwidth requirements, as only compressed representations need to be transmitted to the cloud rather than raw video data, resulting in bandwidth reduction compared to traditional streaming approaches. The edge implementation also provides lower latency since initial encoding happens immediately at the source without network round-trip delays, enhanced privacy preservation as sensitive raw video data never leaves the edge device, and improved scalability by distributing the encoding load across many edge devices to prevent central server bottlenecks.

The geometric processor and cognitive interface components, including the manifold operations, thought bundle management, and semantic analysis, are optimally implemented on cloud resources in exemplary embodiments. This centralized cognitive processing leverages the computational power of cloud GPUs and specialized tensor processing units for complex manifold operations and geometric calculations. The cloud implementation enables the federated learning capabilities described herein, where multiple edge devices can contribute to collective knowledge while maintaining privacy through the exchange of only abstract geometric patterns. Cloud resources can be dynamically allocated based on demand, enabling efficient handling of varying workloads, while persistent cloud storage maintains the manifold structures and learned patterns over time, accumulating knowledge that benefits all users of the system.

The decoder operates on client devices including smartphones, tablets, computers, and smart TVs where the video will be viewed. Client-side decoding enables adaptive quality, where each client can request and decode video at quality levels appropriate for its display capabilities and network conditions. The client implementation supports efficient streaming by allowing clients to navigate the manifold structure to access only the portions of video they need, rather than downloading entire files. The symbolic anchor system enables clients to jump directly to semantically relevant content without sequential scanning, while the progressive enhancement architecture allows clients to begin playback with coarse representations while downloading and decoding finer details in parallel.

Inter-component communication in the distributed architecture employs efficient protocols optimized for each connection type. Edge-to-cloud communication transmits compressed geometric representations and metadata using efficient binary protocols, with typical bandwidth requirements reduced by 100-1000× compared to raw video transmission. Cloud-to-client communication leverages the manifold structure for intelligent prefetching and caching, where clients download nearby regions in the semantic space for smooth navigation. Cloud-to-cloud communication for federated learning exchanges only abstract geometric patterns between cloud instances, preserving privacy while enabling collective improvement across the distributed system.

This distributed architecture provides system-level advantages including resilience through elimination of single points of failure, as edge devices can operate independently if cloud connection is lost; computational efficiency by performing each operation where it is most efficient; flexibility through independent component upgrades and seamless addition of new edge devices or clients; and cost optimization by sharing expensive cloud computational resources across many users while keeping simpler operations local. The distributed nature of the system aligns naturally with modern video workflows from capture through processing to consumption, while enabling new capabilities through the integration of geometric compression with cognitive understanding. The architecture supports processing of multiple video types including standard video, volumetric video, and holographic video, with the flexibility to adapt to emerging video formats through updates to individual components rather than system-wide modifications.

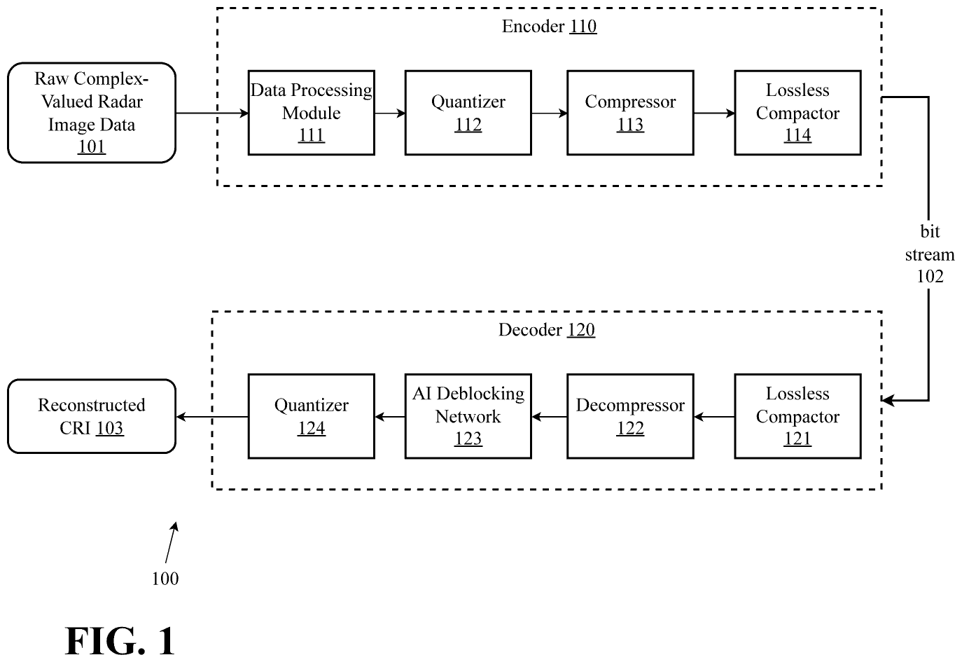

FIG. 1 is a block diagram illustrating an exemplary system architecture 100 for complex-valued SAR image compression with predictive recovery, according to an embodiment. According to the embodiment, the system 100 comprises an encoder module 110 configured to receive as input raw complex-valued (comprising both real (I) and imaginary (Q) components) SAR image data 101 and compress and compact the input data into a bitstream 102, and a decoder module 120 configured to receive and decompress the bitstream 102 to output a reconstructed SAR image data 103. In some embodiments, the SAR image data is stored as a 32-bit floating-point value, covering a range (e.g., full range −R to +R) that varies depending on the specific dataset.

A data processor module 111 may be present and configured to apply one or more data processing techniques to the raw input data to prepare the data for further processing by encoder 110. Data processing techniques can include (but are not limited to) any one or more of data cleaning, data transformation, encoding, dimensionality reduction, data slitting, and/or the like. In an embodiment, data processor 111 is configured to perform data clipping on the input data to a new range (e.g., cut range −C to +C). The selection of the new clipped range should be done such that only 1% of the total pixels in both I and Q channels are affected by the clipping action. Clipping the data limits the effect of extreme values while preserving the overall information contained in the SAR image.

After data processing, a quantizer 112 performs uniform quantization on the I and Q channels. Quantization is a process used in various fields, including signal processing, data compression, and digital image processing, to represent continuous or analog data using a discrete set of values. It involves mapping a range of values to a smaller set of discrete values. Quantization is commonly employed to reduce the storage requirements or computational complexity of digital data while maintaining an acceptable level of fidelity or accuracy. In an embodiment, quantizer 112 receives the clipped I/Q channels and quantizes them to 12 bits, thereby limiting the range of I and Q from 0 to 4096. The result is a more compact representation of the data. According to an implementation, the quantized I/Q images are then stored in uncompressed PNG format, which is used as input to a compressor 113. Compressor 113 may be configured to perform data compression on quantized I/Q images using a suitable conventional compression algorithm. According to an embodiment, compressor 113 may utilize High Efficiency Video Coding (HVEC) in intra mode to independently encode the I/Q image. In such embodiments, HVEC may be used at a decompressor 122 at decoder 120.

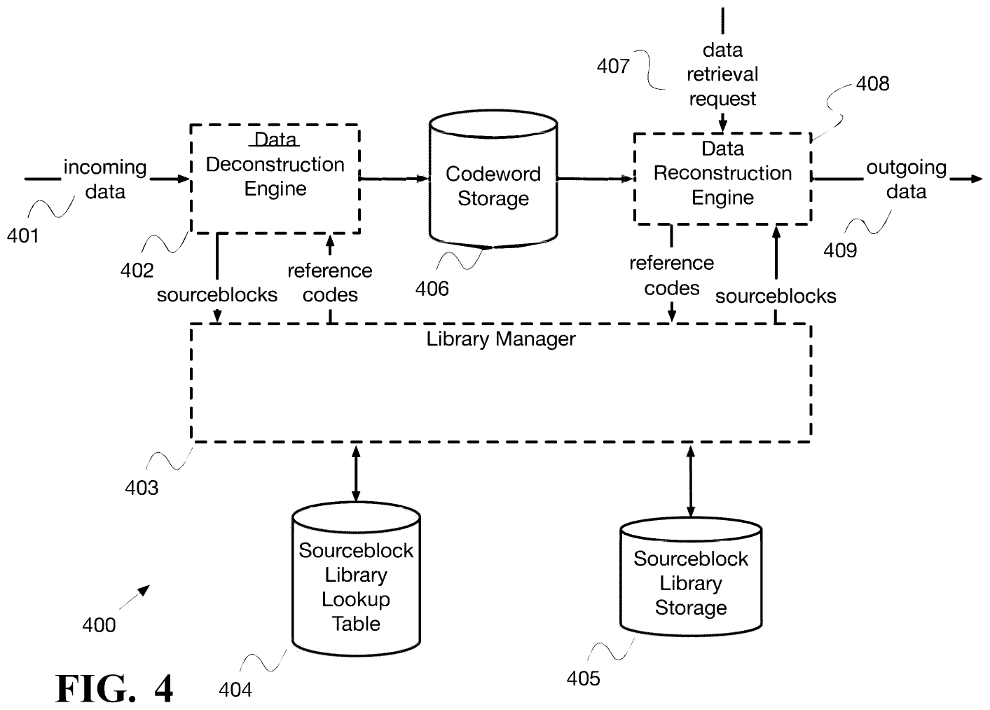

The resulting encoded bitstream may then be (optionally) input into a lossless compactor 114 which can apply data compaction techniques on the received encoded bitstream. An exemplary lossless data compaction system which may be integrated in an embodiment of system 100 is illustrated with reference to FIG. 4-7. For example, lossless compactor 114 may utilize an embodiment of data deconstruction engine 501 and library manager 403 to perform data compaction on the encoded bitstream. The output of the compactor is a compacted bitstream 102 which can be stored in a database, requiring much less space than would have been necessary to store the raw 32-bit complex-valued radar image, or it can be transmitted to some other endpoint.

At the endpoint which receives the transmitted compacted bitstream 102 may be decoder module 120 configured to restore the compacted data into the original complex-valued radar image by essentially reversing the process conducted at encoder module 110. The received bitstream may first be (optionally) passed through a lossless compactor 121 which de-compacts the data into an encoded bitstream. In an embodiment, a data reconstruction engine 601 may be implemented to restore the compacted bitstream into its encoded format. The encoded bitstream may flow from compactor 121 to decompressor 122 wherein a data compaction technique may be used to decompress the encoded bitstream into the I/Q channels. In an embodiment, decompressor 122 uses HVEC techniques to decompress the encoded bitstream. It should be appreciated that lossless compactor components 114 and 121 are optional components of the system, and may or may not be present in the system, dependent upon the embodiment.

According to the embodiment, an Artificial Intelligence (AI) deblocking network 123 is present and configured to utilize a trained deep learning network to enhance a decoded SAR image (i.e., I/Q channels) as part of the decoding process. AI deblocking network 123 may leverage the linear relationship demonstrated between I and Q images to enhance the reconstructed SAR image 103. Effectively, AI deblocking network 123 provides an improved and novel method for removing compression artifacts that occur during lossy compression/decompression using a network designed during the training process to simultaneously address the removal of artifacts and maintain fidelity of the amplitude information by optimizing the balance between SAR loss and amplitude loss, ensuring a comprehensive optimization of the network during the training stages.

The output of AI deblocking network 123 may be dequantized by quantizer 124, restoring the I/Q channels to their initial dynamic range. The dequantized SAR image may be reconstructed and output 103 by decoder module 120 or stored in a database.

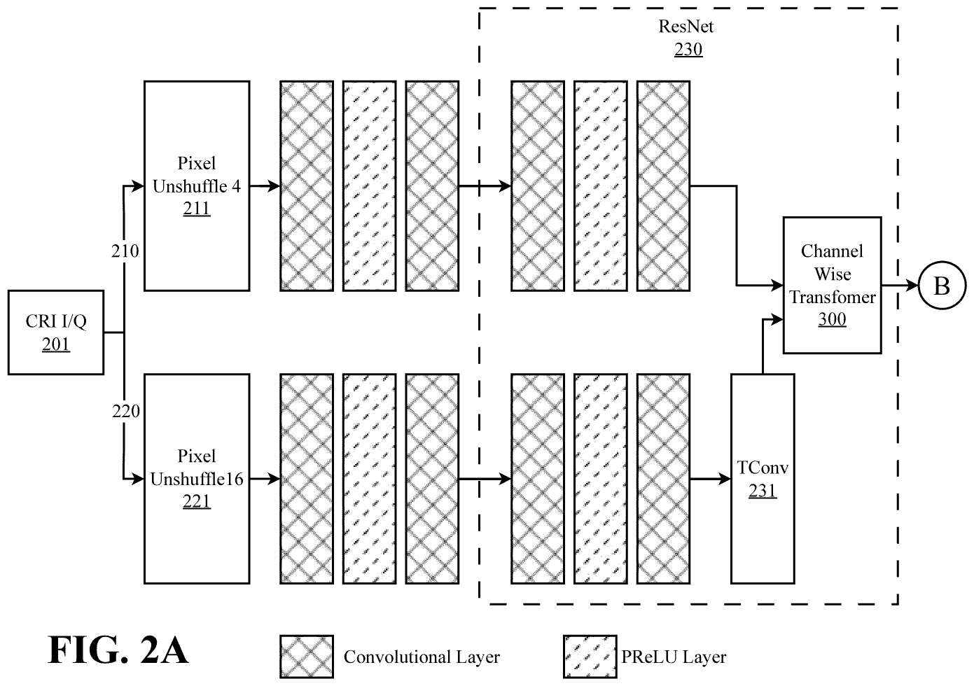

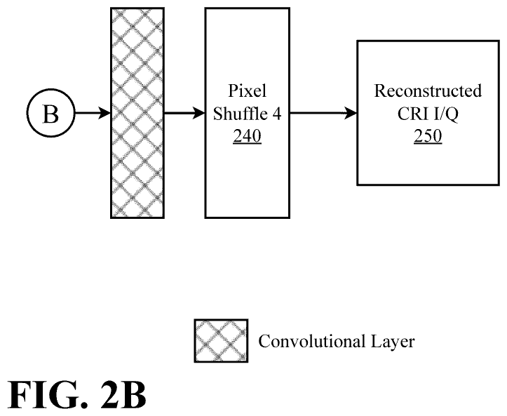

FIGS. 2A and 2B illustrate an exemplary architecture for an AI deblocking network configured to provide deblocking for dual-channel data stream comprising radar image I/Q data, according to an embodiment. In the context of this disclosure, dual-channel data refers to fact that complex-valued radar image signals can be represented as two (dual) components (i.e., I and Q) which are correlated to each other in some manner. In the case of I and Q, their correlation is that they can be transformed into phase and amplitude information and vice versa. AI deblocking network utilizes a deep learned neural network architecture for joint frequency and pixel domain learning. According to the embodiment, a network may be developed for joint learning across one or more domains. As shown, the top branch 210 is associated with the pixel domain learning and the bottom branch 220 is associated with the frequency domain learning. According to the embodiment, the AI deblocking network receives as input complex-valued radar image I and Q channels 201 which, having been encoded via encoder 110, has subsequently been decompressed via decoder 120 before being passed to AI deblocking network for image enhancement via artifact removal. Inspired by the residual learning network and the MSAB attention mechanism, AI deblocking network employs resblocks that take two inputs. In some implementations, to reduce complexity the spatial resolution may be downsampled to one-half and one-fourth. During the final reconstruction the data may be upsampled to its original resolution. In one implementation, in addition to downsampling, the network employs deformable convolution to extract initial features, which are then passed to the resblocks. In an embodiment, the network comprises one or more resblocks and one or more convolutional filters. In an embodiment, the network comprises 8 resblocks and 64 convolutional filters.

Deformable convolution is a type of convolutional operation that introduces spatial deformations to the standard convolutional grid, allowing the convolutional kernel to adaptively sample input features based on the learned offsets. It's a technique designed to enhance the modeling of spatial relationships and adapt to object deformations in computer vision tasks. In traditional convolutional operations, the kernel's positions are fixed and aligned on a regular grid across the input feature map. This fixed grid can limit the ability of the convolutional layer to capture complex transformations, non-rigid deformations, and variations in object appearance. Deformable convolution aims to address this limitation by introducing the concept of spatial deformations. Deformable convolution has been particularly effective in tasks like object detection and semantic segmentation, where capturing object deformations and accurately localizing object boundaries are important. By allowing the convolutional kernels to adaptively sample input features from different positions based on learned offsets, deformable convolution can improve the model's ability to handle complex and diverse visual patterns.

According to an embodiment, the network may be trained as a two-stage process, each utilizing specific loss functions. During the first stage, a mean squared error (MSE) function is used in the I/Q domain as a primary loss function for the AI deblocking network. The loss function of the complex-valued radar image I/Q channel L_{CRI} is defined as:

$${L}_{CRI} = 𝔼 [ {‖ I - {I}_{amp} ‖}_{2} ]$$

Moving to the second stage, the network reconstructs the amplitude component and computes the amplitude loss using MSE as follows:

$${L}_{amp} = 𝔼 [ {‖ {I}_{amp} - {I}_{dec , amp} ‖}_{2} ]$$

To calculate the overall loss, the network combines the complex-valued radar image loss and the amplitude loss, incorporating a weighting factor, α, for the amplitude loss. The total loss is computed as:

$${L}_{total} = {L}_{CRI} + α \times {L}_{amp}$$

The weighting factor value may be selected based on the dataset used during network training. In an embodiment, the network may be trained using two different SAR datasets: the National Geospatial-Intelligence Agency (NGA) SAR dataset and the Sandia National Laboratories Mini SAR Complex Imagery dataset, both of which feature complex-valued SAR images. In an embodiment, the weighting factor is set to 0.0001 for the NGA dataset and 0.00005 for the Sandia dataset. By integrating both the SAR and amplitude losses in the total loss function, the system effectively guides the training process to simultaneously address the removal of the artifacts and maintain the fidelity of the amplitude information. The weighting factor, α, enables AI deblocking network to balance the importance of the SAR loss and the amplitude loss, ensuring comprehensive optimization of the network during the training stages. In some implementations, diverse data augmentation techniques may be used to enhance the variety of training data. For example, techniques such as horizontal and vertical flops and rotations may be implemented on the training dataset. In an embodiment, model optimization is performed using MSE loss and Adam optimizer with a learning rate initially set to 1×10⁻⁴ and decreased by a factor of 2 at epochs 100, 200, and 250, with a total of 300 epochs. In an implementation, the batch size is set to 256×256 with each batch containing 16 images.

Both branches first pass through a pixel unshuffling layer 211, 221 which implements a pixel unshuffling process on the input data. Pixel unshuffling is a process used in image processing to reconstruct a high-resolution image from a low-resolution image by rearranging or “unshuffling” the pixels. The process can involve the following steps, low-resolution input, pixel arrangement, interpolation, and enhancement. The input to the pixel unshuffling algorithm is a low-resolution image (i.e., decompressed, quantized SAR I/Q data). This image is typically obtained by downscaling a higher-resolution image such as during the encoding process executed by encoder 110. Pixel unshuffling aims to estimate the original high-resolution pixel values by redistributing and interpolating the low-resolution pixel values. The unshuffling process may involve performing interpolation techniques, such as nearest-neighbor, bilinear, or more sophisticated methods like bicubic or Lanczos interpolation, to estimate the missing pixel values and generate a higher-resolution image.

The output of the unshuffling layers 211, 221 may be fed into a series of layers which can include one or more convolutional layers and one or more parametric rectified linear unit (PReLU) layers. A legend is depicted for both FIG. 2A and FIG. 2B which indicates the cross hatched block represents a convolutional layer and the dashed block represents a PReLU layer. Convolution is the first layer to extract features from an input image. Convolution preserves the relationship between pixels by learning image features using small squares of input data. It is a mathematical operation that takes two inputs such as an image matrix and a filter or kernel. The embodiment features a cascaded ResNet-like structure comprising 8 ResBlocks to effectively process the input data. The filter size associated with each convolutional layer may be different. The filter size used for the pixel domain of the top branch may be different than the filter size used for the frequency domain of the bottom branch.

A PRELU layer is an activation function used in neural networks. The PRELU activation function extends the ReLU by introducing a parameter that allows the slope for negative values to be learned during training. The advantage of PRELU over ReLU is that it enables the network to capture more complex patterns and relationships in the data. By allowing a small negative slope for the negative inputs, the PRELU can learn to handle cases where the output should not be zero for all negative values, as is the case with the standard ReLU. In other implementations, other non-linear functions such as tanh or sigmoid can be used instead of PReLU.

After passing through a series of convolutional and PRELU layers, both branches enter the resnet 230 which further comprises more convolutional and PRELU layers. The frequency domain branch is slightly different than the pixel domain branch once inside ResNet 230, specifically the frequency domain is processed by a transposed convolutional (TConv) layer 231. Transposed convolutions are a type of operation used in neural networks for tasks like image generation, image segmentation, and upsampling. They are used to increase the spatial resolution of feature maps while maintaining the learned relationships between features. Transposed convolutions aim to increase spatial dimensions of feature maps, effectively “upsampling” them. This is typically done by inserting zeros (or other values) between existing values to create more space for new values.

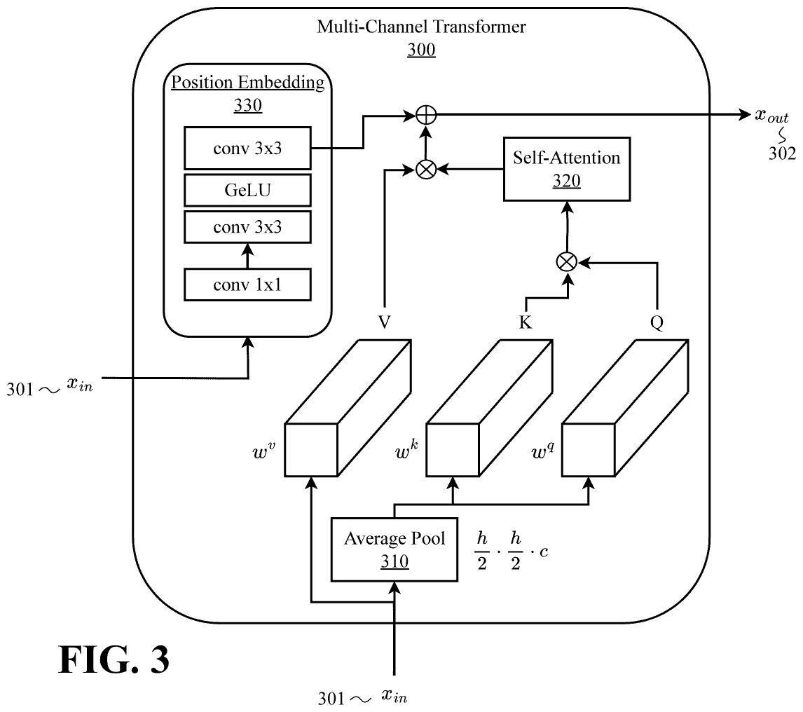

Inside ResBlock 230 the data associated with the pixel and frequency domains are combined back into a single stream by using the output of the Tconv 231 and the output of the top branch. The combined data may be used as input for a channel-wise transformer 300. In some embodiments, the channel-wise transformer may be implemented as a multi-scale attention block utilizing the attention mechanism. For more detailed information about the architecture and functionality of channel-wise transformer 300 refer to FIG. 3. The output of channel-wise transformer 300 may be a bit stream suitable for reconstructing the original SAR I/Q image. FIG. 2B shows the output of ResBlock 230 is passed through a final convolutional layer before being processed by a pixel shuffle layer 240 which can perform upsampling on the data prior to image reconstruction. The output of the AI deblocking network may be passed through a quantizer 124 for dequantization prior to producing a reconstructed SAR I/Q image 250.

FIG. 3 is a block diagram illustrating an exemplary architecture for a component of the system for SAR image compression, the channel-wise transformer 300. According to the embodiment, channel-wise transformer receives an input signal, Xin 301, the input signal comprising SAR I/Q data which is being processed by AI deblocking network 123. The input signal may be copied and follow two paths through multi-channel transformer 300.

A first path may process input data through a position embedding module 330 comprising series of convolutional layers as well as a Gaussian Error Linear Unit (GeLU). In traditional recurrent neural networks or convolutional neural networks, the order of input elements is inherently encoded through the sequential or spatial nature of these architectures. However, in transformer-based models, where the attention mechanism allows for non-sequential relationships between tokens, the order of tokens needs to be explicitly conveyed to the model. Position embedding module 330 may represent a feedforward neural network (position-wise feedforward layers) configured to add position embeddings to the input data to convey the spatial location or arrangement of pixels in an image. The output of position embedding module 330 may be added to the output of the other processing path the received input signal is processed through.

A second path may process the input data. It may first be processed via a channel-wise configuration and then through a self-attention layer 320. The signal may be copied/duplicated such that a copy of the received signal is passed through an average pool layer 310 which can perform a downsampling operation on the input signal. It may be used to reduce the spatial dimensions (e.g., width and height) of feature maps while retaining the most important information. Average pooling functions by dividing the input feature map into non-overlapping rectangular or square regions (often referred to as pooling windows or filters) and replacing each region with the average of the values within that region. This functions to downsample the input by summarizing the information within each pooling window.

Self-attention layer 320 may be configured to provide an attention to AI deblocking network 123. The self-attention mechanism, also known as intra-attention or scaled dot-product attention, is a fundamental building block used in various deep learning models, particularly in transformer-based models. It plays a crucial role in capturing contextual relationships between different elements in a sequence or set of data, making it highly effective for tasks involving sequential or structured data like complex-valued SAR I/Q channels. Self-attention layer 320 allows each element in the input sequence to consider other elements and weigh their importance based on their relevance to the current element. This enables the model to capture dependencies between elements regardless of their positional distance, which is a limitation in traditional sequential models like RNNs and LSTMs.

The input 301 and downsampled input sequence is transformed into three different representations: Query (Q), Key (K), and Value (V). These transformations (w^{V}, w^{K}, and w^{Q}) are typically linear projections of the original input. For each element in the sequence, the dot product between its Query and the Keys of all other elements is computed. The dot products are scaled by a factor to control the magnitude of the attention scores. The resulting scores may be normalized using a softmax function to get attention weights that represent the importance of each element to the current element. The Values (V) of all elements are combined using the attention weights as coefficients. This produces a weighted sum, where elements with higher attention weights contribute more to the final representation of the current element. The weighted sum is the output of the self-attention mechanism for the current element. This output captures contextual information from the entire input sequence.

The output of the two paths (i.e., position embedding module 330 and self-attention layer 320) may be combined into a single output data stream xₒᵤₜ 302.

FIG. 4 is a block diagram illustrating an exemplary system architecture 400 for providing lossless data compaction, according to an embodiment. As incoming data 401 is received by data deconstruction engine 402. Data deconstruction engine 402 breaks the incoming data into sourceblocks, which are then sent to library manager 403. Using the information contained in sourceblock library lookup table 404 and sourceblock library storage 405, library manager 403 returns reference codes to data deconstruction engine 402 for processing into codewords, which are stored in codeword storage 106. When a data retrieval request 407 is received, data reconstruction engine 408 obtains the codewords associated with the data from codeword storage 406, and sends them to library manager 403. Library manager 403 returns the appropriate sourceblocks to data reconstruction engine 408, which assembles them into the proper order and sends out the data in its original form 409.

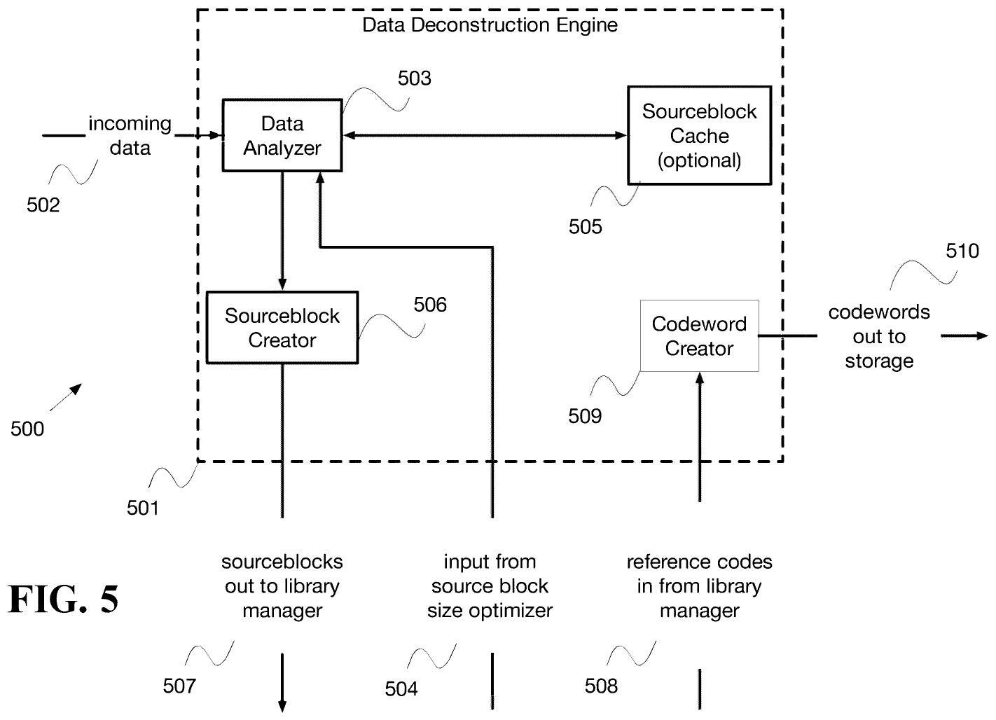

FIG. 5 is a diagram showing an embodiment of one aspect 500 of the system, specifically data deconstruction engine 501. Incoming data 502 is received by data analyzer 503, which optimally analyzes the data based on machine learning algorithms and input 504 from a sourceblock size optimizer, which is disclosed below. Data analyzer may optionally have access to a sourceblock cache 505 of recently processed sourceblocks, which can increase the speed of the system by avoiding processing in library manager 403. Based on information from data analyzer 503, the data is broken into sourceblocks by sourceblock creator 506, which sends sourceblocks 507 to library manager 403 for additional processing. Data deconstruction engine 501 receives reference codes 508 from library manager 403, corresponding to the sourceblocks in the library that match the sourceblocks sent by sourceblock creator 506, and codeword creator 509 processes the reference codes into codewords comprising a reference code to a sourceblock and a location of that sourceblock within the data set. The original data may be discarded, and the codewords representing the data are sent out to storage 510.

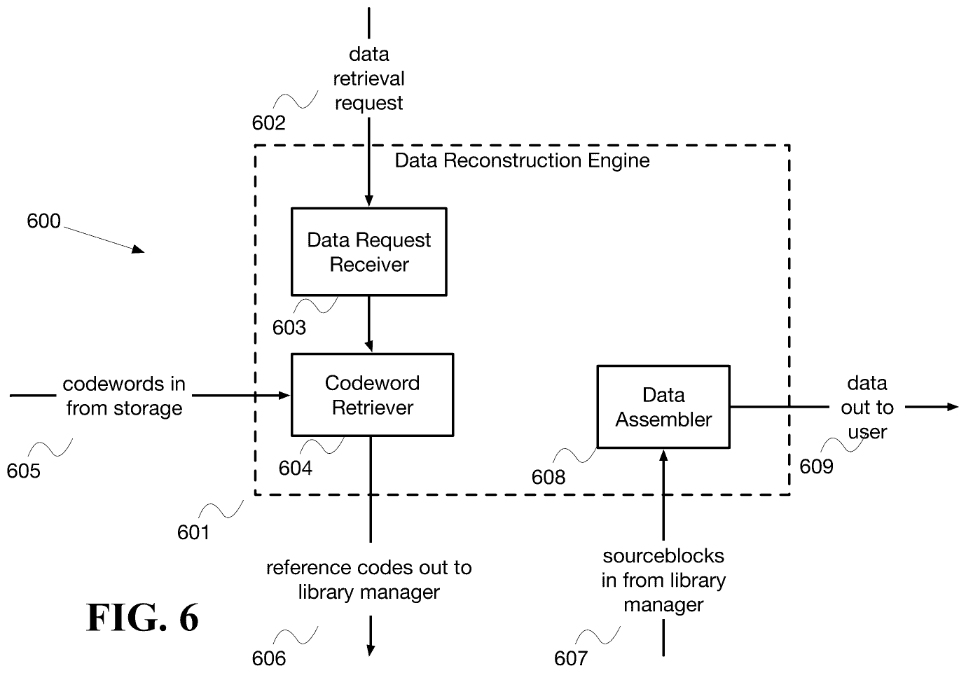

FIG. 6 is a diagram showing an embodiment of another aspect of system 600, specifically data reconstruction engine 601. When a data retrieval request 602 is received by data request receiver 603 (in the form of a plurality of codewords corresponding to a desired final data set), it passes the information to data retriever 604, which obtains the requested data 605 from storage. Data retriever 604 sends, for each codeword received, a reference codes from the codeword 606 to library manager 403 for retrieval of the specific sourceblock associated with the reference code. Data assembler 608 receives the sourceblock 607 from library manager 403 and, after receiving a plurality of sourceblocks corresponding to a plurality of codewords, assembles them into the proper order based on the location information contained in each codeword (recall each codeword comprises a sourceblock reference code and a location identifier that specifies where in the resulting data set the specific sourceblock should be restored to. The requested data is then sent to user 609 in its original form.

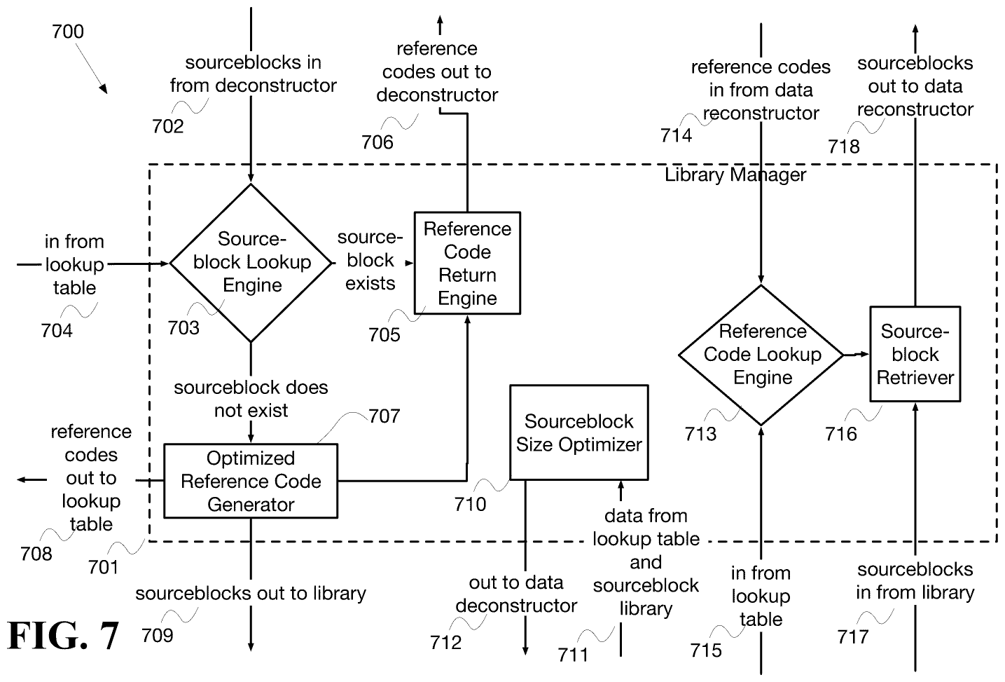

FIG. 7 is a diagram showing an embodiment of another aspect of the system 700, specifically library manager 701. One function of library manager 701 is to generate reference codes from sourceblocks received from data deconstruction engine 701. As sourceblocks are received 702 from data deconstruction engine 501, sourceblock lookup engine 703 checks sourceblock library lookup table 704 to determine whether those sourceblocks already exist in sourceblock library storage 705. If a particular sourceblock exists in sourceblock library storage 105, reference code return engine 705 sends the appropriate reference code 706 to data deconstruction engine 601. If the sourceblock does not exist in sourceblock library storage 105, optimized reference code generator 407 generates a new, optimized reference code based on machine learning algorithms. Optimized reference code generator 707 then saves the reference code 708 to sourceblock library lookup table 704; saves the associated sourceblock 709 to sourceblock library storage 105; and passes the reference code to reference code return engine 705 for sending 706 to data deconstruction engine 501. Another function of library manager 701 is to optimize the size of sourceblocks in the system. Based on information 711 contained in sourceblock library lookup table 404, sourceblock size optimizer 410 dynamically adjusts the size of sourceblocks in the system based on machine learning algorithms and outputs that information 712 to data analyzer 603. Another function of library manager 701 is to return sourceblocks associated with reference codes received from data reconstruction engine 601. As reference codes are received 714 from data reconstruction engine 601, reference code lookup engine 713 checks sourceblock library lookup table 715 to identify the associated sourceblocks; passes that information to sourceblock retriever 716, which obtains the sourceblocks 717 from sourceblock library storage 405; and passes them 718 to data reconstruction engine 601.

### DETAILED DESCRIPTION OF EXEMPLARY ASPECTS

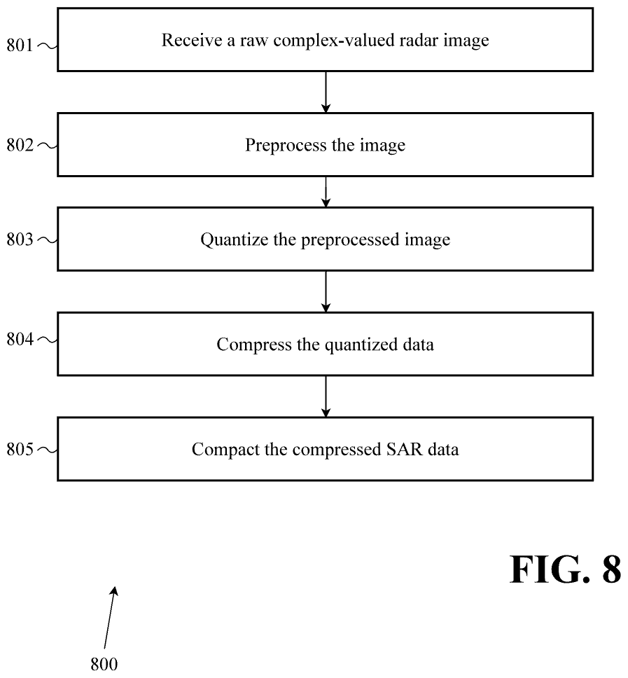

FIG. 8 is a flow diagram illustrating an exemplary method 800 for complex-valued SAR image compression, according to an embodiment. According to the embodiment, the process begins at step 801 when encoder 110 receives a raw complex-valued SAR image. The complex-valued SAR image comprises both I and Q components. In some embodiments, the I and Q components may be processed as separate channels. At step 802, the received SAR image may be preprocessed for further processing by encoder 110. For example, the input image may be clipped or otherwise transformed in order to facilitate further processing. As a next step 803, the preprocessed data may be passed to quantizer 112 which quantizes the data. The next step 804, comprises compressing the quantized SAR data using a compression algorithm known to those with skill in the art. In an embodiment, the compression algorithm may comprise HEVC encoding for both compression and decompression of SAR data. As a last step 805, the compressed data may be compacted. The compaction may be a lossless compaction technique, such as those described with reference to FIGS. 4-7. The output of method 800 is a compressed, compacted bit stream of SAR image data which can be stored in a database, requiring much less storage space than would be required to store the original, raw SAR image. The compressed and compacted bit stream may be transmitted to an endpoint for storage or processing. Transmission of the compressed and compacted data require less bandwidth and computing resources than transmitting raw SAR image data.

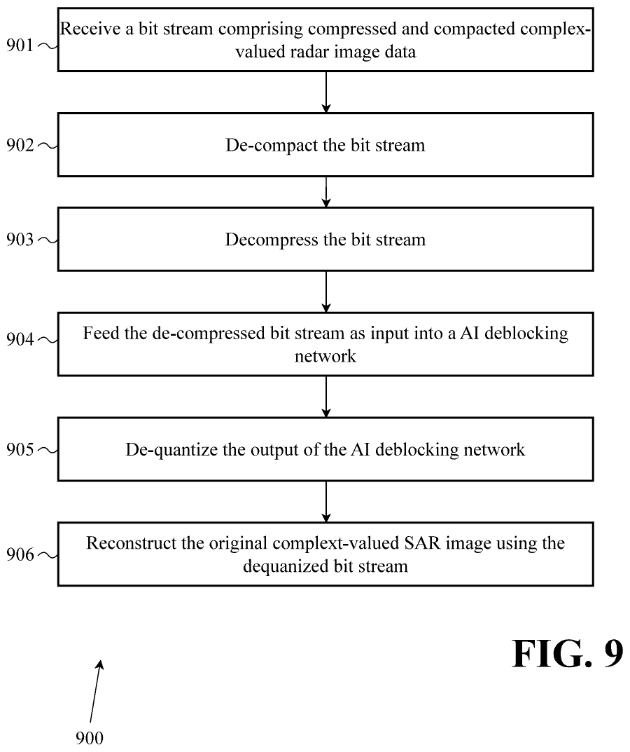

FIG. 9 is a flow diagram illustrating and exemplary method 900 for decompression of a complex-valued SAR image, according to an embodiment. According to the embodiment, the process begins at step 901 when decoder 120 receives a bit stream comprising compressed and compacted complex-valued SAR image data. The compressed bit stream may be received from encoder 110 or from a suitable data storage device. At step 902, the received bit stream is first de-compacted to produce an encoded (compressed) bit stream. In some embodiments, data reconstruction engine 601 may be implemented as a system for de-compacting a received bit stream. The next step 903, comprising decompressing the de-compacted bit stream using a suitable compression algorithm known to those with skill in the art, such as HEVC encoding. At step 904, the de-compressed SAR data may be fed as input into AI deblocking network 123 for image enhancement via a trained deep learning network. The AI deblocking network may utilize a series of convolutional layers and/or ResBlocks to process the input data and perform artifact removal on the de-compressed SAR image data. AI deblocking network may be further configured to implement an attention mechanism for the model to capture dependencies between elements regardless of their positional distance. In an embodiment, during training of AI deblocking network, the amplitude loss in conjunction with the SAR loss may be computed and accounted for, further boosting the compression performance of system 100. The output of AI deblocking network 123 can be sent to a quantizer 124 which can execute step 905 by de-quantizing the output bit stream from AI deblocking network. As a last step 906, system can reconstruct the original complex-valued SAR image using the de-quantized bit stream.

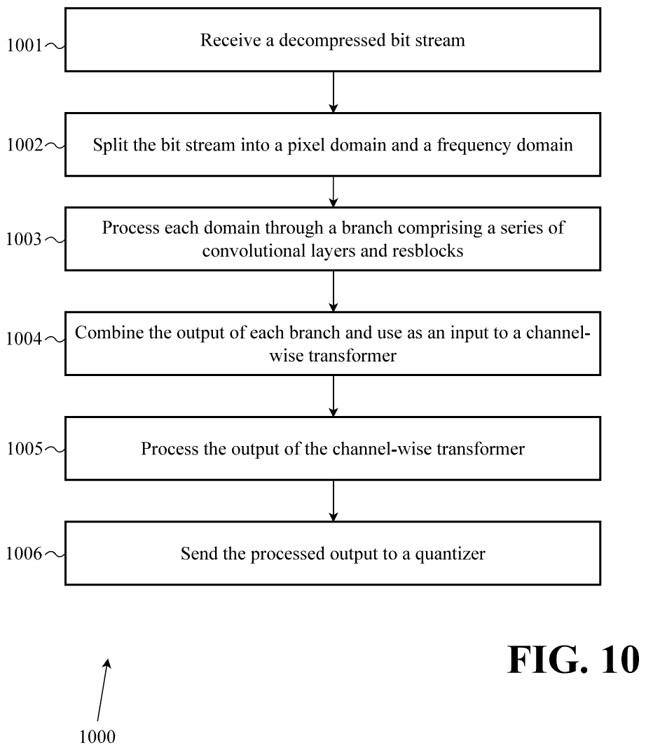

FIG. 10 is a flow diagram illustrating an exemplary method for deblocking using a trained deep learning algorithm, according to an embodiment. According to the embodiment, the process begins at step 1001 wherein the trained deep learning algorithm (i.e., AI deblocking network 123) receives a decompressed bit stream comprising SAR I/Q image data. At step 1002, the bit stream is split into a pixel domain and a frequency domain. Each domain may pass through AI deblocking network, but have separate, almost similar processing paths. As a next step 1003, each domain is processed through its respective branch, the branch comprising a series of convolutional layers and ResBlocks. In some implementations, frequency domain may be further processed by a transpose convolution layer. The two branches are combined and used as input for a multi-channel transformer with attention mechanism at step 1004. Multi-channel transformer 300 may perform functions such as downsampling, positional embedding, and various transformations, according to some embodiments. Multi-channel transformer 300 may comprise one or more of the following components: channel-wise attention, transformer self-attention, and/or feedforward layers. In an implementation, the downsampling may be performed via average pooling. As a next step 1005, the AI deblocking network processes the output of the channel-wise transformer. The processing may include the steps of passing the output through one or more convolutional or PRELU layers and/or upsampling the output. As a last step 1006, the processed output may be forwarded to quantizer 124 or some other endpoint for storage or further processing.

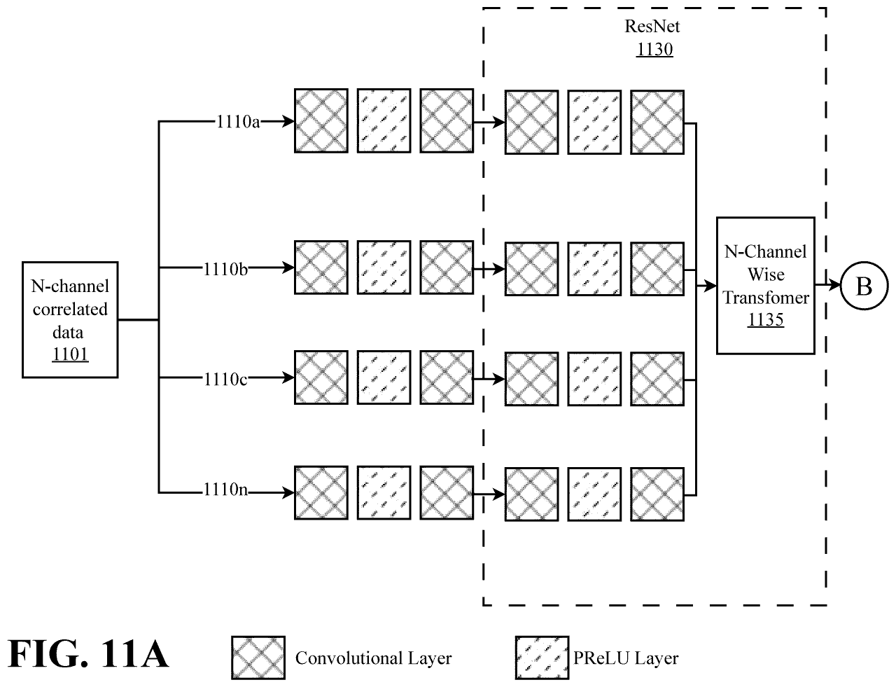

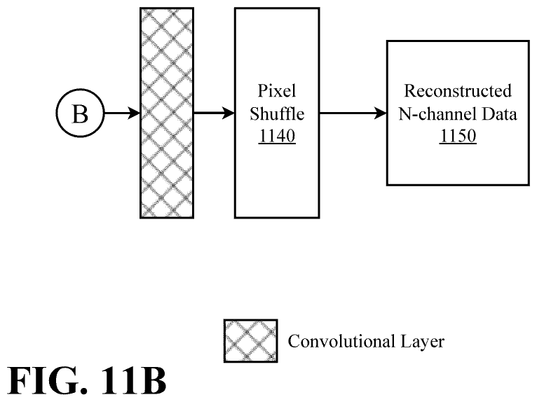

FIGS. 11A and 11B illustrate an exemplary architecture for an AI deblocking network configured to provide deblocking for a general N-channel data stream, according to an embodiment. The term “N-channel” refers to data that is composed of multiple distinct channels of modalities, where each channel represents a different aspect of type of information. These channels can exist in various forms, such as sensor readings, image color channels, or data streams, and they are often used together to provide a more comprehensive understanding of the underlying phenomenon. Examples of N-channel data include, but is not limited to, RGB images (e.g., in digital images, the red, green, and blue channels represent different color information; combining these channels allows for the representation of a wide range of colors), medical imaging (e.g., may include Magnetic Resonance Imaging scans with multiple channels representing different tissue properties, or Computed Tomography scans with channels for various types of X-ray attenuation), audio data (e.g., stereo or multi-channel audio recordings where each channel corresponds to a different microphone or audio source), radar and lidar (e.g., in autonomous vehicles, radar and lidar sensors provide multi-channel data, with each channel capturing information about objects' positions, distances, and reflectivity) SAR image data, text data (e.g., in natural language processing, N-channel data might involve multiple sources of text, such as social media posts and news articles, each treated as a separate channel to capture different textual contexts), sensor networks (e.g., environmental monitoring systems often employ sensor networks with multiple sensors measuring various parameters like temperature, humidity, air quality, and more. Each sensor represents a channel), climate data, financial data, and social network data.

The disclosed AI deblocking network may be trained to process any type of N-channel data, if the N-channel data has a degree of correlation. More correlation between and among the multiple channels yields a more robust and accurate AI deblocking network capable of performing high quality compression artifact removal on the N-channel data stream. A high degree of correlation implies a strong relationship between channels. Using SAR image data has been used herein as an exemplary use case for an AI deblocking network for a N-channel data stream comprising 2 channels, the In-phase and Quadrature components (i.e., I and Q, respectively).

Exemplary data correlations that can be exploited in various implementations of AI deblocking network can include, but are not limited to, spatial correlation, temporal correlation, cross-sectional correlation (e.g., This occurs when different variables measured at the same point in time are related to each other), longitudinal correlation, categorical correlation, rank correlation, time-space correlation, functional correlation, and frequency domain correlation, to name a few.

As shown, an N-channel AI deblocking network may comprise a plurality of branches 1110a-n. The number of branches is determined by the number of channels associated with the data stream. Each branch may initially be processed by a series of convolutional and PRELU layers. Each branch may be processed by resnet 1130 wherein each branch is combined back into a single data stream before being input to N-channel wise transformer 1135, which may be a specific configuration of transformer 300. The output of N-channel wise transformer 1135 may be sent through a final convolutional layer before passing through a last pixel shuffle layer 1140. The output of AI deblocking network for N-channel video/image data is the reconstructed N-channel data 1150.

As an exemplary use case, video/image data may be processed as a 3-channel data stream comprising Green (G), Red (R), and Blue (B) channels. An AI deblocking network may be trained that provides compression artifact removal of video/image data. Such a network would comprise 3 branches, wherein each branch is configured to process one of the three channels (R, G, or B). For example, branch 1110a may correspond to the R-channel, branch 1110b to the G-channel, and branch 1110c to the B-channel. Each of these channels may be processed separately via their respective branches before being combined back together inside resnet 1130 prior to being processed by N-channel wise transformer 1135.

As another exemplary use case, a sensor network comprising a half dozen sensors may be processed as a 6-channel data stream. The exemplary sensor network may include various types of sensors collecting different types of, but still correlated, data. For example, sensor network can include a pressure sensor, a thermal sensor, a barometer, a wind speed sensor, a humidity sensor, and an air quality sensor. These sensors may be correlated to one another in at least one way. For example, the six sensors in the sensor network may be correlated both temporally and spatially, wherein each sensor provides a time series data stream which can be processed by one of the 6 channels 1110a-n of AI deblocking network. As long as AI deblocking network is trained on N-channel data with a high degree of correlation and which is representative of the N-channel data it will encounter during model deployment, it can reconstruct the original data using the methods described herein.

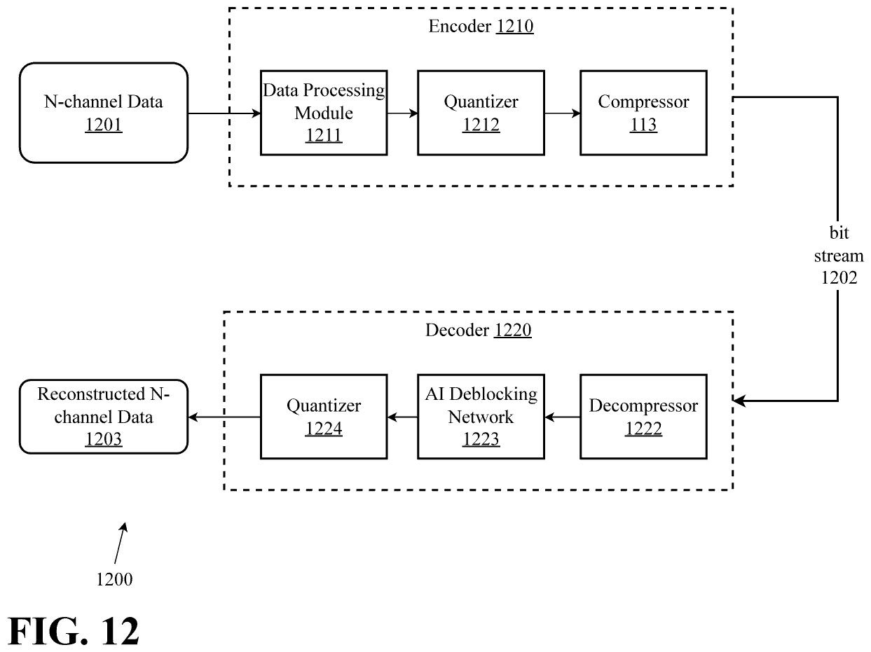

FIG. 12 is a block diagram illustrating an exemplary system architecture 1200 for N-channel data compression with predictive recovery, according to an embodiment. According to the embodiment, the system 1200 comprises an encoder module 1210 configured to receive as input N-channel data 1201 and compress and compact the input data into a bitstream 102, and a decoder module 120 configured to receive and decompress the bitstream 1202 to output a reconstructed N-channel data 1203.

A data processor module 1211 may be present and configured to apply one or more data processing techniques to the raw input data to prepare the data for further processing by encoder 1210. Data processing techniques can include (but are not limited to) any one or more of data cleaning, data transformation, encoding, dimensionality reduction, data slitting, and/or the like.

After data processing, a quantizer 1212 performs uniform quantization on the n-number of channels. Quantization is a process used in various fields, including signal processing, data compression, and digital image processing, to represent continuous or analog data using a discrete set of values. It involves mapping a range of values to a smaller set of discrete values. Quantization is commonly employed to reduce the storage requirements or computational complexity of digital data while maintaining an acceptable level of fidelity or accuracy. Compressor 1213 may be configured to perform data compression on quantized N-channel data using a suitable conventional compression algorithm.

The resulting encoded bitstream may then be (optionally) input into a lossless compactor (not shown) which can apply data compaction techniques on the received encoded bitstream. An exemplary lossless data compaction system which may be integrated in an embodiment of system 1200 is illustrated with reference to FIG. 4-7. For example, lossless compactor may utilize an embodiment of data deconstruction engine 501 and library manager 403 to perform data compaction on the encoded bitstream. The output of the compactor is a compacted bitstream 1202 which can be stored in a database, requiring much less space than would have been necessary to store the raw N-channel data, or it can be transmitted to some other endpoint.

At the endpoint which receives the transmitted compacted bitstream 1202 may be decoder module 1220 configured to restore the compacted data into the original SAR image by essentially reversing the process conducted at encoder module 1210. The received bitstream may first be (optionally) passed through a lossless compactor which de-compacts the data into an encoded bitstream. In an embodiment, a data reconstruction engine 601 may be implemented to restore the compacted bitstream into its encoded format. The encoded bitstream may flow from compactor to decompressor 1222 wherein a data compaction technique may be used to decompress the encoded bitstream into the I/Q channels. It should be appreciated that lossless compactor components are optional components of the system, and may or may not be present in the system, dependent upon the embodiment.

According to the embodiment, an Artificial Intelligence (AI) deblocking network 1223 is present and configured to utilize a trained deep learning network to provide compression artifact removal as part of the decoding process. AI deblocking network 1223 may leverage the relationship demonstrated between the various N-channels of a data stream to enhance the reconstructed N-channel data 1203. Effectively, AI deblocking network 1223 provides an improved and novel method for removing compression artifacts that occur during lossy compression/decompression using a network designed during the training process to simultaneously address the removal of artifacts and maintain fidelity of the original N-channel data signal, ensuring a comprehensive optimization of the network during the training stages.

The output of AI deblocking network 1223 may be dequantized by quantizer 1224, restoring the n-channels to their initial dynamic range. The dequantized n-channel data may be reconstructed and output 1203 by decoder module 1220 or stored in a database.

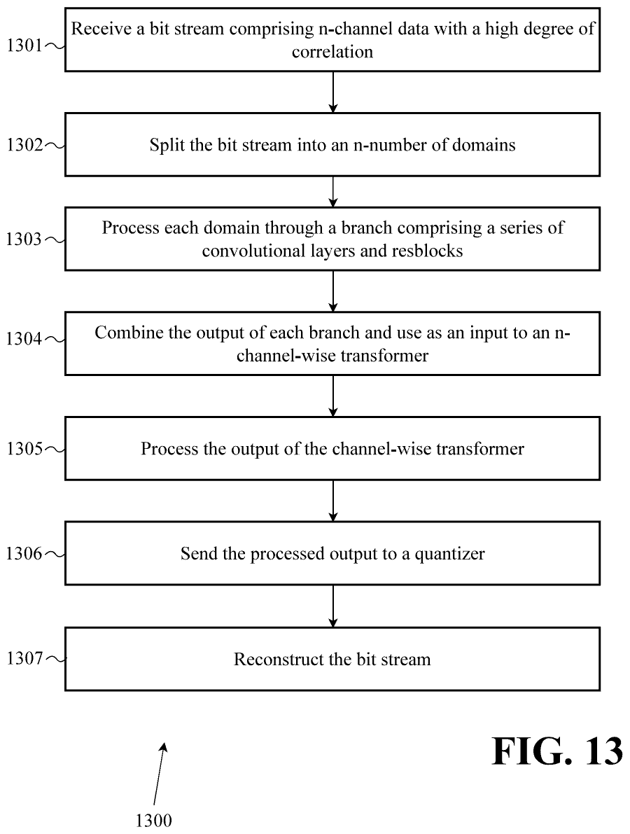

FIG. 13 is a flow diagram illustrating an exemplary method for processing a compressed n-channel bit stream using an AI deblocking network, according to an embodiment. According to the embodiment, the process begins at step 1301 when a decoder module 1220 receives, retrieves, or otherwise obtains a bit stream comprising n-channel data with a high degree of correlation. At step 1302, the bit stream is split into an n-number of domains. For example, if the received bit stream comprises image data in the form of R-, G,- and B-channels, then the bit stream would be split into 3 domains, one for each color (RGB). At step 1303, each domain is processed through a branch comprising a series of convolutional layers and ResBlocks. The number of layers and composition of said layers may depend upon the embodiment and the n-channel data being processed. At step 1304, the output of each branch is combined back into a single bitstream and used as an input into an n-channel wise transformer 1135. At step 1305, the output of the channel-wise transformer may be processed through one or more convolutional layers and/or transformation layers, according to various implementations. At step 1306, the processed output may be sent to a quantizer for upscaling and other data processing tasks. As a last step 1307, the bit stream may be reconstructed into its original uncompressed form.

### Exemplary Computing Environment

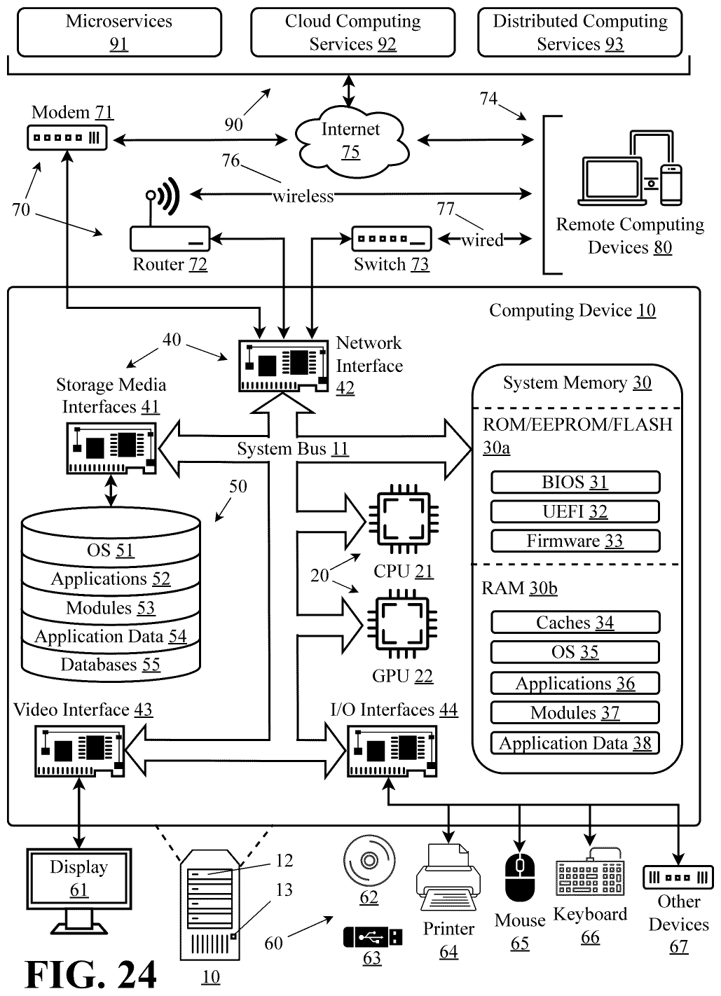

FIG. 24 illustrates an exemplary computing environment on which an embodiment described herein may be implemented, in full or in part. This exemplary computing environment describes computer-related components and processes supporting enabling disclosure of computer-implemented embodiments. Inclusion in this exemplary computing environment of well-known processes and computer components, if any, is not a suggestion or admission that any embodiment is no more than an aggregation of such processes or components. Rather, implementation of an embodiment using processes and components described in this exemplary computing environment will involve programming or configuration of such processes and components resulting in a machine specially programmed or configured for such implementation. The exemplary computing environment described herein is only one example of such an environment and other configurations of the components and processes are possible, including other relationships between and among components, and/or absence of some processes or components described. Further, the exemplary computing environment described herein is not intended to suggest any limitation as to the scope of use or functionality of any embodiment implemented, in whole or in part, on components or processes described herein.

The exemplary computing environment described herein comprises a computing device 10 (further comprising a system bus 11, one or more processors 20, a system memory 30, one or more interfaces 40, one or more non-volatile data storage devices 50), external peripherals and accessories 60, external communication devices 70, remote computing devices 80, and cloud-based services 90.

System bus 11 couples the various system components, coordinating operation of and data transmission between, those various system components. System bus 11 represents one or more of any type or combination of types of wired or wireless bus structures including, but not limited to, memory busses or memory controllers, point-to-point connections, switching fabrics, peripheral busses, accelerated graphics ports, and local busses using any of a variety of bus architectures. By way of example, such architectures include, but are not limited to, Industry Standard Architecture (ISA) busses, Micro Channel Architecture (MCA) busses, Enhanced ISA (EISA) busses, Video Electronics Standards Association (VESA) local busses, a Peripheral Component Interconnects (PCI) busses also known as a Mezzanine busses, or any selection of, or combination of, such busses. Depending on the specific physical implementation, one or more of the processors 20, system memory 30 and other components of the computing device 10 can be physically co-located or integrated into a single physical component, such as on a single chip. In such a case, some or all of system bus 11 can be electrical pathways within a single chip structure.

Computing device may further comprise externally-accessible data input and storage devices 12 such as compact disc read-only memory (CD-ROM) drives, digital versatile discs (DVD), or other optical disc storage for reading and/or writing optical discs 62; magnetic cassettes, magnetic tape, magnetic disk storage, or other magnetic storage devices; or any other medium which can be used to store the desired content and which can be accessed by the computing device 10. Computing device may further comprise externally-accessible data ports or connections 13 such as serial ports, parallel ports, universal serial bus (USB) ports, and infrared ports and/or transmitter/receivers. Computing device may further comprise hardware for wireless communication with external devices such as IEEE 1394 (“Firewire”) interfaces, IEEE 802.11 wireless interfaces, BLUETOOTH® wireless interfaces, and so forth. Such ports and interfaces may be used to connect any number of external peripherals and accessories 60 such as visual displays, monitors, and touch-sensitive screens 61, USB solid state memory data storage drives (commonly known as “flash drives” or “thumb drives”) 63, printers 64, pointers and manipulators such as mice 65, keyboards 66, and other devices 67 such as joysticks and gaming pads, touchpads, additional displays and monitors, and external hard drives (whether solid state or disc-based), microphones, speakers, cameras, and optical scanners.

Processors 20 are logic circuitry capable of receiving programming instructions and processing (or executing) those instructions to perform computer operations such as retrieving data, storing data, and performing mathematical calculations. Processors 20 are not limited by the materials from which they are formed, or the processing mechanisms employed therein, but are typically comprised of semiconductor materials into which many transistors are formed together into logic gates on a chip (i.e., an integrated circuit or IC). The term processor includes any device capable of receiving and processing instructions including, but not limited to, processors operating on the basis of quantum computing, optical computing, mechanical computing (e.g., using nanotechnology entities to transfer data), and so forth. Depending on configuration, computing device 10 may comprise more than one processor. For example, computing device 10 may comprise one or more central processing units (CPUs) 21, each of which itself has multiple processors or multiple processing cores, each capable of independently or semi-independently processing programming instructions. Further, computing device 10 may comprise one or more specialized processors such as a graphics processing unit (GPU) 22 configured to accelerate processing of computer graphics and images via a large array of specialized processing cores arranged in parallel.

System memory 30 is processor-accessible data storage in the form of volatile and/or nonvolatile memory. System memory 30 may be either or both of two types: non-volatile memory and volatile memory. Non-volatile memory 30a is not erased when power to the memory is removed and includes memory types such as read only memory (ROM), electronically-erasable programmable memory (EEPROM), and rewritable solid state memory (commonly known as “flash memory”). Non-volatile memory 30a is typically used for long-term storage of a basic input/output system (BIOS) 31, containing the basic instructions, typically loaded during computer startup, for transfer of information between components within computing device, or a unified extensible firmware interface (UEFI), which is a modern replacement for BIOS that supports larger hard drives, faster boot times, more security features, and provides native support for graphics and mouse cursors. Non-volatile memory 30a may also be used to store firmware comprising a complete operating system 35 and applications 36 for operating computer-controlled devices. The firmware approach is often used for purpose-specific computer-controlled devices such as appliances and Internet-of-Things (IoT) devices where processing power and data storage space is limited. Volatile memory 30b is erased when power to the memory is removed and is typically used for short-term storage of data for processing. Volatile memory 30b includes memory types such as random access memory (RAM), and is normally the primary operating memory into which the operating system 35, applications 36, program modules 37, and application data 38 are loaded for execution by processors 20. Volatile memory 30b is generally faster than non-volatile memory 30a due to its electrical characteristics and is directly accessible to processors 20 for processing of instructions and data storage and retrieval. Volatile memory 30b may comprise one or more smaller cache memories which operate at a higher clock speed and are typically placed on the same IC as the processors to improve performance.

Interfaces 40 may include, but are not limited to, storage media interfaces 41, network interfaces 42, display interfaces 43, and input/output interfaces 44. Storage media interface 41 provides the necessary hardware interface for loading data from non-volatile data storage devices 50 into system memory 30 and storage data from system memory 30 to non-volatile data storage device 50. Network interface 42 provides the necessary hardware interface for computing device 10 to communicate with remote computing devices 80 and cloud-based services 90 via one or more external communication devices 70. Display interface 43 allows for connection of displays 61, monitors, touchscreens, and other visual input/output devices. Display interface 43 may include a graphics card for processing graphics-intensive calculations and for handling demanding display requirements. Typically, a graphics card includes a graphics processing unit (GPU) and video RAM (VRAM) to accelerate display of graphics. One or more input/output (I/O) interfaces 44 provide the necessary support for communications between computing device 10 and any external peripherals and accessories 60. For wireless communications, the necessary radio-frequency hardware and firmware may be connected to I/O interface 44 or may be integrated into I/O interface 44.

Non-volatile data storage devices 50 are typically used for long-term storage of data. Data on non-volatile data storage devices 50 is not erased when power to the non-volatile data storage devices 50 is removed. Non-volatile data storage devices 50 may be implemented using any technology for non-volatile storage of content including, but not limited to, CD-ROM drives, digital versatile discs (DVD), or other optical disc storage; magnetic cassettes, magnetic tape, magnetic disc storage, or other magnetic storage devices; solid state memory technologies such as EEPROM or flash memory; or other memory technology or any other medium which can be used to store data without requiring power to retain the data after it is written. Non-volatile data storage devices 50 may be non-removable from computing device 10 as in the case of internal hard drives, removable from computing device 10 as in the case of external USB hard drives, or a combination thereof, but computing device will typically comprise one or more internal, non-removable hard drives using either magnetic disc or solid-state memory technology. Non-volatile data storage devices 50 may store any type of data including, but not limited to, an operating system 51 for providing low-level and mid-level functionality of computing device 10, applications 52 for providing high-level functionality of computing device 10, program modules 53 such as containerized programs or applications, or other modular content or modular programming, application data 54, and databases 55 such as relational databases, non-relational databases, and graph databases.

Applications (also known as computer software or software applications) are sets of programming instructions designed to perform specific tasks or provide specific functionality on a computer or other computing devices. Applications are typically written in high-level programming languages such as C++, Java, and Python, which are then either interpreted at runtime or compiled into low-level, binary, processor-executable instructions operable on processors 20. Applications may be containerized so that they can be run on any computer hardware running any known operating system. Containerization of computer software is a method of packaging and deploying applications along with their operating system dependencies into self-contained, isolated units known as containers. Containers provide a lightweight and consistent runtime environment that allows applications to run reliably across different computing environments, such as development, testing, and production systems.

The memories and non-volatile data storage devices described herein do not include communication media. Communication media are means of transmission of information such as modulated electromagnetic waves or modulated data signals configured to transmit, not store, information. By way of example, and not limitation, communication media includes wired communications such as sound signals transmitted to a speaker via a speaker wire, and wireless communications such as acoustic waves, radio frequency (RF) transmissions, infrared emissions, and other wireless media.

External communication devices 70 are devices that facilitate communications between computing device and either remote computing devices 80, or cloud-based services 90, or both. External communication devices 70 include, but are not limited to, data modems 71 which facilitate data transmission between computing device and the Internet 75 via a common carrier such as a telephone company or internet service provider (ISP), routers 72 which facilitate data transmission between computing device and other devices, and switches 73 which provide direct data communications between devices on a network. Here, modem 71 is shown connecting computing device 10 to both remote computing devices 80 and cloud-based services 90 via the Internet 75. While modem 71, router 72, and switch 73 are shown here as being connected to network interface 42, many different network configurations using external communication devices 70 are possible. Using external communication devices 70, networks may be configured as local area networks (LANs) for a single location, building, or campus, wide area networks (WANs) comprising data networks that extend over a larger geographical area, and virtual private networks (VPNs) which can be of any size but connect computers via encrypted communications over public networks such as the Internet 75. As just one exemplary network configuration, network interface 42 may be connected to switch 73 which is connected to router 72 which is connected to modem 71 which provides access for computing device 10 to the Internet 75. Further, any combination of wired 77 or wireless 76 communications between and among computing device 10, external communication devices 70, remote computing devices 80, and cloud-based services 90 may be used. Remote computing devices 80, for example, may communicate with computing device through a variety of communication channels 74 such as through switch 73 via a wired 77 connection, through router 72 via a wireless connection 76, or through modem 71 via the Internet 75. Furthermore, while not shown here, other hardware that is specifically designed for servers may be employed. For example, secure socket layer (SSL) acceleration cards can be used to offload SSL encryption computations, and transmission control protocol/internet protocol (TCP/IP) offload hardware and/or packet classifiers on network interfaces 42 may be installed and used at server devices.

In a networked environment, certain components of computing device 10 may be fully or partially implemented on remote computing devices 80 or cloud-based services 90. Data stored in non-volatile data storage device 50 may be received from, shared with, duplicated on, or offloaded to a non-volatile data storage device on one or more remote computing devices 80 or in a cloud computing service 92. Processing by processors 20 may be received from, shared with, duplicated on, or offloaded to processors of one or more remote computing devices 80 or in a distributed computing service 93. By way of example, data may reside on a cloud computing service 92, but may be usable or otherwise accessible for use by computing device 10. Also, certain processing subtasks may be sent to a microservice 91 for processing with the result being transmitted to computing device 10 for incorporation into a larger processing task. Also, while components and processes of the exemplary computing environment are illustrated herein as discrete units (e.g., OS 51 being stored on non-volatile data storage device 51 and loaded into system memory 35 for use) such processes and components may reside or be processed at various times in different components of computing device 10, remote computing devices 80, and/or cloud-based services 90.

Remote computing devices 80 are any computing devices not part of computing device 10. Remote computing devices 80 include, but are not limited to, personal computers, server computers, thin clients, thick clients, personal digital assistants (PDAs), mobile telephones, watches, tablet computers, laptop computers, multiprocessor systems, microprocessor based systems, set-top boxes, programmable consumer electronics, video game machines, game consoles, portable or handheld gaming units, network terminals, desktop personal computers (PCs), minicomputers, main frame computers, network nodes, and distributed or multi-processing computing environments. While remote computing devices 80 are shown for clarity as being separate from cloud-based services 90, cloud-based services 90 are implemented on collections of networked remote computing devices 80.

Cloud-based services 90 are Internet-accessible services implemented on collections of networked remote computing devices 80. Cloud-based services are typically accessed via application programming interfaces (APIs) which are software interfaces which provide access to computing services within the cloud-based service via API calls, which are pre-defined protocols for requesting a computing service and receiving the results of that computing service. While cloud-based services may comprise any type of computer processing or storage, three common categories of cloud-based services 90 are microservices 91, cloud computing services 92, and distributed computing services 93.

Microservices 91 are collections of small, loosely coupled, and independently deployable computing services. Each microservice represents a specific computing functionality and runs as a separate process or container. Microservices promote the decomposition of complex applications into smaller, manageable services that can be developed, deployed, and scaled independently. These services communicate with each other through well-defined application programming interfaces (APIs), typically using lightweight protocols like HTTP or message queues. Microservices 91 can be combined to perform more complex processing tasks.

Cloud computing services 92 are delivery of computing resources and services over the Internet 75 from a remote location. Cloud computing services 92 provide additional computer hardware and storage on as-needed or subscription basis. Cloud computing services 92 can provide large amounts of scalable data storage, access to sophisticated software and powerful server-based processing, or entire computing infrastructures and platforms. For example, cloud computing services can provide virtualized computing resources such as virtual machines, storage, and networks, platforms for developing, running, and managing applications without the complexity of infrastructure management, and complete software applications over the Internet on a subscription basis.

Distributed computing services 93 provide large-scale processing using multiple interconnected computers or nodes to solve computational problems or perform tasks collectively. In distributed computing, the processing and storage capabilities of multiple machines are leveraged to work together as a unified system. Distributed computing services are designed to address problems that cannot be efficiently solved by a single computer or that require large-scale computational power. These services enable parallel processing, fault tolerance, and scalability by distributing tasks across multiple nodes.

Although described above as a physical device, computing device 10 can be a virtual computing device, in which case the functionality of the physical components herein described, such as processors 20, system memory 30, network interfaces 40, and other like components can be provided by computer-executable instructions. Such computer-executable instructions can execute on a single physical computing device, or can be distributed across multiple physical computing devices, including being distributed across multiple physical computing devices in a dynamic manner such that the specific, physical computing devices hosting such computer-executable instructions can dynamically change over time depending upon need and availability. In the situation where computing device 10 is a virtualized device, the underlying physical computing devices hosting such a virtualized computing device can, themselves, comprise physical components analogous to those described above, and operating in a like manner. Furthermore, virtual computing devices can be utilized in multiple layers with one virtual computing device executing within the construct of another virtual computing device. Thus, computing device 10 may be either a physical computing device or a virtualized computing device within which computer-executable instructions can be executed in a manner consistent with their execution by a physical computing device. Similarly, terms referring to physical components of the computing device, as utilized herein, mean either those physical components or virtualizations thereof performing the same or equivalent functions.

The skilled person will be aware of a range of possible modifications of the various aspects described above. Accordingly, the present invention is defined by the claims and their equivalents.

What is claimed is:

1. A computing system for video compression comprising:
a processor; and
a memory storing instructions that, when executed by the processor, cause the computing system to implement:
a hierarchical encoder configured to receive video data and generate compressed representations at a plurality of hierarchical scales;
a geometric processor configured to organize the compressed representations within a manifold structure having geometric properties that encode relationships between video elements, the geometric processor configured to:
compute paths through the manifold that represent evolution of video content over time;
determine geometric characteristics based on content properties; and
enforce constraints maintaining temporal relationships during compression;
a cognitive interface configured to provide semantic understanding of video content, the cognitive interface configured to:
organize related concepts into navigable structures within the manifold;
enable traversal of the manifold based on semantic relationships; and
adapt the manifold structure based on learned patterns;
a decoder configured to reconstruct video from the compressed representations using information from both the geometric processor and the cognitive interface; and
a navigation system configured to enable access to compressed video content based on semantic queries.

2. The computing system of claim 1, wherein the manifold structure comprises a Lorentzian manifold having a metric tensor with negative temporal signature to distinguish time dimensions from spatial dimensions, and wherein the geometric processor computes time-like geodesics through the Lorentzian manifold with light cone constraints that prevent acausal information flow.

3. The computing system of claim 1, wherein the cognitive interface comprises:
a thought bundle manager configured to create submanifolds containing semantically related video elements, each submanifold having local geometric properties reflecting semantic density; and
a manifold evolution controller configured to modify curvature of the manifold based on usage patterns and create new connections between thought bundles based on discovered relationships.

4. The computing system of claim 1, wherein the decoder comprises:
a correlation network configured to identify spatiotemporal relationships between compressed elements;
a progressive reconstruction engine configured to combine representations from different hierarchical scales; and
a semantic enhancement module configured to apply refinements guided by the cognitive interface.

5. The computing system of claim 1, wherein the navigation system comprises an anchor detector configured to identify semantically significant points within the video and assign them positions within the manifold, the anchors being categorized as at least one of: decision points for narrative branches, semantic boundaries for concept transitions, navigation waypoints for reference locations, and temporal markers for time-based events.

6. The computing system of claim 1, wherein the instructions further cause the computing system to implement a federated learning module configured to:
extract geometric patterns from the manifold structure;
apply privacy-preserving transformations that remove content-specific information while maintaining geometric and topological properties; and
share abstracted patterns with other video compression systems to enable collective learning without content disclosure.

7. The computing system of claim 1, wherein the instructions further cause the computing system to implement a real-time processing module configured to:
generate initial coarse compressed representations with minimal latency;
progressively refine the representations by adding hierarchical detail; and
stream video content while refinement continues in parallel, wherein the real-time processing module terminates refinement when quality targets are achieved.

8. The computing system of claim 1, wherein the cognitive interface is implemented as a persistent cognitive machine having a sensory encoder corresponding to the hierarchical encoder, a cognitive core implementing the manifold operations, and a motor decoder corresponding to the decoder, and wherein the manifold structure evolves through dreaming operations comprising perturbation, recombination, and pruning of structures.

9. The computing system of claim 1, wherein the hierarchical encoder comprises at least three encoding stages generating macro-scale, meso-scale, and micro-scale representations capturing progressively finer details.

10. The computing system of claim 1, wherein:
the processor comprises distributed processing resources including edge devices, cloud resources, and client devices;
the hierarchical encoder is executed on the edge devices;
the geometric processor and cognitive interface are executed on the cloud resources; and
the decoder is executed on the client devices, wherein the computing system is configured to process multiple video types including standard video, volumetric video, and holographic video.

11. A computer-implemented method for video compression comprising the steps of:
receiving video data and generating compressed representations at a plurality of hierarchical scales;
organizing the compressed representations within a manifold structure having geometric properties that encode relationships between video elements, the organizing comprising:
computing paths through the manifold that represent evolution of video content over time;
determining geometric characteristics based on content properties; and
enforcing constraints maintaining temporal relationships during compression;
providing semantic understanding of video content through a cognitive interface, the providing comprising:
organizing related concepts into navigable structures within the manifold;
enabling traversal of the manifold based on semantic relationships; and
adapting the manifold structure based on learned patterns;
reconstructing video from the compressed representations using information from both the geometric organizing and the semantic understanding; and
enabling access to compressed video content based on semantic queries.

12. The method of claim 11, wherein organizing the compressed representations comprises organizing within a Lorentzian manifold having a metric tensor with negative temporal signature to distinguish time dimensions from spatial dimensions, and computing time-like geodesics through the Lorentzian manifold with light cone constraints that prevent acausal information flow.

13. The method of claim 11, wherein providing semantic understanding comprises:
creating submanifolds containing semantically related video elements as thought bundles, each submanifold having local geometric properties reflecting semantic density; and
modifying curvature of the manifold based on usage patterns and creating new connections between thought bundles based on discovered relationships.

14. The method of claim 11, wherein reconstructing video comprises:
identifying spatiotemporal relationships between compressed elements through a correlation network;
progressively combining representations from different hierarchical scales; and
applying refinements guided by the semantic understanding.

15. The method of claim 11, wherein enabling access comprises identifying semantically significant points within the video as anchors and assigning them positions within the manifold, the anchors being categorized as at least one of: decision points for narrative branches, semantic boundaries for concept transitions, navigation waypoints for reference locations, and temporal markers for time-based events.

16. The method of claim 11, further comprising the steps of:
extracting geometric patterns from the manifold structure;
applying privacy-preserving transformations that remove content-specific information while maintaining geometric and topological properties; and
sharing abstracted patterns with other video compression systems to enable collective learning without content disclosure.

17. The method of claim 11, further comprising the steps of:
generating initial coarse compressed representations with minimal latency;
progressively refining the representations by adding hierarchical detail; and
streaming video content while refinement continues in parallel, including terminating refinement when quality targets are achieved.

18. The method of claim 11, wherein providing semantic understanding comprises implementing a persistent cognitive machine having sensory encoding corresponding to the generating compressed representations, cognitive processing implementing the manifold operations, and motor decoding corresponding to the reconstructing, and wherein the method further comprises evolving the manifold structure through dreaming operations comprising perturbation, recombination, and pruning of structures.

19. The method of claim 11, wherein generating compressed representations comprises generating at least macro-scale, meso-scale, and micro-scale representations capturing progressively finer details.

20. The method of claim 11, wherein:
the generating compressed representations is performed on edge devices;
the organizing within a manifold structure and providing semantic understanding are performed on cloud resources; and
the reconstructing is performed on client devices, wherein the method processes multiple video types including standard video, volumetric video, and holographic video.
